(19) United States
(12) Patent Application Publication
(10) Pub. No.: US 2026/0154901 A1
(43) Pub. Date: Jun. 4, 2026

(54) METHODS AND SYSTEM FOR FACILITATING USER INTERACTIONS WITH A DIGITAL TWIN OF A PHYSICAL ENVIRONMENT

(71) Applicant: Occipital, Inc., Denver, CO (US)

(72) Inventors: Anton Anatolievich Yakubenko, Saint Johns, FL (US); Gleb Robertovich Krivovyaz, Zurich (CH); Sarah Bird, Seattle, WA (US); Oleksandra Sergeevna Fohol, Kharkiv (UA); Dianne C. Hallock, Medfield, MA (US); Yuriy Evgenevich Berdnikov, Belgrade (RS); Mikhail Aleksandrovich Bombin, Belgrade (RS); Isabella Marie Alexander Muno, Seattle, WA (US); Ovidiu-Tiberiu Moise, Bucharest (RO); Jedrick Willis Lyon, Nashville, TN (US); Benjamin Singer Petuchowski, Centennial, CO (US); Alexandru-Aurelian Girtan, Prague (CZ); Pedro Maia Coelho, Gafanha da Nazaré (PT); Liviu Bogdan Ujeniuc Chiributa, Brasov (RO)

(21) Appl. No.: 19/404,366

(22) Filed: Dec. 1, 2025

Related U.S. Application Data
(60) Provisional application No. 63/726,781, filed on Dec. 2, 2024.

(51) Int. Cl. G06T 17/00; G06T 7/30; G06T 7/60; G06V 20/70

(52) U.S. Cl. CPC G06T 17/00; G06T 7/30; G06T 7/60; G06V 20/70

(57) ABSTRACT

The present disclosure provides methods and systems for facilitating user interactions with a digital twin of a physical environment. The system receives sensor data and generates a three-dimensional model of the physical environment. The system generates text-based descriptors of the physical environment and objects based on the three-dimensional model. The text-based descriptors include structured descriptions of architectural features, object properties, spatial relationships, dimensions, and materials. The system receives user interactions associated with the three-dimensional model, including queries, modification requests, or analysis requests. The system may utilize machine learning models to process text-based descriptors and generate responses to user queries, modifications to the digital twin, or reports including cost estimates and analytical insights.

### CROSS-REFERENCE TO RELATED APPLICATION

This application claims priority to U.S. Provisional Application No. 63/726,781 filed on Dec. 2, 2024 and entitled “METHODS FOR FACILITATING USER INTERACTIONS WITH A DIGITAL TWIN OF A PHYSICAL ENVIRONMENT,” which is incorporated herein by reference in its entirety.

### BACKGROUND

The use of machine learning models, such as large language models and artificial intelligence agents has greatly increased over the last few years. Similarly, over the last few years, the users of three-dimensional digital twins of physical environments have increased. Unfortunately, large language models and artificial intelligence agents are typically trained and configured to process and output textual content as opposed to image data. While some of these models have been configured to process image data and/or video data, the processing costs and resources associated with image based large language models and artificial intelligence agents remains high often placing real-world application of image based the large language models and artificial intelligence agents unrealistic including applying large language models and artificial intelligence agents to digital twins of physical environments.

### BRIEF DESCRIPTION OF FIGURES

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a digital twin system for generating digital twins or three-dimensional models of physical environments, according to some implementations.

FIG. 2 is another example block diagram of a digital twin system for generating digital twins or three-dimensional models of physical environments, according to some implementations.

FIG. 3 is an example block diagram of a digital twin system for processing requests associated with digital twins or three-dimensional models of physical environments, according to some implementations.

FIG. 4 is another example block diagram of a digital twin system for processing requests associated with digital twins or three-dimensional models of physical environments, according to some implementations.

FIG. 5 is an example block diagram of a digital twin system for spatially registering image data with respect to a digital twins or three-dimensional models of physical environments, according to some implementations.

FIG. 6 is another example block diagram of a digital twin system for spatially registering image data with respect to a digital twins or three-dimensional models of physical environments, according to some implementations.

FIG. 7 is a flow diagram illustrating an example process for generating text-based descriptors of a physical environment based on sensor data, according to some implementations.

FIG. 8 is another flow diagram illustrating an example process for facilitating user interactions with a digital twin of a physical environment, according to some implementations.

FIG. 9 is another flow diagram illustrating an example process for aligning or mapping text-based descriptors between different digital twins of the same physical environment, according to some implementations.

FIG. 10 is a flow diagram illustrating an example process for spatially registering image data within a digital twin of a physical environment, according to some implementations.

FIG. 11 is another flow diagram illustrating an example method for spatially registering image data within a digital twin of a physical environment, according to some implementations.

FIG. 12 is another flow diagram illustrating an example process for spatially registering image data within a digital twin of a physical environment, according to some implementations.

FIG. 13 is an example system for facilitating user interactions with a digital twin of a physical environment that may implement the techniques described herein, according to some implementations.

### DETAILED DESCRIPTION

Discussed herein is a digital twin system for generating, annotating, and/or extracting information and data from a digital twin of a physical environment. In some examples, the digital twin system may be configured to utilize machine learning models (MLMs), such as artificial intelligence (AI), Large Language Models (LLMs), neural networks, as well as other machine learning techniques to allow one or more users to create and interact with digital twins of physical environments. In some cases, the digital twin system may be configured to generate and/or utilize text-based descriptors of features, objects, characteristics, and/or the like of the digital twin. In some cases, the digital twin system may allow the users to input requests via chat-style (e.g., text-based or audio-based queries) or application programming interface (APIs) interactions. Accordingly, the system discussed herein may assist or improve interactions with AI agents and/or LLMs that typically leverage text-based or language-based processing when the AI agents and/or LLMs are processing the digital twin data, thereby, enabling the use of AI agents and/or LLMs to facilitate information extraction and analysis with regards to digital twins of physical environments.

In some examples, the system discussed herein may represent a digital twin as a text file or a plurality of text-based descriptors, such as JSON or XML, containing a detailed description of the space. In some cases, in addition to the text-based descriptors, the system may also generate and utilize include two-dimensional vectors, three-dimensional vectors, raster representations, three-dimensional scans, computer assisted design files, BIM models, and/or the like with respect to querying a digital twin. In some cases, these text-based descriptors may include an enumeration of various features or elements, such as walls, doors, windows, openings, cabinets, appliances, countertops, electrical fixtures (including outlets, light switches, and smoke detectors), light fixtures (including ceiling and wall lights), showers, vanities, toilets, bathtubs, baseboards, moldings, furniture, stairs, chimneys, fireplaces, HVAC systems, pipes, and other structural or functional components, objects in the space, and/or the like. In some cases, each object in the space may include text-based descriptors including position and orientation (X, Y, Z coordinates and rotation angles, or transformation matrices), dimensions, properties (e.g., type and number of panes for windows and doors, materials), and relationships to other objects (e.g., a door or window belonging to a specific wall), and/or the like.

In some implementations, these text-based descriptors files describing the digital twin may be generated from scans, computer-aided design (CAD), Building Information Modeling (BIM) models, and/or the like using a variety of manual, automated, and fully automated techniques. In some cases, the process of generating the text-based descriptors may include one or more fully automated recognition of objects in a three-dimensional (3D) scan as well as manual or semi-automated modeling of CAD and BIM files. In various examples, the digital twin system may include modules or processes to convert the created CAD or BIM files into text-based descriptor representations.

In some aspects, as the digital twin is in text form, one or more AI agents, LLMs and/or other machine learning models or approaches may more effectively (e.g., requiring fewer processing resources and/or cycles, producing results in less time, and resulting in reduced expense when using third-party AI agents and/or LLMs) process the digital twin when compared with inputting image data representing a digital twin into AI agents and/or LLMs. In some examples, a user may enter a query in text format, such as “What is the square footage of the kitchen?” or “List all electrical outlets in the living room.” The digital twin system may then generate prompt data which may or may not include the text-based digital twin. The prompt data may then be input into one or more AI agents and/or LLMs to generate output data (which may also be in a text format) as expected from generative AI systems.

In some cases, the digital twin system may process more complex queries that involve generating reports, quotes, and estimates based on the information contained within the text-based digital twin and processed by a generative AI or LLM model. In some cases, these reports may be generated in standardized formats or created ad hoc based on specific user requests. In some examples, the digital twin system may generate reports that include floor plans of the entire space, individual floors, and specific rooms, complete with dimensions for each area. The system may also produce schedules or lists of all objects within the space, including their dimensions and quantities. For instance, when processing windows, the system may generate a detailed list that includes specifications such as width, height, depth, sill height, and shape for each window element.

In some aspects, these reports may be represented in various formats including vector or raster images, tables (such as CSV or Excel files), PDFs, word processing documents, or other suitable formats. The reports may be utilized to generate estimates based on the quantities and dimensions of objects and the overall characteristics of the space as extracted from the digital twin of the physical environment. In some cases, an estimate may include a materials list, material prices, and labor costs. Users may have the ability to control the exact cost of each line item or provide general guidance, such as targeting a certain percentile, average, or a specified percentage above average for a particular local area, which may be identified by zip code. Additionally, these reports may include customer or end-client branding and visualizations of proposed changes, thereby providing a personalized overview of the project or space analysis.

In some cases, the digital twin system may enable a user to request edits to the digital twin and, thereby, the physical environment. For example, the user may input a text based query such “how would a space look with 8-foot doors instead of 7-foot doors”. In this example, the AI agent or LLM may process the text-based descriptor digital twin together with the query to identify all door objects, calculate the dimensional changes and structural implications, and generate updated specifications. The system may then translate the changes to the text-based descriptor digital twin into the 3D model digital twin to provide the visual representation showing the modified doors in their spatial context.

Accordingly, in some cases, the system may allow users to visualize how a space would appear with furniture from a specific manufacturer or with a particular style. In some cases, the machine learning models (e.g., the LLMs, AI agents, and/or the like) may process the text-based descriptors to determine object (e.g., furniture) placement based on room dimensions and traffic flow patterns. In some aspects, the digital twin system may facilitate visual staging or redecorating of a space with an interior design style in which the machine learning models (e.g., the LLMs, AI agents, and/or the like) may analyze the text-based descriptors to suggest color schemes, materials, and layout modifications based on the existing structural elements. In some implementations, the system may assist with space planning scenarios such as office planning for workspaces, individual desks, conference rooms, offices, and/or the like within particular physical environments.

In some cases, the digital twin system may utilize the text-based descriptors digital twin together with a corresponding 3D model digital twin. In such implementations, the text-based descriptor digital twin may be utilized with AI agents and LLMs for efficient processing, analysis, and information extraction, while the 3D model digital twin may be interacted with by one or more users for visualization, navigation, and spatial understanding of the physical environment. This approach may allow the system to provide both text-based data for automated processing and visual representations for user interactions, thereby enabling analysis and user engagement with the digital twin of the physical environment in a more interactive and digestible manner. For example, if a user requests a remodeling estimate and design, the system may present the data of the report (e.g., the text-based output of the AI agent or LLM) on the 3D model digital twin including visualizations of the design of the space in a visible interactive 3D manner. This interactive presentation may assist the users with understanding the scope and realization of the remodeling project in an easily digestible and visible manner. In some cases, the system may overlay cost information, material specifications, and timeline data directly onto the 3D model digital twin to assist the user with editing the scope (e.g., adding and/or removing design changes of the project).

In some implementations, the text-based digital twin and the 3D model digital twin may be combined into a unified model, such as a 3D model digital twin may be annotated with the text-based descriptors. In such cases, the text-based descriptors may be directly embedded within or linked to specific geometric elements of the 3D model, creating a digital representation that maintains both spatial and semantic information in a single integrated format. In some aspects, this combined approach may allow users to interact with the 3D model while simultaneously accessing textual information about specific objects, materials, dimensions, and properties directly within the visual interface. In some examples, when a user views, selects, hovers, or otherwise engaged with a particular element, feature, object, and/or the like in the 3D model, the system may display the associated text-based descriptors, providing immediate access to detailed specifications, installation notes, maintenance information, or other relevant data without requiring separate queries or navigation to external documentation.

In this manner, the system may allow a user to interact with a digital twin in a text-based manner that is preferred by LLMs and AI agents while still being able to consume or understand a physical space in a 3D model or visual sense as is typically desired by humans. In some implementations, the digital twin system may maintain synchronization between the text-based descriptors and the 3D model representations to ensure consistency across both formats. In some cases, when modifications are made to either representation, the system may update the corresponding format to maintain data integrity and coherence. In some aspects, this synchronization may involve real-time validation processes that verifies the compatibility of changes across both the textual and visual representations of the digital twin.

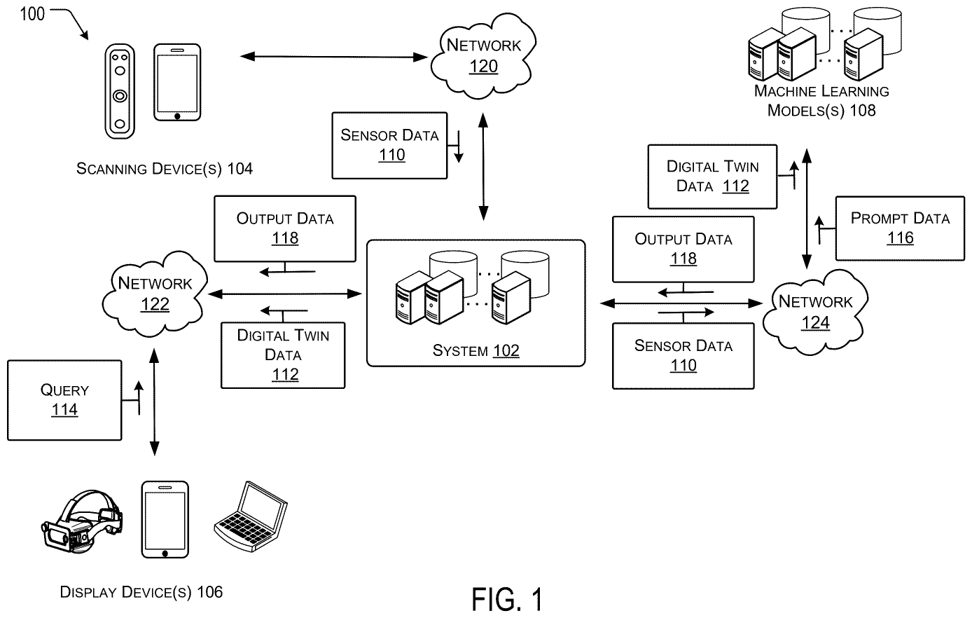

FIG. 1 illustrates a block diagram of a digital twin system 100 that may be configured to generate, annotate, and extract information from digital twins of physical environments using machine learning models, such as LLMs and AI agents. In the current example, the digital twin system 100 may include a system 102 that communicates with a scanning device 104 to receive sensor data 110 from physical environment as part of a capture or scanning operations. In some cases, the scanning device 104 may transmit three-dimensional image data, point cloud data, lidar data, and other sensor data to the system 102.

In some cases, the system 102 may then generate the digital twin data 112 including a 3D digital twin of the physical environment based at least in part on the received sensor data 110. In some implementations, the system 102 may process sensor data 110 to construct a digital representation of the scanned physical space. In some aspects, the digital twin data 112 may include geometric models, spatial relationships, object classifications, and structural elements that collectively represent the physical environment in digital form. In some cases, the system 102 may utilize various processing algorithms and techniques to convert the sensor data 110 into structured digital twin data 112 that may be suitable for further analysis, visualization, and interaction by users and machine learning models.

In some implementations, the system 102 may also generate text-based descriptors using the sensor data 110 and/or the generated digital twin data 112 (including the 3D model). In some cases, the system 102 may analyze the sensor data 110 directly to identify and classify objects, surfaces, and structural elements within the physical environment, converting these identified features into structured text-based descriptions. In some aspects, the system 102 may process the digital twin data 112, including the 3D model, to extract semantic information about the spatial relationships, dimensions, materials, and properties of various elements within the digital representation.

In some examples, the text-based descriptors may be generated through automated analysis of the geometric data contained within the digital twin data 112, where the system 102 may identify object boundaries, calculate dimensions, and determine spatial orientations to create textual descriptions of each element. In some cases, the system 102 may utilize computer vision techniques and object recognition algorithms to process the sensor data 110 and identify specific features such as doors, windows, walls, fixtures, and furniture, subsequently generating corresponding text-based descriptors that capture the characteristics and properties of these identified objects.

In some implementations, the generation of text-based descriptors may involve combining information from both the sensor data 110 and the processed digital twin data 112 to create more accurate and detailed textual representations. In some aspects, this dual-source approach may allow the system 102 to leverage the precision of the sensor measurements while also incorporating the structured spatial relationships established during the digital twin generation process, resulting in text-based descriptors that may provide coverage of both individual object properties and their contextual relationships within the physical environment.

In some cases, user inputs may be utilized to further refine or generate the text-based descriptors. In some examples, the user inputs may be supplied from a CAD or design expert that assists with the generation or completion of the 3D model. In such implementations, the CAD or design expert may provide specialized knowledge about architectural elements, construction details, material specifications, and design standards that may enhance the accuracy and completeness of both the 3D model and the associated text-based descriptors.

In some implementations, the 3D model digital twin and/or the text-based descriptors may be generated using machine learning models, such as LLMs and/or AI agents. In some cases, these machine learning models may be trained using training data comprising labeled architectural elements, structural components, and objects within the sensor data 110 to generate both geometric representations and corresponding textual descriptions. In some aspects, LLMs may be particularly effective at generating natural language descriptions of identified objects and their properties, while AI agents may be configured to process spatial relationships and dimensional data to create structured text-based descriptors. In some examples, the machine learning models may utilize pattern recognition and semantic understanding capabilities to interpret complex spatial arrangements and generate descriptions that capture both the physical characteristics and functional attributes of elements within the physical environment. In some cases, the use of machine learning models trained on such 3D model or physical environment training data in the generation process may improve the consistency and accuracy of both the 3D model digital twin and text-based descriptors.

The system 102 may also provide one or more display systems 106 that allow users to interact with, visualize, and/or otherwise consume the digital twin data 112. For example, the display systems 106 may provide interfaces for viewing 3D models, accessing text-based descriptors, submitting queries 114, and reviewing generated reports and estimates. The display systems 106 may include various specialized visualization tools to facilitate precise interaction with the digital twin content. For instance, the display systems 106 may provide spatial navigation tools that allow users to move through and explore the three-dimensional representation of the physical environment while accessing contextual information about objects and features. The display systems 106 may also include object selection tools that enable users to identify and interact with particular elements within the digital twin data 112, allowing for targeted information retrieval about specific components such as dimensions, materials, or installation specifications. Additionally, the display systems 106 may provide query input interfaces that allow users to submit natural language requests for information extraction, analysis, or modifications to the digital twin data 112.

As one illustrative example, a user may submit a query 114 to the system 102, such as to retrieve information and/or modify the digital twin data 112. In some cases, the query 114 may be text-based allowing users to interact with the digital twin system 100 using natural language requests. Accordingly, the system 102 may submit the query 114 together with a corresponding digital twin (e.g., the text-based descriptors corresponding digital twin data 112) to one or more machine learning models 108 (e.g., the LLMs and/or AI agents). In some implementations, the system 102 may format the query 114 into prompt data 116 that may be optimized for processing by the machine learning models 108. For example, the system 102 may convert and/or submit the text-based descriptors corresponding to the appropriate digital twin together with the query 114 as a fully text-based input to the machine learning models 108 via the prompt data 116. In some aspects, this approach may enable the machine learning models 108 (such as LLMs and AI agents) to more efficiently analyze the 3D model in conjunction with the user's specific request, facilitating more accurate and contextually relevant responses while reducing associated costs (e.g., processing resources and/or transitional costs associated with third-party LLMs and AI agents).

In some cases, the machine learning models 108 may then generate output data 118 (which may also be text-based) based at least in part on the processed prompt data 116. In some examples, the system 102 may process the output data 118 to update the 3D model and/or the text-based descriptors of the 3D model, thereby updating the digital twin data 112. In some cases, this updating process may involve analyzing the output data 118 to identify modifications, additions, or corrections that should be applied to the existing 3D digital twin representation and/or the text-based descriptors.

In some aspects, the system 102 may parse the output data 118 to extract specific changes to object properties, spatial relationships, or structural elements that were generated by the machine learning models 108 in response to user queries or analysis requests. In some implementations, the system 102 may modify existing descriptions or add new descriptions. In some cases, the system 102 may also translate textual modifications from the output data 118 into corresponding 3D geometric changes within the visual model, ensuring consistency between the text-based descriptors and visual representations of the digital twin. In some cases, the system 102 may generate a new 3D model of the physical environment based at least in part on the output data 118 such that a user engaged with the display device 106 may be able to consume the original 3D model together with the new 3D model including any edits associated with the output data 118. In some cases, the system 102 may also overlay the edits to the 3D model over the text-based descriptors and/or the 3D elements or features within the 3D model to assist the user of the display device 106 in consuming and understanding differences between an original digital twin and an updated digital twin.

It should be understood that the machine learning models 108 may be associated with the system 102 and/or may be provided by third-parties, such as via one or more cloud-based service or downloadable models that may be hosted by resources associated with the system 102. It should also be understood that in various examples, the system 102 may operate with respect to multiple machine learning models 108 that are made available by two or more third-parties (e.g., the system 102 may interface with models provided by multiple third-parties).

In the current example, the system 100 may facilitate communication between components through multiple networks, including network 120 that connects the scanning device 104 and system 102 for sensor data transmission, network 122 that enables query 114 and output data 118 exchange between the system 102 and display devices 106, and network 124 that supports data flow between the system 102 and machine learning models 108. These network connections may allow for distributed processing and substantially real-time collaboration between the various components of the digital twin system 100, enabling efficient generation, analysis, and visualization of digital twin representations of physical environments.

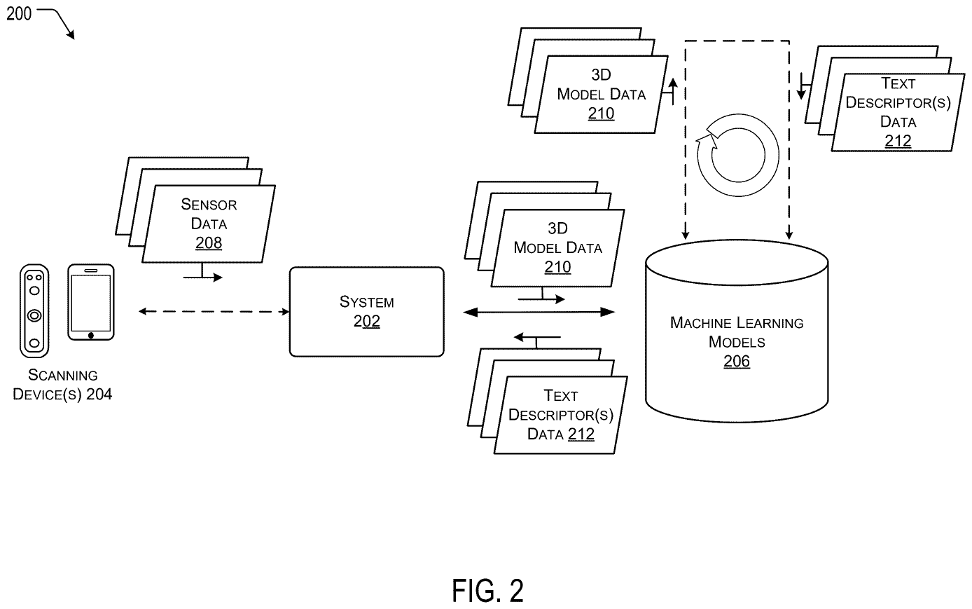

FIG. 2 illustrates a block diagram of a digital twin system 200 that may be configured to generate both 3D model data 210 and text descriptor data 212 from sensor data 208 captured during scanning sessions. In the current example, the digital twin system 200 may include a system 202 that communicates with a scanning system or device 204 to receive sensor data 208 from a physical environment during capture operations. In some cases, the scanning system 204 may include various sensing devices such as lidar scanners, depth cameras, photogrammetry equipment, and other data capture instruments that may collect spatial and visual information about the physical environment.

In some implementations, the system 202 may process the received sensor data 208 to generate 3D model data 210 that represents the geometric structure and spatial characteristics of the scanned physical environment. In some aspects, the system 202 may utilize point cloud processing algorithms, mesh generation techniques, three-dimensional reconstruction methods, structure-from-motion (SfM) techniques, simultaneous localization and mapping (SLAM) techniques, and surface reconstruction methods to convert the raw sensor data 208 into structured 3D model data 210. In some cases, the 3D model data 210 may include detailed geometric representations of walls, floors, ceilings, openings, fixtures, and other architectural elements present within the physical space.

In some examples, the system 202 may also interface with machine learning models 206 to generate text-based descriptor data 212 based at least in part on the sensor data 208 and/or the generated 3D model data 210. In some aspects, the machine learning models 206 (e.g., LLMs, AI agents, and/or the like) may process the 3D model data 210 to identify specific objects, calculate dimensions, determine spatial relationships, and generate text-based descriptor data 212 that describes the characteristics and properties of elements within the physical environment.

In some implementations, the text-based descriptor data 212 may include structured descriptions of architectural features (such as room dimensions, door and window specifications, fixture locations, material properties, spatial relationships between objects, and/or the like). In some aspects, the text-based descriptor data 212 may be formatted in structured formats such as JSON, XML, or other machine-readable formats that may facilitate efficient processing by downstream applications and additional machine learning models.

In some specific examples, the system 202 may coordinate the generation of both the 3D model data 210 and text-based descriptor data 212 to ensure consistency and accuracy between the geometric and textual representations of the physical environment. In some cases, the system 202 may utilize feedback mechanisms between the 3D model generation process and the text-based descriptor generation process, where information from one representation may be used to refine and improve the accuracy of the other representation (such as within a multilevel neural network approach). In some aspects, this coordinated approach may result in more machine learning model friendly and reliable digital twin representations that may effectively support both visual interactions and LLM and AI based-analysis.

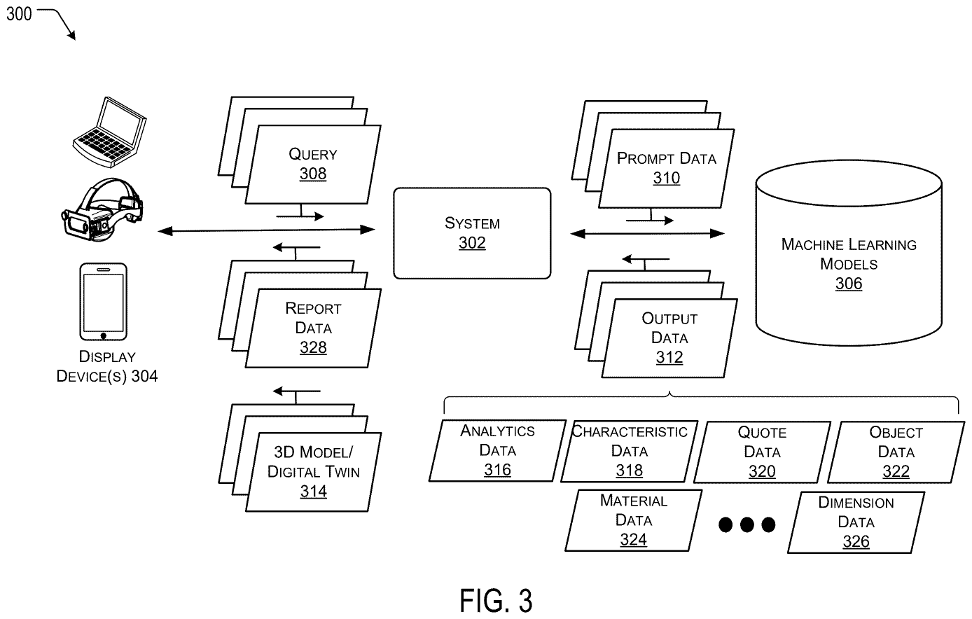

FIG. 3 illustrates a block diagram of a digital twin system 300 that may be configured to generate reports and analysis outputs from digital twin data using machine learning models, such as LLMs and AI agents. In the current example, the digital twin system 300 may include a system 302 that communicates with display devices 304 to provide visualization and interaction capabilities for users engaging with digital twin content. In some cases, the display devices 304 may include various devices such as laptops, head-mounted displays, mobile devices, and other visualization platforms that may enable users to access, view, and interact with digital twin information and generated reports including 3D immersive image data.

In some implementations, the system 302 may process queries 308 received from the display systems 304 to generate detailed analysis and reporting data 316. For example, the user may submit the model edit requests 308 in a conversational text-based or audio-based request as if the user was asking another individual for feedback. As some illustrative examples of the model edit requests 308, a user may submit request 308 in a similar style and content as to the following: “how many interior doors are there in the space?,” “provide a list of all windows, their dimensions, and their energy efficiency rating,” “what is the square footage of all walls, excluding doors, windows, and openings,” “how much paint is needed to cover all the walls,” “what is the total square footage of flooring, split by room type (e.g., wet spaces vs. dry spaces),” “how many rolls of carpet are needed to cover all bedrooms,” “does each room have a smoke detector,” “how much labor is needed, and what is the cost to replace all baseboards,” “provide a list of all appliances, their models, and their dimensions,” “identify the manufacturer and model of an appliance and provide recall information, maintenance and usage guidance,” “please calculate and make recommendations based on volume, heat mapping, internet strength for location to place smoke detectors or other safety items,” “provide engineering planning such as air-conditioning, plumbing, electric, etc.,” “what is the likelihood that certain objects contain asbestos or are made of organic material,” “provide a list of the items easiest to recycle, re-use, or re-purpose,” “provide a list of the items that may be toxic and require special equipment or consideration during demolition,” and/or the like.

In some aspects, the system 302 may generate, based at least in part on the queries 308, prompt data 310 to interface with machine learning models 306. For example, the system 302 may generate the prompt data 310 using the queries 308 together with the corresponding 3D model or digital twin of the physical environment. In some cases, the prompt data 310 may include a reference to or copy of the text-based descriptor data of the digital twin. Accordingly, the machine learning models 306 may receive the prompt data 310 including the query (or a modified query) and the text-based descriptor data of the corresponding digital twin.

In the current example, the machine learning models 306 (e.g., LLMs, AI agents, and/or the like) may process the prompt data 310 to generate output data 312 (such as edits to the digital twin, text-based reports, estimates, specifications, analytical insights, and/or the like). In some implementations, the output data 312 may encompass various data types that provide information about the physical environment represented in the digital twin. In some cases, the output data 312 may include analytics data 316, characteristic data 318, quote data 320, object data 322, material data 324, and dimension data 326 that collectively provide information about the physical environment and its components, objects, and/or features.

In some aspects, the analytics data 316 may include structured documentation such as floor plans, room layouts, architectural drawings, and space assessments that may be generated in multiple formats including PDF documents, interactive web reports, or printable summaries. In some cases, the analytics data 316 may also incorporate visual elements such as annotated diagrams, measurement overlays, and comparative analyses between different areas or configurations within the physical environment.

In some examples, the characteristic data 318 may provide detailed properties and attributes of identified elements within the space, including material compositions, surface finishes, structural properties, and functional specifications of architectural components. In some aspects, the characteristic data 318 may encompass information about lighting conditions, acoustic properties, accessibility features, and environmental factors that may influence the use and functionality of the physical space.

In some implementations, the quote data 320 may include cost estimates and pricing information for materials, labor, equipment, and project components based at least in part on the analytic data 316 of the digital twin. In some cases, the quote data 320 may provide itemized breakdowns of expenses, alternative pricing scenarios, regional cost adjustments, and timeline-based cost projections that may assist users in budgeting and project planning activities. In some aspects, the quote data 320 may also include vendor recommendations, material sourcing options, and cost optimization suggestions based on the specific requirements identified within the digital twin.

In some examples, the object data 322 may provide detailed inventories and specifications of furniture, fixtures, appliances, and other elements present within the physical environment. In some cases, the object data 322 may include dimensional specifications, model numbers, installation requirements, maintenance schedules, and replacement recommendations for identified objects. In some aspects, the object data 322 may also encompass spatial relationships between objects, traffic flow considerations, and functional groupings that may inform space planning and optimization decisions.

In some implementations, the material data 324 may include information about construction materials, finishes, surface properties, and structural components identified within the digital twin. In some cases, the material data 324 may provide specifications such as material grades, performance characteristics, durability ratings, maintenance requirements, and compatibility information for renovation or modification projects. In some aspects, the material data 324 may also include sustainability metrics, cost comparisons, and availability information that may support material selection and procurement processes.

In some examples, the dimension data 326 may provide precise measurements and spatial relationships between elements within the physical environment. In some cases, the dimension data 326 may include room dimensions, ceiling heights, opening sizes, clearance measurements, and volumetric calculations that may be formatted in various units of measurement and presentation formats. In some aspects, the dimension data 326 may also encompass area calculations, perimeter measurements, and spatial efficiency metrics that may support space utilization analysis and planning activities.

In some implementations, the system 302 may utilize the output data 312 to generate report data 328 that may provide detailed documentation and analysis of the physical environment represented in the digital twin to the user (such as back to the display device 304 or other device issuing a query 308). In some aspects, the system 302 may process the output data 312 to extract relevant information and format it into structured reports 328 that may include floor plans, dimensional specifications, material inventories, cost estimates, and/or the like. In some cases, the analytics data 316 may be generated in various formats including PDF documents, spreadsheets, interactive web-based reports, or other presentation formats that may facilitate sharing and review by stakeholders.

In some cases, the system 302 may also update the 3D model or digital twin 314 of the physical environment according to the output data 312, such as when the output data 312 includes changes or potential changes (e.g., a remodel preview) to the physical environment. In some aspects, this updating process may involve analyzing the output data 312 to identify specific modifications, additions, or alterations that should be applied to the existing 3D model or digital twin 314 representation. In some implementations, the system 302 may parse the output data 312 to extract geometric changes, material substitutions, structural modifications, or layout adjustments that were generated by the machine learning models 306 in response to user queries or design requests.

In some examples, the system 302 may translate textual descriptions of proposed changes from the output data 312 into corresponding 3D geometric modifications, color adaptations, textures updates, and/or the like within the digital twin 314, ensuring that visual representations accurately reflect the suggested alterations. In some cases, the system 302 may generate multiple versions of the 3D model or digital twin 314, including both the original representation and updated versions that incorporate the changes specified in the output data 312, allowing users to compare different scenarios or design options. In some aspects, the system 302 may also maintain version control and change tracking capabilities that may document the evolution of the digital twin 314 over time, providing users with the ability to review modification history and revert to previous configurations if needed.

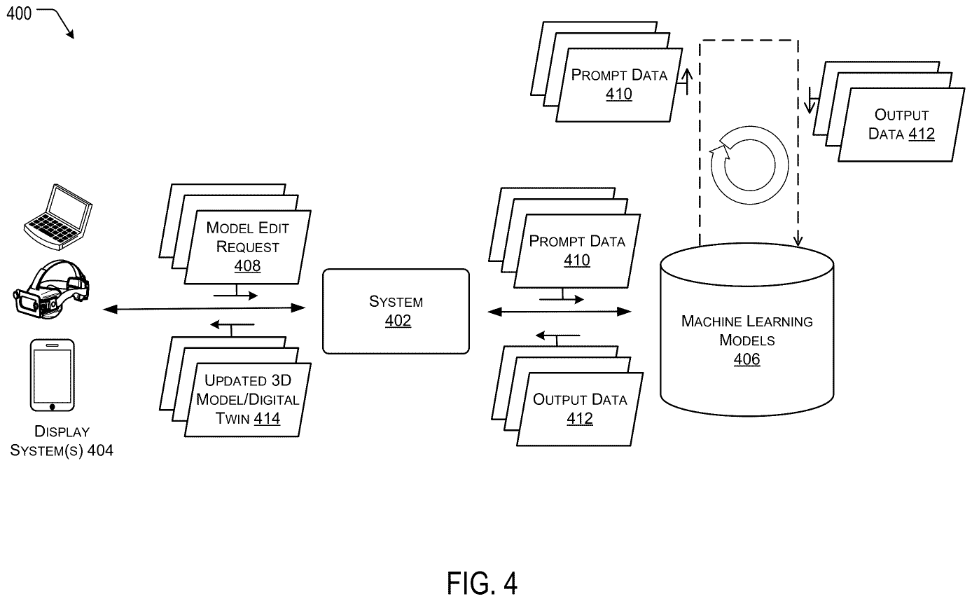

FIG. 4 illustrates a block diagram of a digital twin system 402 that may be configured to process model edit requests and generate updated digital twin representations using machine learning models. In the current example, the digital twin system 402 may include display systems 404 that provide visualization and interaction capabilities for users 400 engaging with digital twin content. In some cases, the display systems 404 may include various devices such as laptops, augmented reality displays, virtual reality disapply, mixed reality displays, mobile devices, and other visualization platforms that may enable users 400 to access, view, and interact with digital twin information and submit modification requests.

In some implementations, the digital twin system 402 may process model edit requests 408 (e.g., a model edit query) received from the display systems 404 to generate updated digital twin representations. In some aspects, the digital twin system 402 may generate, based at least in part on the model edit requests 408, prompt 410 to interface with machine learning models 406 (e.g., LLMs and/or AI agents). For example, the digital twin system 402 may generate the prompt 410 using the model edit requests 408 together with the corresponding 3D model or digital twin of the physical environment. In some cases, the prompt 410 may include a reference to or copy of the text-based descriptor data of the digital twin along with the specific modification parameters requested by the user 400. Accordingly, the machine learning models 406 may receive the prompt 410 including the edit request (or a modified edit request) and the text-based descriptor data of the corresponding digital twin.

In the current example, the machine learning models 406 (e.g., LLMs, AI agents, and/or the like) may process the prompt 410 to generate output data 412 that includes updated 3D model representations reflecting the requested modifications. In some implementations, the output data 412 may encompass various data types that provide modified information about the physical environment represented in the digital twin. In some cases, the output data 412 may include updated geometric specifications, revised material assignments, altered spatial configurations, and modified object placements that collectively represent the requested changes to the physical environment.

In some examples, the system 402 may utilize output data 412 to modify or generate an updated 3D model or digital twin 414. In some aspects, this modification process may involve analyzing the output data 412 to identify specific changes, updates, or enhancements that should be applied to the existing digital twin representation. In some cases, the system 402 may parse the output data 412 to extract geometric modifications, material updates, structural alterations, or layout changes that were generated by the machine learning models 406 in response to the model edit requests 408.

In some implementations, the system 402 may translate the textual or structured modifications from the output data 412 into corresponding visual and geometric changes within the 3D model or digital twin 414. In some aspects, this translation process may involve updating object positions, modifying dimensions, changing material properties, or altering spatial relationships between elements within the digital representation. In some cases, the system 402 may also apply color changes, texture modifications, and lighting adjustments to accurately reflect the requested modifications in the visual representation of the physical environment.

In some examples, the system 402 may generate comparative versions of the 3D model or digital twin 414, including both the original state and the modified state that incorporates the changes specified in the output data 412. In some aspects, this approach may allow users 400 to visualize the differences between the current configuration and the proposed modifications through side-by-side comparisons or overlay visualizations. In some cases, the system 402 may also provide interactive tools that enable users 400 to toggle between different versions or view progressive modification sequences to better understand the impact of the requested changes.

In some examples, the digital twin system 402 may generate multiple 3D model or digital twin 414 representations within the output data 412, allowing users 400 to compare the original digital twin with various modification options. In some cases, the output data 412 may include side-by-side comparisons, overlay visualizations, and progressive modification sequences that may assist users 400 in understanding the impact of proposed changes. In some aspects, the digital twin system 402 may also generate cost implications, timeline estimates, and resource requirements associated with the requested modifications as part of the output data 412.

In some implementations, the digital twin system 402 may facilitate format conversion and specialized analysis capabilities that enable different professional applications to utilize the same underlying digital twin data for their specific requirements. For example, an architect may utilize the system 402 to submit a model edit request 408 through the display systems 404 to convert a digital twin originally created for construction planning into a point cloud format suitable for structural analysis. In some aspects, the architect may specify through the model edit request 408 that the existing 3D model or digital twin should be processed to extract structural elements, load-bearing components, and geometric relationships in a point cloud representation that may be imported into structural analysis software. In some cases, the output data 412 may include filtered geometric data that emphasizes structural elements while removing nonstructural components such as furniture, fixtures, or decorative elements that are not relevant for structural calculations. In some implementations, the system 402 may generate an updated 3D model or digital twin 414 that presents the point cloud data in formats compatible with engineering analysis tools, enabling the architect to perform load calculations, stress analysis, or structural optimization based on the precise geometric characteristics captured in the original digital twin.

In some specific examples, an e-commerce platform may utilize the digital twin system 402 to submit model edit requests 408 for extracting visual staging data from residential or commercial digital twins. In some cases, the e-commerce platform may request through the model edit request 408 that the system 402 process existing digital twin representations to identify optimal product placement locations, lighting conditions, and spatial configurations that would enhance virtual product demonstrations. In some examples, the machine learning models 406 may analyze the prompt 410 containing the staging requirements together with the text-based descriptors of room layouts, furniture arrangements, and spatial characteristics to generate output data 412 that includes recommended product placement zones, camera angles, and environmental settings for virtual staging applications. In still other examples, the system 402 may generate an updated 3D model or digital twin 414 that incorporates virtual staging elements, product placements, and environmental modifications that showcase how various objects would appear within the physical space, enabling customers to visualize products in realistic settings before making purchase decisions.

In some implementations, while FIGS. 3 and 4 are discussed with respect to a single digital twin and a single physical environment, it should be understood that the system 102 may be able to provide information or data associated with multiple digital twins or aggregated data from multiple digital twins (e.g., such as multiple digitals twin associated with a specific geographic area). For example, in some cases, there may be use cases that could span across multiple properties or physical environments as well. For instance, a user may submit a query 308 or a request 408 to ask questions specific to a portfolio of products or properties, such as “What are the most common bathroom fixture brands or types in our portfolio?” In some aspects, if the data is aggregated across multiple digital twins and physical environments and anonymized, the systems 302 and/or 402 may compare and contrast data, such as “what is the most common bedroom paint color in San Francisco vs New York” or “what is the average number of televisions in homes between 1500 and 2500 sq ft?”

In some examples, the systems 302 and 402 may process queries 308 and requests 408 that require analysis across multiple digital twin representations to generate comparative insights, trend analysis, or portfolio-wide assessments. In some cases, the machine learning models may analyze text-based descriptors from numerous digital twins to identify patterns, commonalities, or variations across different properties, geographic regions, or demographic segments. In some implementations, the aggregated analysis capabilities may enable property managers, real estate professionals, or researchers to gain insights into market trends, design preferences, or regional characteristics that would not be apparent from individual property assessments.

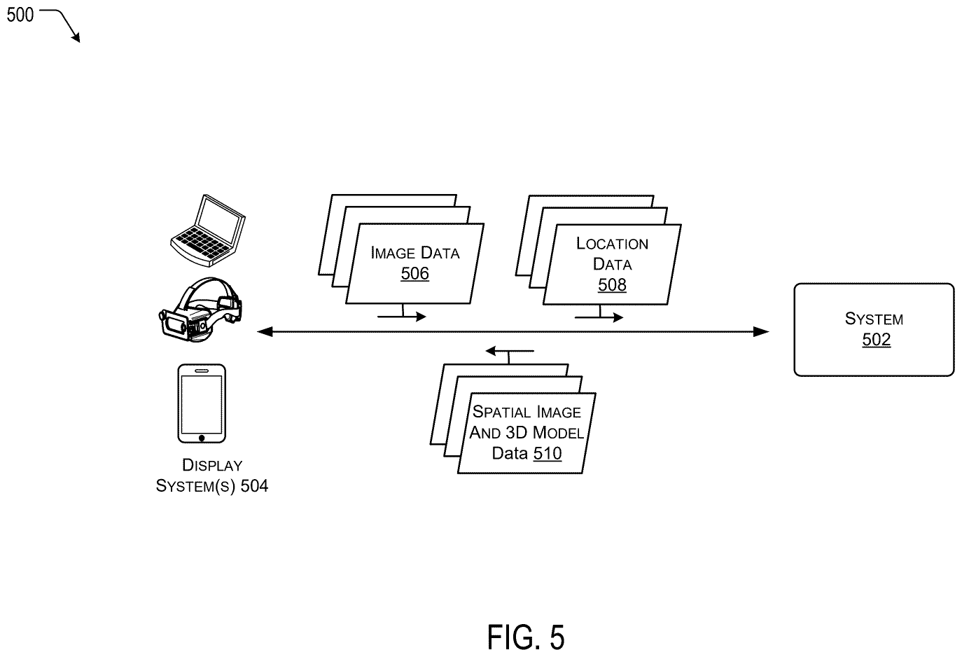

FIG. 5 illustrates a block diagram of a digital twin system 500 that may be configured to spatially register photos and videos with digital twin representations using machine learning models and spatial tracking technologies. In the current example, the digital twin system 500 may include a system 502 that communicates with display devices 504 to provide visualization and interaction capabilities for users engaging with digital twin content. In some cases, the display devices 504 may include various devices such as laptops, head-mounted displays, mobile devices, and other visualization platforms that may enable users to access, view, and interact with spatially registered photos and videos within digital twin environments.

In some implementations, photos and videos captured in a physical space may not be inherently linked to spatial data, such as positioned within a digital twins. In some aspects, this lack of spatial registration may make it challenging to understand exactly where in the digital twin the photos and videos were taken. Conventionally, users needed to manually interpret or manually align these media with existing digital twins and 3D models, which may be time-consuming and prone to error.

In some examples, the digital twin system 500 may process image data 506 and location data 508 received from the display devices 504 to spatially registered image data within a digital twin 510. In some aspects, the system 502 may generate, based at least in part on the image data 506 and location data 508, a spatial coordinate for aligning the image data 506 with the digital twin 510. For example, the system 502 may utilize place recognition algorithms, inertial measurement unit (IMU) data, and camera pose estimation to determine the precise location and orientation where media was captured within the physical environment. In some cases, spatial context information or analysis may be utilized to align, embed, or overlay the image data 506 directly on top of the digital twin from the exact viewpoint and position where the media was captured.

In some examples, the system 502 may enable spatial photo capture and integration during the process of capturing or generating a digital twin. In these examples, users may take photos that are associated with their precise location and orientation within the space, enabling the creation of “spatial photos” that may be seamlessly embedded in the digital twin as the location data 508 for the photos aligns directly with the location data of the input data used to create the digital twin itself. In some cases, for photos taken outside of a digital twin capture session, the system 502 may use visual place recognition algorithms, optionally combined with IMU data and camera pose estimation, to determine where the photo was taken and align these photos with the digital twin based on spatial data.

In some examples, the system 502 may allow users to record videos during a digital twin capture session, with the option to include camera pose data and IMU readings. In some aspects, the system 502 may use this data to align the video to the digital twin in real-time, ensuring that the video is spatially registered with the 3D model or CAD/BIM representation. In some cases, for videos taken outside of a digital twin capture, the system 502 may use a combination of visual place recognition and spatial tracking to align the video with the digital twin, resulting in a “spatial video” that may be viewed in context with the 3D model or digital twin 510.

In some implementations, the system 502 may provide interactive spatial photo and video display capabilities. In some aspects, when displaying spatially registered photos or videos, the system 502 may show their exact position on the floor plan or 3D digital twin, allowing users to click on a location in the digital twin to see all photos or videos captured from that point or view the space from the same viewpoint as a specific photo or video. In some cases, the system 502 may display a split-screen or overlay mode where the video is shown alongside the digital twin, with both views updating simultaneously as the user moves through the video.

In some examples, the system 502 may facilitate construction site management and inspection workflows through immersive visualization capabilities. In some cases, a construction foreman may view a digital twin of a job site in VR, with spatial photos and videos overlaid at the precise locations where they were captured. In some aspects, this immersive approach may allow for more inspection and review processes, enabling construction professionals to make informed decisions based on real-world visual data that is spatially contextualized within the digital twin environment. In some implementations, the system 502 may provide construction or design professionals with the ability to view photos and videos taken on the construction site overlaid on top of the as-built or planned design, facilitating comparison between intended specifications and actual construction progress.

In some implementations, the system 502 may support targeted search and filtering capabilities for spatial media content. In some aspects, building inspectors may search for all spatial photos showing specific systems, such as electrical installations in a particular corridor or area. In some cases, the system 502 may filter and display only the relevant photos based on spatial location and content recognition, potentially saving time and effort in documentation and reporting processes. In some examples, this targeted filtering may enable inspectors to quickly access visual documentation of specific building systems or components without manually reviewing extensive photo collections.

In some examples, the system 502 may enhance real estate presentation and marketing capabilities through integrated spatial media display. In some cases, real estate agents may present virtual tours of properties, showing spatial photos and videos in conjunction with the digital twin representation. In some aspects, potential buyers may view real-world images overlaid on the 3D model, providing enhanced understanding of the space and its current conditions. In some implementations, this combined approach may allow prospective buyers to experience both the spatial layout through the digital twin and the actual visual appearance through spatially registered photographs and videos, potentially improving their ability to evaluate properties remotely or during guided virtual tours.

In some implementations, the system 502 may integrate with AR, VR, XR, and similar platforms, allowing users to view spatial media content or data in an immersive environment. In some aspects, users may “walk through” the digital twin in VR and view spatial photos or videos overlaid in their original positions within the space, adding an interactive, immersive layer to the experience. In some cases, the system 502 may implement search and filtering features that leverage spatial metadata to find specific photos or videos based on criteria such as location, viewpoint, or subject.

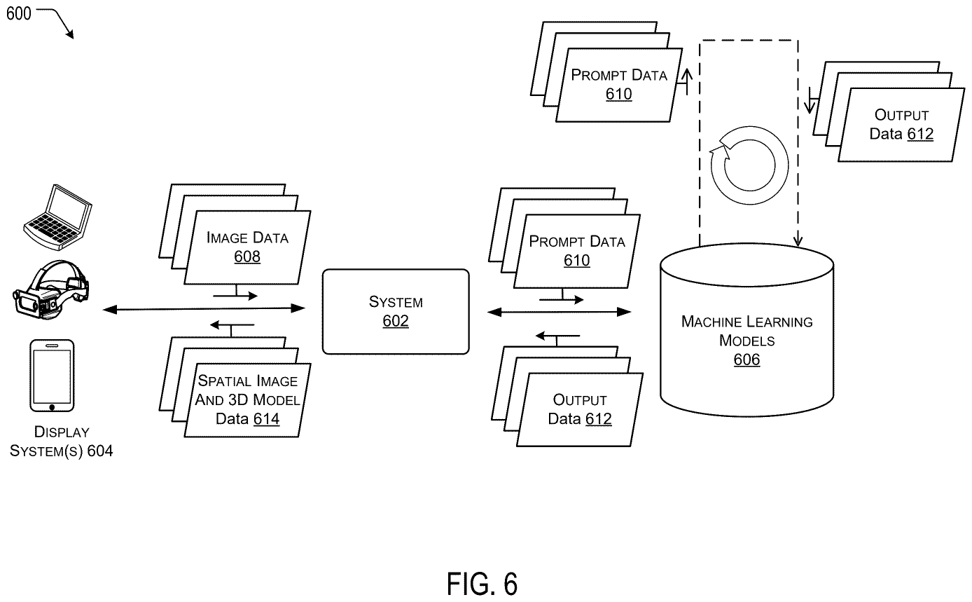

FIG. 6 illustrates a block diagram of a digital twin system 600 that may be configured to process image data and generate spatially registered visual content within digital twin representations using machine learning models. In the current example, the digital twin system 600 may include a system 602 that communicates with display devices 604 to provide visualization and interaction capabilities for users engaging with digital twin content. In some cases, the display devices 604 may include various devices such as laptops, head-mounted displays, mobile devices, and other visualization platforms that may enable users to access, view, and interact with spatially registered image content within digital twin environments.

In some implementations, the digital twin system 600 may process image data 608 received from the display devices 604 to generate spatially registered visual content within digital twin representations. In some aspects, the system 602 may generate, based at least in part on the image data 608, prompt data 610 to interface with machine learning models 606. For example, the system 602 may generate the prompt data 610 as a text-based input prompt for a LLM or AI agent using the image data 608 together with the corresponding text-based descriptors of the 3D model or digital twin of the physical environment. In some cases, the prompt data 610 may include a reference to or copy of the text-based descriptor data of the digital twin along with the specific image content provided by the user.

In the current example, the machine learning models 606 (e.g., LLMs, AI agents, and/or the like) may process the prompt data 610 to generate output data 612 that includes spatially registered image information (e.g., location data within the digital twin to place or register the image data or photo 608) usable to spatially register the image data 608 with regard to the digital twin. For example, the system 602 may translate the spatial positioning information from the output data 612 into corresponding visual overlays and geometric alignments within the spatial image and 3D model data or digital twin 614.

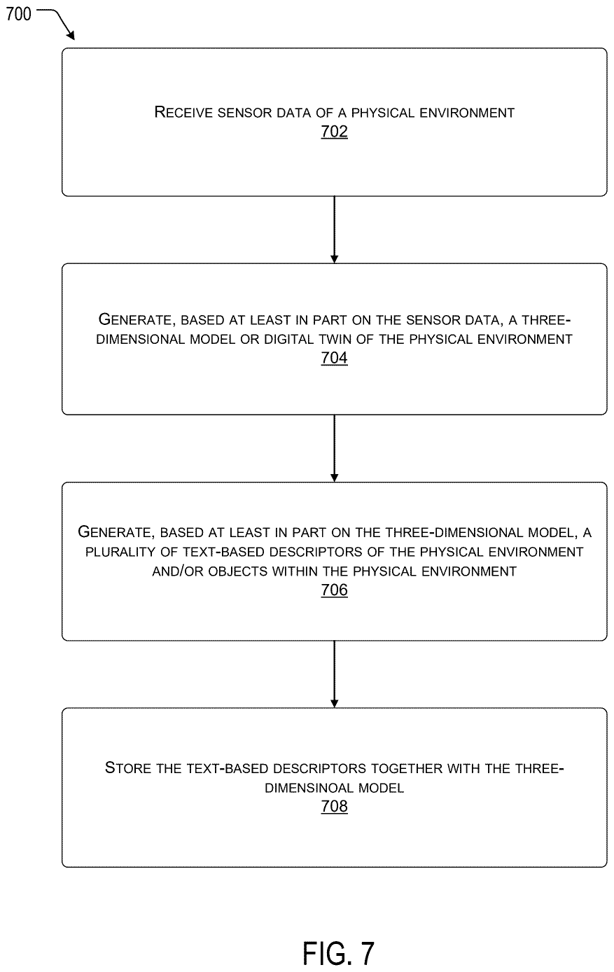

FIGS. 7-12 are flow diagrams illustrating example processes associated with the system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 7 illustrates a flow diagram of a process 700 for generating and storing text-based descriptors of a physical environment based on sensor data and a 3D model or digital twin, according to some implementations. The process 700 may be performed by the digital twin system in conjunction with one or more scanning devices positioned within or directed toward a physical environment.

At 702, the digital twin system may receive sensor data of a physical environment. In some cases, the physical environment may correspond to an interior space of a building, facility, or other structure, and the sensor data may be captured by scanning devices having fields of view directed toward various areas within the environment. The sensor data may include three-dimensional image data, point cloud data, LIDAR data, depth information, photogrammetry data, infrared data, and/or other spatial measurements that capture the geometric structure and contents of the physical space. In some implementations, the scanning devices may be positioned at multiple locations within the environment to ensure coverage of all areas, including walls, floors, ceilings, openings, fixtures, furniture, and other architectural or functional elements present within the space.

At 704, the digital twin system may generate a 3D model or digital twin of the physical environment based at least in part on the sensor data. In some aspects, the generation process may involve processing the sensor data to construct geometric representations, identify spatial relationships, and create structured digital representations of the physical space. The system may utilize point cloud processing algorithms, mesh generation techniques, three-dimensional reconstruction methods, SfM techniques, SLAM techniques, and surface reconstruction methods to convert the raw sensor data into the structured three-dimensional model. The three-dimensional model may include detailed representations of architectural elements such as room boundaries, structural components, openings like doors and windows, built-in fixtures, and moveable objects within the environment. In some cases, the system may also incorporate computer-aided design (CAD) data or Building Information Modeling (BIM) data to enhance the accuracy and completeness of the three-dimensional model generation process.

At 706, the digital twin system may generate a plurality of text-based descriptors of the physical environment and objects within the physical environment based at least in part on the three-dimensional model. In some implementations, the text-based descriptors may include structured descriptions of architectural features, object properties, spatial relationships, dimensions, materials, and other characteristics of elements within the physical environment. The system may analyze the geometric data contained within the three-dimensional model to identify object boundaries, calculate dimensions, and determine spatial orientations to create textual descriptions of each element. In some cases, the system may utilize computer vision techniques and object recognition algorithms to identify specific features such as doors, windows, walls, fixtures, and furniture, subsequently generating corresponding text-based descriptors that capture the characteristics and properties of these identified objects. The text-based descriptors may be formatted in machine-readable formats such as JSON, XML, or other structured formats that may facilitate efficient processing by machine learning models, large language models, and artificial intelligence agents.

At 708, the digital twin system may store the text-based descriptors together with the three-dimensional model or digital twin. In some aspects, the storage process may involve maintaining associations between the textual descriptions and corresponding geometric elements within the three-dimensional model, enabling coordinated access to both representations of the physical environment. The system may implement synchronization mechanisms to ensure consistency between the text-based descriptors and the visual representations, where modifications to either format may trigger updates to the corresponding representation. In some cases, the stored text-based descriptors and three-dimensional model may be subsequently utilized for various applications including information extraction, analysis, visualization, modification requests, and report generation through interactions with large language models and artificial intelligence agents. The storage may also include version control capabilities that document changes to both the text-based descriptors and three-dimensional model over time, providing users with the ability to track modifications and revert to previous configurations when needed.

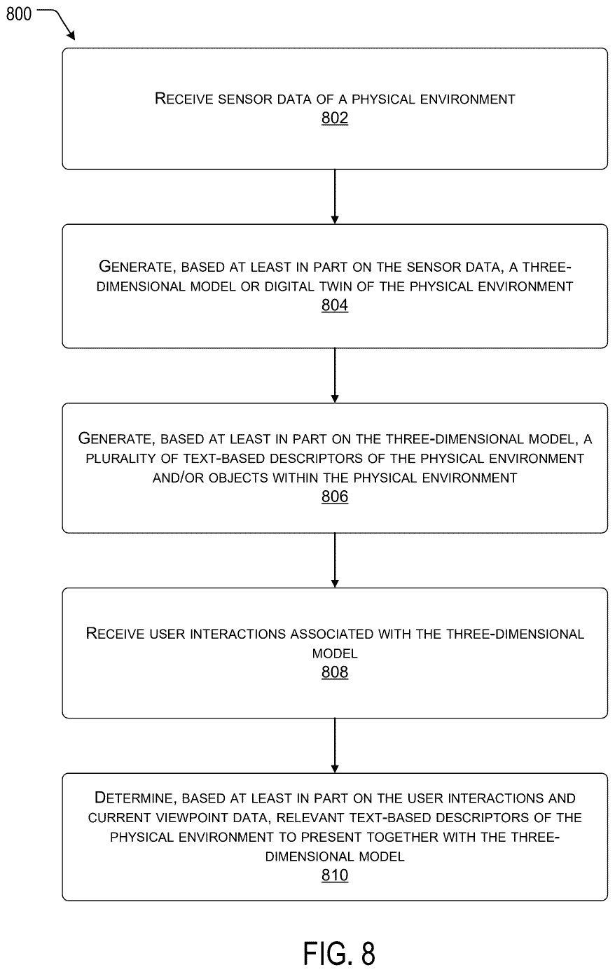

FIG. 8 illustrates a flow diagram of a process 800 for facilitating user interactions with a digital twin of a physical environment using machine learning models, according to some implementations. The process 800 may be performed by the digital twin system in conjunction with one or more machine learning models such as large language models and artificial intelligence agents to enable natural language interactions with digital twin representations.

At 802, the digital twin system may receive sensor data of a physical environment. In some cases, the physical environment may correspond to an interior space of a building, facility, or other structure, and the sensor data may be captured by scanning devices having fields of view directed toward various areas within the environment. The sensor data may include three-dimensional image data, point cloud data, LIDAR data, depth information, photogrammetry data, infrared data, inertial measurement unit (IMU) data, and/or other spatial measurements that capture the geometric structure and contents of the physical space. In some implementations, the scanning devices may be positioned at multiple locations within the environment to ensure coverage of all areas, including walls, floors, ceilings, openings, fixtures, furniture, and other architectural or functional elements present within the space.

At 804, the digital twin system may generate a 3D model or digital twin of the physical environment based at least in part on the sensor data. In some aspects, the generation process may involve processing the sensor data to construct geometric representations, identify spatial relationships, and create structured digital representations of the physical space. The system may utilize point cloud processing algorithms, mesh generation techniques, three-dimensional reconstruction methods, SfM techniques, SLAM techniques, and surface reconstruction methods to convert the raw sensor data into the structured three-dimensional model. The three-dimensional model may include detailed representations of architectural elements such as room boundaries, structural components, openings like doors and windows, built-in fixtures, and moveable objects within the environment. In some cases, the system may also incorporate computer-aided design (CAD) data or Building Information Modeling (BIM) data to enhance the accuracy and completeness of the three-dimensional model generation process.

At 806, the digital twin system may generate a plurality of text-based descriptors of the physical environment and objects within the physical environment based at least in part on the three-dimensional model. In some implementations, the text-based descriptors may include structured descriptions of architectural features, object properties, spatial relationships, dimensions, materials, and other characteristics of elements within the physical environment. The system may analyze the geometric data contained within the three-dimensional model to identify object boundaries, calculate dimensions, and determine spatial orientations to create textual descriptions of each element. In some cases, the system may utilize computer vision techniques and object recognition algorithms to identify specific features such as doors, windows, walls, fixtures, and furniture, subsequently generating corresponding text-based descriptors that capture the characteristics and properties of these identified objects. The text-based descriptors may be formatted in machine-readable formats such as JSON, XML, or other structured formats that may facilitate efficient processing by machine learning models (e.g., LLM, AI agents, and/or the like).

At 808, the digital twin system may receive user interactions associated with the 3D model or digital twin. In some aspects, the user interactions may include queries, modification requests, analysis requests, or other input commands that specify desired information extraction or changes to the digital twin representation. In some cases, the queries may be submitted in natural language format, such as text-based or voice-based requests for specific information about the physical environment, including questions about dimensions, materials, object locations, or spatial relationships. In some implementations, the modification requests may include instructions to alter elements within the digital twin, such as changing door heights, repositioning furniture, modifying wall configurations, or updating material specifications. In some examples, the analysis requests may involve generating reports, cost estimates, floor plans, or comparative studies based on the digital twin data. In some aspects, the user interactions may be received through various interfaces including chat-style input systems, application programming interfaces, voice commands, or graphical user interface elements that allow users to select, manipulate, or query specific objects within the three-dimensional model visualization.

At 810, the digital twin system may determine relevant text-based descriptors of the physical environment based at least in part on the user interactions and current viewpoint data to present together with the three-dimensional model. In some implementations, the system may analyze the user's current viewing perspective, interaction history, and specific requests to identify which text-based descriptors are most relevant for display. The system may adjust the displayed information based on factors such as camera location, orientation, zoom level, and areas of user focus within the digital twin. In some aspects, the system may utilize contextual filtering algorithms to prioritize text-based descriptors that correspond to objects or features currently visible within the user's field of view, thereby reducing information overload and enhancing user experience. In some cases, the system may also consider temporal factors such as recent user queries or previously accessed information to maintain continuity in the displayed descriptors. In some examples, the determination process may involve analysis of user gaze patterns, cursor movements, or touch interactions to predict which elements or features of the digital twin are of greatest interest to the user. In some implementations, the system may provide layered information display capabilities, where basic descriptors are shown by default and more detailed technical specifications become available through progressive disclosure based on user engagement levels or explicit requests for additional information.

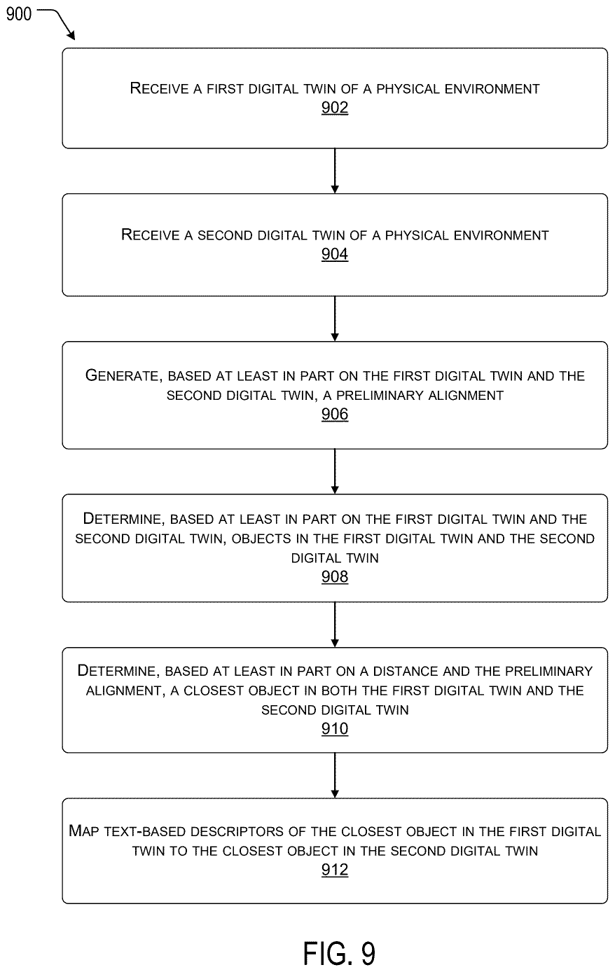

FIG. 9 illustrates a flow diagram of a process 900 for mapping text-based descriptors between different digital twins of the same physical environment, according to some implementations. The process 900 may be performed by the digital twin system to maintain consistency and transfer information between multiple representations of a physical space that may have been captured at different times or generated using different methods.

At 902, the digital twin system may receive a first digital twin of a physical environment. In some cases, the first digital twin may include a three-dimensional model representation along with associated text-based descriptors that describe architectural features, objects, and spatial relationships within the physical environment. The first digital twin may have been generated from sensor data captured during an initial scanning session and may contain user annotations, analysis results, or other information that has been added over time through various interactions and processing operations.

At 904, the digital twin system may receive a second digital twin of the physical environment. In some aspects, the second digital twin may represent the same physical space as the first digital twin but may have been captured at a different time, processed using alternative methods, or generated with varying levels of detail and accuracy. The second digital twin may include updated geometric representations that reflect changes to the physical environment, such as renovations, furniture rearrangements, or structural modifications that have occurred since the first digital twin was created.

At 906, the digital twin system may generate a preliminary alignment based at least in part on the first digital twin and the second digital twin. In some implementations, the preliminary alignment process may involve analyzing geometric features, spatial relationships, and structural elements common to both digital twins to establish correspondence between the two representations. The system may utilize transformation matrices, feature matching algorithms, and spatial registration techniques to determine how the coordinate systems and spatial references of the two digital twins relate to one another. In some cases, the preliminary alignment may account for differences in capture positions, orientation variations, or scale discrepancies between the two digital twin representations.

In one example, the second digital twin may be a text-based descriptor digital twin that contains structured textual descriptions of the physical environment that the system is registering as textual spatial references with geometric elements from the first digital twin during the alignment process. For example, the system may align the text-based descriptor data of specific object with the corresponding object within the 3D model digital twin.

At 906, the digital twin system may generate a preliminary alignment based at least in part on the first digital twin and the second digital twin. In some implementations, the preliminary alignment process may involve analyzing geometric features, spatial relationships, and structural elements common to both digital twins to establish correspondence between the two representations. The system may utilize transformation matrices, feature matching algorithms, and spatial registration techniques to determine how the coordinate systems and spatial references of the two digital twins relate to one another. In some cases, the preliminary alignment may account for differences in capture positions, orientation variations, or scale discrepancies between the two digital twin representations.

At 908, the digital twin system may determine objects in the first digital twin and the second digital twin, based at least in part on the first digital twin and the second digital twin. In some aspects, this determination process may involve identifying and classifying architectural elements, fixtures, furniture, appliances, and other components present within both digital twin representations. The system may analyze geometric properties, spatial positions, dimensional characteristics, and semantic attributes to recognize and catalog objects across the two digital twins. In some cases, the object determination may utilize machine learning models or computer vision techniques to detect and classify elements within each digital twin representation.

At 910, the digital twin system may determine a closest object in both the first digital twin and the second digital twin based at least in part on a distance and the preliminary alignment. In some implementations, this determination may involve calculating spatial distances between objects identified in the first digital twin and candidate corresponding objects in the second digital twin, utilizing the preliminary alignment to establish a common coordinate system for accurate distance measurements. The system may evaluate proximity metrics, geometric similarity measures, and spatial relationships relative to surrounding elements to identify the most likely corresponding object pairs. In some cases, the closest object determination may consider factors such as object type, dimensional similarity, and contextual positioning within the physical environment.

At 912, the digital twin system may map text-based descriptors of the closest object in the first digital twin to the closest object in the second digital twin. In some aspects, this mapping process may involve transferring annotations, specifications, measurements, user notes, analysis results, or other textual information associated with the identified object in the first digital twin to the corresponding object in the second digital twin. The mapping may preserve user-generated content, historical data, or documentation that has been attached to objects over time, ensuring continuity of information across different versions or representations of the same physical environment. In some cases, the system may also merge or reconcile conflicting information when text-based descriptors from both digital twins contain different values or descriptions for the same object properties.

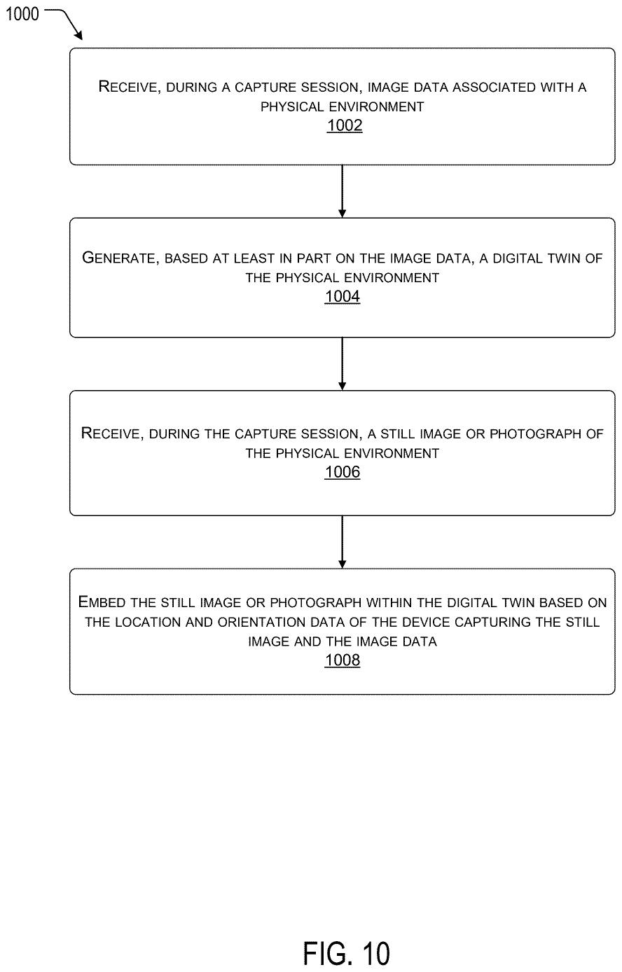

FIG. 10 illustrates a flow diagram of a process 1000 for spatially registering image data within a digital twin of a physical environment, according to some implementations. The process 1000 may be performed by the digital twin system to integrate photographs and videos captured within a physical space with their corresponding spatial locations in the digital twin representation.

At 1002, the digital twin system may receive image data associated with a physical environment during a capture session. In some cases, the image data may include photographs, video frames, or other visual content captured within the physical space using various imaging devices such as cameras, mobile devices, or specialized capture equipment. The image data may be accompanied by metadata including capture timestamps, device specifications, and preliminary location information that may assist in subsequent spatial registration processes. In some implementations, the image data may be captured simultaneously with sensor data used for digital twin generation, or may be collected during separate documentation sessions within the same physical environment.

At 1004, the digital twin system may generate a digital twin of the physical environment based at least in part on the image data. In some aspects, this generation process may involve processing the image data together with additional sensor data such as LIDAR scans, depth measurements, or photogrammetry data to construct geometric representations of the physical space. The system may utilize computer vision algorithms, structure-from-motion techniques, and spatial reconstruction methods to create structured digital representations that capture the architectural elements, objects, and spatial relationships within the environment. In some cases, the digital twin generation may incorporate machine learning models to enhance object recognition, surface reconstruction, and spatial accuracy of the resulting three-dimensional representation.

At 1006, the digital twin system may receive a still image or photograph of the physical environment during the capture session. In some implementations, the still image may be captured using the same imaging device used for digital twin generation or may be obtained from a different camera or mobile device operated within the physical space. The still image may include visual details of specific areas, objects, features, or conditions within the physical environment that provide additional documentation or context beyond the geometric information captured in the digital twin. In some aspects, the still image may be associated with location data, orientation information, or camera pose data that indicates the position and viewing direction from which the photograph was taken.

At 1008, the digital twin system may embed the still image or photograph within the digital twin based on the location and orientation data of the device capturing the still image and the image data. In some aspects, this embedding process may involve determining the precise spatial coordinates, viewing angle, and camera pose from which the still image was captured, utilizing information such as GPS coordinates, inertial measurement unit readings, visual place recognition algorithms, or manual positioning data. The system may align the still image with the corresponding location within the digital twin representation, creating spatial associations that allow users to view the photograph in its proper context within the three-dimensional model. In some cases, the embedded still image may be accessible through interactive elements within the digital twin visualization, enabling users to navigate to specific locations and view associated photographs, or to select photographs and navigate to their capture locations within the digital twin. In some implementations, the system may provide overlay capabilities where still images are displayed as spatial annotations, viewpoint markers, or immersive content that enhances the user's understanding of the physical environment represented in the digital twin.

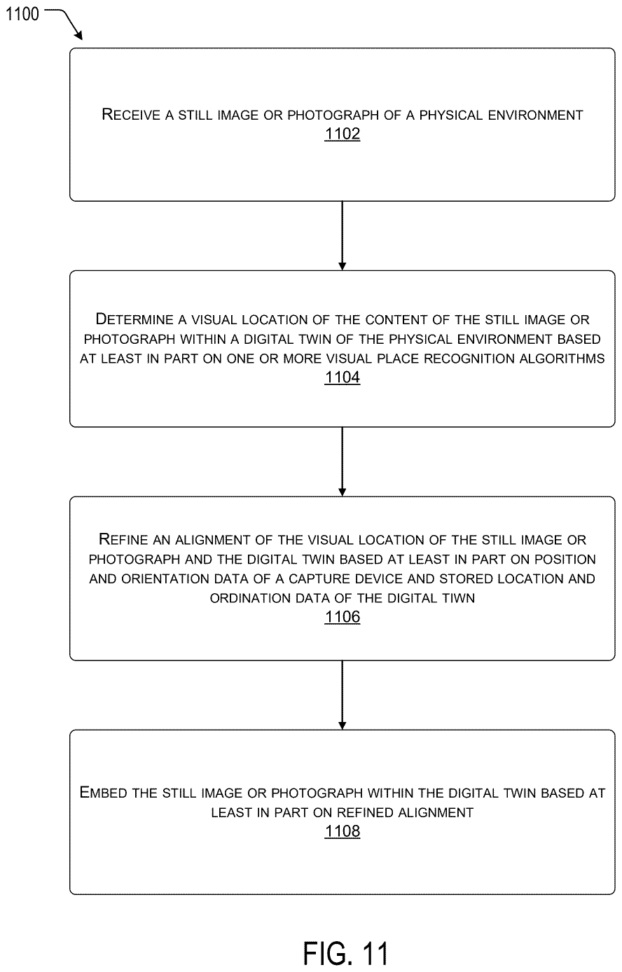

FIG. 11 illustrates a flow diagram of a method 1100 for embedding spatially registered image content within a digital twin of a physical environment using visual place recognition algorithms, according to some implementations. The method 1100 may be performed by the digital twin system to determine spatial locations of photographs and integrate them with digital twin representations without requiring manual positioning or extensive metadata.

At 1102, the digital twin system may receive a still image or photograph of a physical environment. In some cases, the still image may be captured using various imaging devices such as cameras, mobile devices, or specialized photography equipment within the physical space. The still image may include visual content showing specific areas, objects, architectural features, or conditions within the physical environment that are intended to be spatially registered within a corresponding digital twin representation. In some implementations, the still image may be received without accompanying location metadata, camera pose information, or other spatial reference data that would typically facilitate direct positioning within the digital twin.

In the current example, a still image or photograph is discussed. However, it should be understood that the digital twin system may also receive video data of the physical environment, where the video may be spatially registered or embedded within the three-dimensional digital twin using similar techniques as described herein for still images. In some cases, the video data may include motion sequences, temporal documentation, or dynamic visual content that may be processed frame-by-frame or as continuous spatial media to provide enhanced documentation and visualization capabilities within the digital twin representation.

At 1104, the digital twin system may determine a visual location of the content of the still image or photograph within a digital twin of the physical environment based at least in part on one or more visual recognition algorithms. In some aspects, the visual place recognition algorithms may analyze visual features, spatial patterns, structural elements, and distinctive characteristics within the still image to identify corresponding locations within the digital twin representation. The system may utilize computer vision techniques, feature matching algorithms, and pattern recognition methods to compare visual elements in the photograph with geometric and textural information contained within the digital twin. In some cases, the visual place recognition process may involve analyzing architectural details, furniture arrangements, lighting conditions, surface textures, and other visual cues to establish spatial correspondence between the photograph and the three-dimensional model. In some implementations, the system may generate confidence scores or probability measures that indicate the likelihood of correct spatial matching between the photograph and potential locations within the digital twin.

At 1106, the digital twin system may refine an alignment of the visual location of the still image or photograph and the digital twin based at least in part on position and orientation data of a capture device and stored location and orientation data of the digital twin. In some implementations, this refinement process may involve utilizing additional spatial information such as camera pose data, inertial measurement unit readings, GPS coordinates, compass bearings, or other positioning data associated with the capture device to improve the accuracy of the spatial registration. The system may combine the initial visual place recognition results with the available positioning data to resolve ambiguities, correct potential misalignments, or enhance the precision of the spatial correspondence. In some cases, the stored location and orientation data of the digital twin may include coordinate systems, spatial reference frames, transformation matrices, and geometric relationships that facilitate precise alignment between the captured image and the digital representation. In some aspects, the refinement process may involve iterative optimization algorithms that adjust the spatial positioning to minimize discrepancies between the visual content and the corresponding digital twin elements.

At 1108, the digital twin system may embed the still image or photograph within the digital twin based at least in part on the refined alignment. In some aspects, this embedding process may create spatial associations that link the visual content to specific locations within the three-dimensional model, allowing users to access the photograph from a corresponding position in the digital twin. The system may generate interactive elements, overlay annotations, or viewpoint markers that enable users to navigate between the photograph and the digital twin representation. In some cases, the embedded still image may be displayed with spatial context information, viewing direction indicators, or camera position markers that help users understand the perspective and location from which the photograph was captured. In some implementations, the system may provide multiple viewing modes where users can toggle between the photograph and the corresponding digital twin view, or display both representations simultaneously to facilitate comparison and spatial understanding of the physical environment.

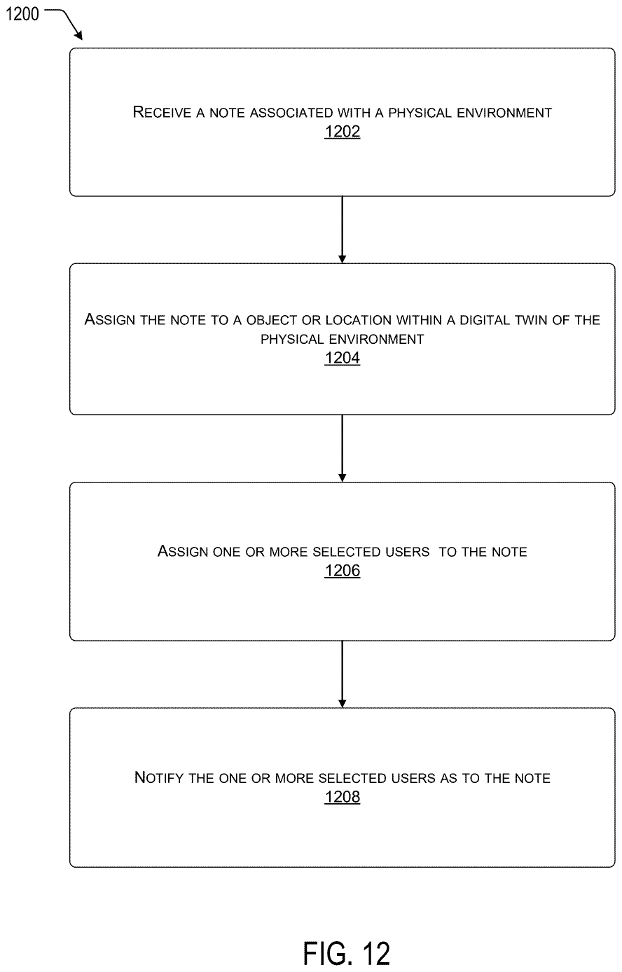

FIG. 12 illustrates a flow diagram of a process 1200 for facilitating collaboration through notes associated with a digital twin of a physical environment, according to some implementations. The process 1200 may be performed by the digital twin system to enable enhanced collaboration capabilities that allow multiple users to communicate, share information, and coordinate activities within digital twin representations through various types of annotations and interactive elements.

At 1202, the digital twin system may receive a note associated with a physical environment. In some cases, the note may include various types of content such as text, HTML, images, files, documents, PDFs, photographs, sensor data, measurements, URLs, drawings, or other information relevant to the physical space or specific elements within the environment. The note may be created by users to document observations, provide instructions, share insights, or facilitate communication regarding particular aspects of the physical environment. In some implementations, the note may be generated through API connections to smart devices, sensors, or other connected systems that provide real-time data about environmental conditions, equipment status, or operational parameters within the physical space.

At 1204, the digital twin system may assign the note to an object or location within a digital twin of the physical environment. In some aspects, the assignment process may involve linking the note to specific spatial elements such as 2D points, 3D points, objects, surfaces, rooms, floors, or connected parts of the space. For example, a note may be attached to a kitchen cabinet, a bedroom, the east side of a wall, or a particular highlighted area within the digital twin representation. In some cases, the system may enable users to select specific objects or draw bounding boxes around sections of the digital twin to define the spatial scope of the note assignment. In some implementations, the assignment may include coordinate information, object identifiers, or spatial references that maintain the association between the note and its corresponding location within the digital twin.

At 1206, the digital twin system may assign one or more selected users to the note. In some cases, the user assignment process may involve tagging specific individuals using their usernames, names, email addresses, or other identification methods to indicate who should be involved in the collaborative discussion or task associated with the note. The system may support role-based assignments where different users may have varying levels of access or responsibility regarding the note content and associated communication threads. In some implementations, the assignment may include permission settings that determine which users may view, edit, or respond to the note, enabling controlled collaboration based on project requirements or organizational hierarchies.

At 1208, the digital twin system may notify the one or more selected users regarding the note. In some aspects, the notification process may utilize various communication channels such as email, push notifications, text messages, phone calls, or in-application alerts to inform assigned users about the note creation, updates, or required actions. The system may provide customizable notification preferences that allow users to specify their preferred communication methods and frequency settings. In some cases, the notifications may include contextual information about the note content, spatial location within the digital twin, and any associated deadlines or priority levels that help users understand the importance and urgency of the collaborative task.

In some implementations, the digital twin system may facilitate ongoing collaboration through communication threads associated with each note, enabling multiple users to engage in chat conversations, share emojis, provide feedback, or coordinate activities related to specific spatial elements within the digital twin. In some cases, the system may support automatic data fetching through API connections to smart devices, sensors, or IoT systems that provide real-time information such as temperature readings, Wi-Fi signal strength, moisture levels, or air quality measurements that may be displayed within the note context. In some aspects, the collaborative notes may trigger automated actions or responses based on predefined conditions, such as adjusting thermostat settings when temperature thresholds are exceeded or generating maintenance alerts when sensor readings indicate potential issues. In some examples, the digital twin system may enable users to clip specific sections of the digital twin and share those clipped portions with other users through new files or URLs, facilitating focused collaboration on particular areas of interest within the physical environment.

In some implementations, the notes described in the process 1200 may be spatially located within the digital twin using similar techniques as those described for image data, videos, and still images in the processes 900-1100 of FIGS. 9-11. For example, the digital twin system may utilize visual place recognition algorithms, position and orientation data, and spatial alignment techniques to determine the precise location where a note should be positioned within the digital twin representation. In some aspects, when a user creates a note while viewing a specific area of the digital twin or captures a note using a mobile device within the physical environment, the system may analyze the visual context, camera pose information, or user interaction data to automatically assign the note to the appropriate spatial location. In some examples, the system may employ similar refinement processes that combine visual recognition results with positioning data to ensure accurate spatial registration of notes, enabling users to access contextual annotations that are precisely aligned with their corresponding physical locations within the digital twin environment.

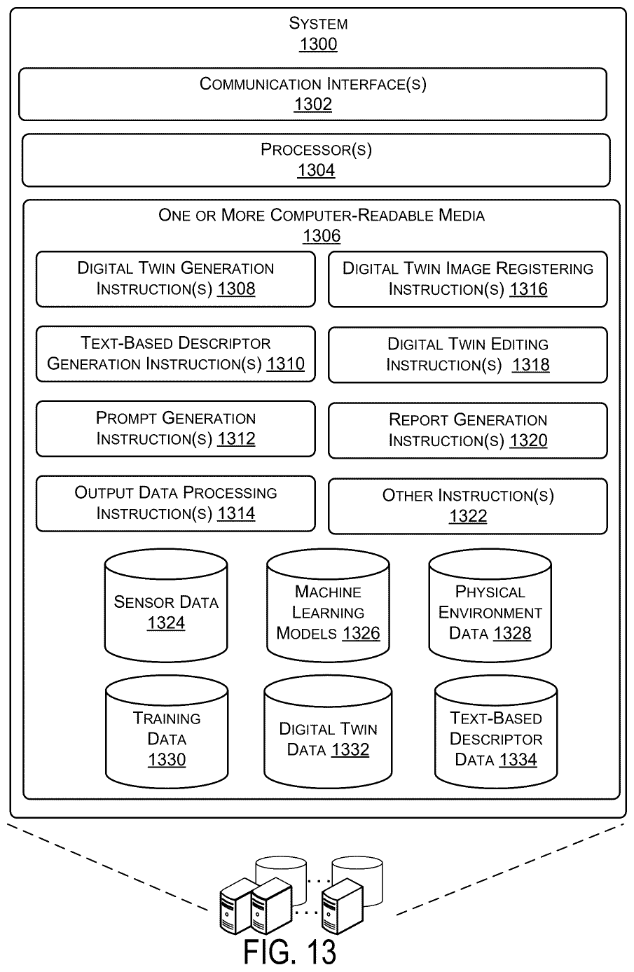

FIG. 13 illustrates a block diagram of a system 1300 for facilitating user interactions with a digital twin of a physical environment according to some implementations. For example, the system 1300 may include one or more communication interface(s) 1302 that enable communication between the system 1300 and one or more other local or remote computing device(s) or remote services, such as one or more scanning devices, display systems, machine learning model services, and/or digital twin visualization platforms. For instance, the communication interface(s) 1302 may facilitate communication with imaging systems, sensor networks, cloud-based services, or other digital twin processing systems. The communication interface(s) 1302 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The system 1300 may include one or more processor(s) 1304 and one or more computer-readable media 1306. Each of the processors 1304 may itself comprise one or more processors or processing cores. The computer-readable media 1306 is illustrated as including memory/storage. The computer-readable media 1306 may include volatile media (such as random access memory (RAM)) and/or nonvolatile media (such as read only memory (ROM), Flash memory, optical disks, magnetic disks, and so forth). The computer-readable media 1306 may include fixed media (e.g., GPU, NPU, RAM, ROM, a fixed hard drive, and so on) as well as removable media (e.g., Flash memory, a removable hard drive, an optical disc, and so forth). The computer-readable media 1306 may be configured in a variety of other ways as further described below.

Several modules such as instructions, data stores, and so forth may be stored within the computer-readable media 1306 and configured to execute on the processors 1304. For example, as illustrated, the computer-readable media 1306 stores digital twin generation instructions 1308, text-based descriptor generation instructions 1310, prompt generation instructions 1312, output data processing instructions 1314, digital twin image registration instructions 1316, digital twin editing instructions 1318, as well as report generation instructions 1320, and other instructions 1322. The computer-readable media 1306 may also be configured to store data, such as sensor data 1324, one or more machine learning models 1326, physical environment data 1328, training data 1330, digital twin data 1332, and text-based descriptor data 1334.

The digital twin generation instructions 1308 may be configured to process sensor data captured by scanning devices to generate three-dimensional digital representations of physical environments. The digital twin generation instructions 1308 may utilize various processing techniques including point cloud processing, mesh generation, three-dimensional reconstruction methods, SfM techniques, SLAM techniques, and surface reconstruction to convert raw sensor data into structured digital twin representations.

The text-based descriptor generation instructions 1310 may be configured to create structured textual descriptions of physical environments and objects within those environments based at least in part on the generated digital twins. For example, the text-based descriptor generation instructions 1310 may utilize one or more machine learning models 1326 to analyze geometric data and generate text-based descriptors that capture architectural features, object properties, spatial relationships, and dimensional characteristics.

The prompt generation instructions 1312 may be configured to format user queries and digital twin information for processing by machine learning models such as large language models and artificial intelligence agents. The prompt generation instructions 1312 may combine text-based descriptors with user requests to create optimized input data for machine learning model processing.

The output data processing instructions 1314 may be configured to analyze and integrate results generated by machine learning models in response to user queries and digital twin analysis requests. The output data processing instructions 1314 may parse machine learning model outputs to extract modifications, generate reports, or update digital twin representations based on the processed information.

The digital twin image registration instructions 1316 may be configured to spatially register photographs and videos within digital twin representations using visual place recognition algorithms and spatial alignment techniques. The digital twin image registration instructions 1316 may determine capture locations and embed visual content at precise spatial coordinates within the three-dimensional models.

The digital twin editing instructions 1318 may be configured to modify digital twin representations based on user requests or machine learning model outputs. The digital twin editing instructions 1318 may translate textual modifications into corresponding geometric changes within the visual models and maintain synchronization between text-based descriptors and three-dimensional representations.

The report generation instructions 1320 may be configured to create documentation, cost estimates, floor plans, and analytical reports based on digital twin analysis. The report generation instructions 1320 may generate various output formats including PDF documents, spreadsheets, and interactive visualizations that provide detailed information about physical environments.

In some particular examples, the system 1300 may be configured to generate both three-dimensional model representations and corresponding text-based descriptors of physical environments, where the text-based descriptors may facilitate efficient processing by machine learning models while the three-dimensional models may provide visual representations for user interaction. In this example, the system 1300 may allow users to submit natural language queries about the physical environment and receive responses that may include visual modifications, detailed reports, or analytical insights generated through machine learning model processing. In this manner, users may interact with digital twins using text-based interfaces that leverage the processing capabilities of large language models and artificial intelligence agents without requiring direct image processing. In some cases, the digital twin representations may be augmented with spatially registered photographs and videos that provide additional visual documentation and context for specific locations within the physical environment.

### Example Use Cases

In some implementations, the digital twin system may facilitate robotics, autonomous systems (e.g., equipment, vehicles, and/or the like) and voice assistant integration to enhance spatial awareness and operational efficiency within physical environments. In some cases, the robotics, autonomous systems, and/or voice assistants may lack understanding of their surrounding spaces, which may limit their ability to perform tasks efficiently or provide contextually relevant interactions with users. In some aspects, the digital twin system may provide detailed virtual representations of physical spaces that enable the robotics, autonomous systems, and/or voice assistants to understand layout configurations, dimensional relationships, and object positioning within residential, industrial, or commercial settings.

As a specific example, the system may enable robotic vacuum systems to utilize digital twin data for enhanced navigation capabilities, allowing these devices to optimize cleaning paths while avoiding obstacles and furniture arrangements identified within the text-based descriptors. In some cases, industrial robotics may leverage digital twin information for inventory management operations, manufacturing processes, or automated material handling tasks by accessing spatial data about warehouse layouts, equipment positioning, and workflow patterns. In some aspects, voice assistants may utilize digital twin data to provide more contextually aware responses to user queries, such as offering precise directions to specific items within rooms or activating particular devices based on their known locations within the physical environment.

In some implementations, the digital twin system may support training operations for robotic and/or autonomous systems as well as artificial intelligence agents by providing spatial data that may be incorporated into machine learning datasets. In some cases, the text-based descriptors generated by the system may serve as training data for robotic systems and/or the AI agents to train the systems and agents to understand spatial relationships, object classifications, and environmental configurations that enhance their autonomous operation capabilities. In some aspects, this approach may enable robotic systems and/or the AI agents to develop improved spatial reasoning and task execution strategies based on detailed knowledge of their operating environments.

In some examples, the system may extend these capabilities to commercial and public spaces, where maintenance robots in airports, shopping centers, or office buildings may utilize digital twin data to perform autonomous cleaning, inspection, or delivery tasks. In some cases, voice assistants integrated with digital twin systems may provide navigation assistance to visitors in large facilities, offering turn-by-turn directions to specific destinations based on substantially real-time spatial understanding of the environment. In some implementations, the system may enable dynamic updates to robotic behavior and voice assistant responses as physical environments change over time, ensuring continued accuracy and effectiveness of automated systems operating within these spaces.

In some implementations, the digital twin system may facilitate e-commerce integration to enhance personalized product recommendations and spatial compatibility assessments for customers. In some cases, e-commerce platforms may struggle to offer personalized product suggestions based on the customer's physical space, which may lead to potential fit or design mismatches when customers purchase furniture, electronics, appliances, or other physical products. In some aspects, the digital twin system may provide detailed spatial understanding that enables e-commerce platforms to assess whether a product will fit appropriately within the customer's existing space and complement their current furnishings and layout.

In some examples, the system may integrate digital twin representations with e-commerce platforms to evaluate product compatibility with customer spaces. In some cases, customers may visualize how products will appear in their home using augmented reality, extended reality, or virtual reality technologies, or may receive automated alerts regarding size constraints or potential conflicts with existing objects identified within their digital twin. In some implementations, the system may analyze dimensional data, spatial relationships, and object positioning within the customer's digital twin to determine optimal product placement and compatibility before purchase decisions are made.

In some aspects, the digital twin system may support AI-driven recommendation engines that work with product catalogs and consider the customer's digital twin for personalized suggestions. In some cases, customers may provide budget constraints to the AI system, allowing the AI agents to suggest entire room setups complete with decor and furnishings based on the customer's financial parameters and spatial requirements. In some implementations, the recommendation engine may analyze the text-based descriptors of the customer's space together with product specifications to generate design solutions that optimize both aesthetic appeal and functional utility within the available budget.

In some examples, the system may suggest optimal placements for products, such as based at least in part on space efficiency or enhance aesthetic appeal. For example, the system may utilize spatial analysis of the customer's digital twin. In some cases, the system may recommend which existing items could be replaced, relocated, or repurposed to accommodate new purchases while maintaining optimal traffic flow and spatial functionality. In some implementations, the digital twin system may provide comparative visualizations showing the customer's space before and after proposed changes, enabling informed decision-making regarding product purchases and spatial modifications.

In some implementations, the digital twin system may facilitate the representation of digital twins as transferable digital assets through non-fungible token (NFT) technology to enable standardized ownership transfer and create unified digital identities for physical spaces. In some cases, there may be no standardized way to transfer ownership or control of a digital twin of a space, which may limit its utility in transactions and digital property rights management. In some aspects, the digital twin system may address this limitation by representing digital twins as NFTs, enabling ownership transfer and creating value as a unified identifier for internet of things (IoT) communication and security protocols.

In some examples, the system may introduce a standardized digital identity for physical spaces that facilitates interoperability between IoT devices and ensures secure, verifiable ownership transfer. In some cases, the NFT-based digital twin may serve as a digital representation that includes spatial data, object inventories, system configurations, and operational parameters that may be transferred along with physical property ownership. In some implementations, the digital twin NFT may contain encrypted access credentials, device authentication keys, and configuration data that enable seamless integration with smart building systems and IoT networks.

In some aspects, the digital twin system may support real estate transactions where the digital twin is transferred to a new owner as part of the property purchase process. In some cases, when a property changes hands, the associated digital twin NFT may be transferred to the new owner, providing immediate access to detailed spatial information, system documentation, and operational data about the physical space. In some implementations, this approach may eliminate the need for new owners to conduct separate scanning operations or recreate digital documentation, as the digital twin representation may be included as part of the property transfer.

In some examples, the system may enable smart home ecosystems where devices are pre-configured based on the NFT-based digital twin's properties and specifications. In some cases, IoT devices and smart home systems may configure themselves based on the spatial data, room layouts, and environmental characteristics contained within the digital twin NFT. In some aspects, this automated configuration capability may reduce setup time and ensure optimal device placement and operation based on the specific characteristics of the physical environment.

In some implementations, the digital twin NFT concept may be applied to commercial buildings, vehicles, or industrial equipment, enabling seamless transfer of digital ownership and operational data across various asset types. In some cases, commercial property transactions may include the transfer of digital twin NFTs that contain building management system configurations, maintenance records, energy usage patterns, and spatial optimization data. In some aspects, vehicle digital twins represented as NFTs may include maintenance histories, performance data, and customization settings that may be transferred to new owners along with the physical vehicle.

In some examples, the system may support industrial equipment digital twins as NFTs that contain operational parameters, maintenance schedules, performance metrics, and configuration data that may be transferred when equipment ownership changes. In some cases, this approach may enable more efficient asset management and reduce the time required for new operators to understand and optimize equipment performance. In some implementations, the digital twin NFT may serve as a digital passport for physical assets, providing verifiable ownership history and operational data that enhances asset value and facilitates more informed purchasing decisions.

In some implementations, the digital twin system may facilitate predictive maintenance capabilities through AI-driven analysis of digital twins (e.g., such as the use of the text-based descriptors) of building systems and infrastructure components to reduce operational costs and prevent unexpected failures. In some cases, traditional building maintenance approaches may be reactive in nature, leading to costly downtime, emergency repairs, and premature equipment replacement when systems fail unexpectedly. In some aspects, the digital twin system may address these challenges by continuously monitoring the health of building systems such as HVAC, plumbing, electrical, and other infrastructure components through integrated sensor networks and machine learning analysis.

In some examples, the system may utilize AI-driven analysis of digital twins (including the text-based descriptors) to predict potential failures and recommend maintenance actions before issues occur, thereby reducing operational costs and extending equipment lifespan. In some cases, the digital twin system may integrate substantially real-time sensor data with the text-based descriptors and 3D model representations to provide substantially continuous feedback and anomaly detection capabilities. In some implementations, the machine learning models (e.g., AI agents) may analyze patterns in temperature fluctuations, vibration levels, energy consumption, fluid flow rates, and other operational parameters to identify deviations from normal operating conditions that may indicate impending equipment failures.

In some aspects, the digital twin system may create a scoring system for maintenance priority based on potential impact and cost considerations. In some cases, the system may evaluate factors such as equipment criticality, replacement costs, downtime implications, and safety risks to generate prioritized maintenance recommendations. In some implementations, the AI agents may analyze the text-based descriptors associated with digital twins of building systems together with historical maintenance data and real-time sensor readings to determine optimal maintenance schedules and resource allocation strategies.

In some examples, the system may be applicable across various facility types including residential, commercial, and industrial settings, as well as in complex systems such as oil rigs, ships, and transportation infrastructure. In some cases, residential applications may include monitoring of home HVAC systems, water heaters, and electrical panels to prevent costly repairs and improve energy efficiency. In some aspects, commercial and industrial facilities may benefit from predictive maintenance of manufacturing equipment, building automation systems, and specialized machinery that may be represented within the digital twin environment.

In some implementations, the digital twin system may extend predictive maintenance capabilities to maritime vessels, offshore platforms, and transportation networks where equipment failures may have significant safety and operational consequences. In some cases, the system may monitor engine performance, structural integrity, and environmental systems aboard ships or oil rigs, providing early warning of potential issues that require maintenance attention. In some aspects, transportation infrastructure applications may include monitoring of bridges, tunnels, and rail systems where the digital twin representation may facilitate predictive analysis of structural components and mechanical systems to ensure continued safe operation.

In some implementations, the digital twin system may facilitate emergency response simulation and planning capabilities through AI-driven analysis of spatial configurations of digital twins and dynamic scenario modeling to enhance preparedness and response effectiveness. In some cases, traditional emergency response planning may rely on static documentation and generic protocols that may not account for the unique spatial characteristics, layout complexities, or dynamic changes within specific buildings or environments. In some aspects, the digital twin system may address these limitations by providing detailed spatial understanding that enables emergency responders to simulate various crisis scenarios and develop optimized response strategies based on the actual physical characteristics of the environment.

In some examples, the system may utilize digital twin representations to simulate emergency scenarios such as fires, earthquakes, natural disasters, security intrusions, or other crisis situations within specific physical spaces. In some cases, the AI-driven simulations may analyze evacuation routes, identify potential bottlenecks or hazards, and optimize safety protocols based on the spatial layout, occupancy patterns, and structural characteristics identified within the text-based descriptors and 3D model representations. In some implementations, the machine learning models may process the digital twin data to evaluate multiple evacuation scenarios, considering factors such as crowd dynamics, accessibility requirements, and emergency equipment placement to determine the most effective response strategies.

In some aspects, the digital twin system may support training operations for emergency responders by providing realistic simulation environments based on actual building layouts and spatial configurations. In some cases, fire departments may utilize digital twin representations of schools, hospitals, office buildings, or residential complexes to conduct training exercises that simulate different fire outbreak scenarios, smoke propagation patterns, and rescue operations. In some implementations, the system may enable responders to practice navigation through complex building layouts, identify optimal entry points, and develop familiarity with structural elements and potential hazards before encountering real emergency situations.

In some examples, law enforcement agencies may leverage digital twin simulations to plan tactical interventions in complex buildings or facilities. In some cases, police departments may utilize the spatial data and text-based descriptors to analyze building access points, room configurations, sight lines, and potential cover positions when developing response strategies for security incidents or hostage situations. In some aspects, the digital twin system may enable tactical teams to rehearse entry procedures, coordinate movement patterns, and identify optimal positioning based at least in part on the specific architectural features and spatial relationships within the target environment.

In some implementations, the digital twin system may extend emergency response capabilities to large-scale urban simulations that enable city management and emergency services to prepare for disasters such as floods, earthquakes, terrorist attacks, or other wide-area emergencies. In some cases, the system may integrate multiple building digital twins with infrastructure data, transportation networks, and population distribution information to create urban models that support disaster preparedness planning. In some aspects, city planners and emergency management officials may utilize these large-scale simulations to evaluate evacuation routes, resource allocation strategies, and coordination protocols across multiple facilities and geographic areas.

In some examples, the system may support flood simulation and response planning by analyzing digital twins of buildings and infrastructure in conjunction with topographical data and weather patterns. In some cases, emergency managers may utilize the simulations to identify vulnerable areas, plan evacuation procedures, and optimize the placement of emergency resources such as shelters, medical facilities, and rescue equipment. In some implementations, the digital twin system may enable substantially real-time updates to emergency plans as conditions change, allowing responders to adapt their strategies based on evolving circumstances and updated spatial information.

In some aspects, the digital twin system may facilitate multi-agency coordination and communication during emergency response operations. In some cases, the shared digital twin representations may provide a common spatial reference that enables different emergency services to coordinate their activities, share situational awareness, and optimize resource deployment. In some implementations, the system may support substantially real-time collaboration between fire departments, police, medical services, and other emergency responders by providing synchronized access to spatial data, evacuation routes, and operational status information within the digital twin environment.

In some implementations, the digital twin system may facilitate sustainability and environmental impact analysis capabilities through AI-powered analysis of building performance data and environmental metrics to support data-driven decision-making for property owners and facility managers. In some cases, property owners may lack insight into the environmental impact of their buildings and potential sustainability improvements, which may limit their ability to implement effective energy conservation measures or meet environmental compliance requirements. In some aspects, the digital twin system may address these challenges by providing detailed analysis of waste production, energy usage patterns, carbon footprint calculations, and environmental performance metrics through integrated sensor networks and machine learning analysis.

In some examples, the system may utilize AI-powered by text-based descriptors, registered or embedded images, and/or the like associated with digital twins to analyze energy consumption patterns, waste generation rates, water usage, and carbon emissions across various building systems and operational processes. In some cases, the digital twin system may integrate substantially real-time sensor data with the text-based descriptors and 3D model representations to provide environmental monitoring and analysis capabilities. In some implementations, the machine learning models may analyze patterns in energy usage, HVAC performance, lighting systems, and occupancy data to identify opportunities for reducing environmental impact and improving sustainability performance.

In some aspects, the digital twin system may provide actionable insights for reducing energy consumption and improving sustainability based at least in part on substantially real-time data analysis and predictive simulations. In some cases, the system may evaluate factors such as building envelope performance, equipment efficiency, operational schedules, and occupant behavior patterns to generate targeted recommendations for sustainability improvements. In some implementations, the AI agents may analyze the text-based descriptors associated with digital twins of building systems together with environmental performance data and regulatory requirements to determine optimal sustainability strategies and resource allocation approaches.

In some examples, the digital twin system may forecast the environmental impact of renovations or new construction projects before they are executed, allowing property owners to make informed decisions based on predictive environmental analysis. In some cases, the system may simulate various design alternatives, material selections, and construction approaches to evaluate their potential environmental consequences and sustainability benefits. In some aspects, the digital twin representations may enable comparative analysis of different renovation scenarios, providing property owners with detailed projections of energy savings, carbon footprint reductions, and long-term environmental benefits associated with various improvement options.

In some implementations, the system may be applicable across various facility types including residential, commercial, industrial, and municipal buildings, providing scalable environmental analysis capabilities that may be adapted to different building types and operational requirements. In some cases, residential applications may include monitoring of home energy systems, water usage patterns, and waste generation to identify opportunities for improving household sustainability and reducing environmental impact. In some aspects, commercial and industrial facilities may benefit from environmental analysis of manufacturing processes, building automation systems, and operational workflows that may be represented within the digital twin environment.

In some examples, the digital twin system may evaluate city-wide sustainability initiatives and track compliance with environmental regulations through integrated analysis of multiple building digital twins and municipal infrastructure data. In some cases, municipal governments may utilize the system to monitor environmental performance across public buildings, assess the effectiveness of sustainability programs, and identify areas where additional environmental improvements may be needed. In some implementations, the system may support regulatory compliance monitoring by tracking environmental metrics, generating compliance reports, and providing early warning of potential violations or performance issues.

In some aspects, the digital twin system may facilitate carbon footprint tracking and reporting capabilities that enable property owners and facility managers to monitor their environmental impact over time and demonstrate progress toward sustainability goals. In some cases, the system may generate detailed environmental reports that include energy consumption analysis, waste reduction metrics, water usage optimization, and carbon emission calculations formatted for regulatory reporting or sustainability certification programs. In some implementations, the digital twin representations may support lifecycle environmental analysis that evaluates the long-term environmental impact of building materials, systems, and operational practices to inform sustainable decision-making processes.

In some implementations, the digital twin system may facilitate financial performance analysis capabilities through AI-driven evaluation of building investments, upgrades, and market positioning to support strategic decision-making for property owners and real estate professionals such as based on digital twins of various investments. In some cases, property owners may lack insight into the financial implications of potential improvements, renovations, or operational changes, which may limit their ability to make informed investment decisions or optimize property value. In some aspects, the digital twin system may address these challenges by providing detailed financial analysis that combines spatial data, market trends, and predictive modeling to evaluate the economic impact of various property enhancement strategies.

In some examples, the system may utilize AI-powered analysis of text-based descriptors, spatial configurations, and market data associated with digital twins to assess return on investment for potential upgrades, renovations, or system improvements. In some cases, the digital twin system may integrate property valuation models, energy cost projections, and market trend analysis with the spatial characteristics and current condition data contained within the digital twin representation. In some implementations, the machine learning models may analyze factors such as building efficiency, spatial utilization, location characteristics, and comparable property data to generate financial projections for proposed improvements.

In some aspects, the digital twin system may provide detailed return on investment analysis for specific upgrade scenarios, enabling property owners to evaluate the financial viability of various improvement options. In some cases, the system may assess factors such as installation costs, ongoing maintenance expenses, energy savings, tax incentives, and property value appreciation to generate financial projections. In some implementations, the AI agents may analyze the text-based descriptors associated with digital twins of building systems together with market data and financial modeling to determine optimal investment strategies and prioritize improvement projects based on expected returns.

In some examples, a building owner may utilize the digital twin system to evaluate the financial impact of installing solar panels, with the AI providing detailed analysis that includes energy production estimates, utility cost savings, available tax credits, and projected property value increases. In some cases, the system may simulate various solar panel configurations based on the building's spatial characteristics, roof orientation, and shading patterns identified within the digital twin to optimize both energy production and financial returns. In some aspects, the financial analysis may include payback period calculations, net present value assessments, and long-term return projections that enable informed decision-making regarding the solar installation investment.

In some implementations, the digital twin system may extend financial analysis capabilities to property portfolio management, enabling real estate investors and property management companies to optimize their investment strategies across multiple properties. In some cases, the system may analyze market positioning, rental income potential, and operational efficiency metrics for individual properties within a portfolio to identify opportunities for value enhancement or strategic repositioning. In some aspects, the AI-driven analysis may consider factors such as location demographics, market trends, competitive properties, and spatial utilization patterns to recommend optimal leasing strategies, pricing adjustments, or property improvements.

In some examples, the system may support commercial real estate investment analysis by evaluating tenant attraction potential, space utilization efficiency, and market competitiveness based on the spatial characteristics and amenities identified within the digital twin representation. In some cases, commercial property owners may utilize the financial analysis to assess the impact of office layout modifications, common area improvements, or technology upgrades on tenant retention, rental rates, and overall property value. In some implementations, the system may generate detailed financial projections that include renovation costs, expected rental income increases, and market positioning improvements to support investment decision-making.

In some aspects, the digital twin system may facilitate residential property investment analysis by evaluating renovation potential, market appeal, and neighborhood positioning to optimize property value and marketability. In some cases, residential property investors may utilize the system to assess the financial impact of kitchen remodels, bathroom upgrades, or space reconfiguration projects based on local market preferences and comparable property data. In some implementations, the AI analysis may consider factors such as neighborhood trends, buyer demographics, and property characteristics to recommend improvements that maximize return on investment and reduce time on market.

In some examples, the digital twin system may extend financial analysis capabilities to public infrastructure projects, enabling government agencies and municipal planners to evaluate the economic impact of infrastructure improvements and public facility upgrades. In some cases, the system may analyze factors such as construction costs, operational savings, public benefit metrics, and long-term maintenance requirements to support budget allocation and project prioritization decisions. In some aspects, the financial analysis may include economic impact assessments, cost-benefit evaluations, and funding strategy recommendations that enable informed decision-making regarding public infrastructure investments.

In some implementations, the system may support property disposition strategies by analyzing market conditions, property characteristics, and financial performance metrics to recommend optimal timing and positioning for property sales. In some cases, property owners may utilize the digital twin system to evaluate whether to hold, improve, or sell properties based on market trends, property condition, and investment objectives. In some aspects, the AI-driven analysis may consider factors such as market cycles, comparable sales data, and property improvement potential to generate strategic recommendations that maximize financial returns and align with investment goals.

In some implementations, the digital twin system may facilitate gaming and entertainment applications through AI-driven adaptation of real-world environments for interactive digital experiences to support game development and content creation workflows. In some cases, game developers and content creators may face significant challenges in creating virtual environments from scratch, which may be time-consuming and costly while requiring extensive artistic and technical resources. In some aspects, the digital twin system may address these challenges by providing detailed spatial representations of real-world environments that may be adapted and optimized for various gaming applications, virtual reality experiences, and interactive entertainment platforms.

In some examples, the system may utilize digital twin representations to create highly realistic game levels and environments based on actual physical spaces. In some cases, real-world locations such as buildings, outdoor areas, historical sites, or architectural landmarks may be scanned and converted into digital twin representations that serve as foundation assets for game development. In some implementations, the machine learning models may analyze the text-based descriptors, registered images, and spatial configurations within digital twins to generate game-appropriate modifications, including lighting adjustments, texture enhancements, and interactive element placement that optimize the environments for specific game genres such as first-person shooters, adventure games, or puzzle-solving experiences.

In some aspects, the digital twin system may enable adaptive environment generation that tailors real-world spaces to different gaming requirements and player experiences. In some cases, the system may process the spatial data and architectural features identified within digital twins to generate multiple variations of the same environment, each optimized for different gameplay mechanics, difficulty levels, or narrative contexts. In some implementations, the AI agents may analyze the text-based descriptors associated with digital twins together with game design parameters and player behavior data to determine optimal environmental modifications, object placement strategies, and interactive element positioning that enhance gameplay engagement, enjoyment, and overall user experience.

In some examples, the digital twin system may support user-generated content capabilities that allow players and community members to contribute their own digital twins to game environments or virtual experiences. In some cases, users may scan their homes, workplaces, or local environments to create digital twin representations that may be integrated into multiplayer games, virtual escape rooms, or collaborative virtual spaces. In some aspects, the system may provide content moderation and quality assurance capabilities that evaluate user-submitted digital twins for appropriateness, technical compatibility, and gameplay suitability before integration into shared gaming environments.

In some implementations, the system may facilitate the creation of virtual escape rooms and puzzle environments based on real-world spatial configurations and architectural features. In some cases, the digital twin representations may provide authentic spatial relationships, room layouts, and environmental details that enhance the realism and immersion of virtual puzzle-solving experiences. In some aspects, the AI-driven analysis may identify locations for interactive elements, hidden objects, and puzzle mechanisms based on the spatial characteristics and accessibility patterns identified within the digital twin data.

In some examples, the digital twin system may extend gaming applications to educational simulations and training environments that leverage real-world spatial accuracy for enhanced learning experiences. In some cases, educational institutions may utilize digital twins of historical sites, scientific facilities, or cultural landmarks to create immersive learning environments that enable students to explore and interact with authentic spatial representations. In some implementations, the system may support virtual field trips, historical recreations, and scientific simulations that combine accurate spatial data with educational content and interactive learning elements.

In some aspects, the digital twin system may facilitate virtual reality experiences that provide users with immersive exploration of real-world environments from remote locations. In some cases, the system may enable virtual tourism applications where users may experience digital twin representations of museums, historical sites, natural landmarks, or architectural marvels through VR headsets and immersive display technologies. In some implementations, the spatial accuracy and detailed environmental information contained within digital twins may enhance the authenticity and educational value of virtual exploration experiences.

In some examples, the system may support multiplayer gaming environments where players may interact within shared digital twin representations of real-world spaces. In some cases, the digital twin data may provide consistent spatial references and environmental details that enable coordinated gameplay, collaborative problem-solving, and social interaction within virtual representations of familiar or exotic locations. In some aspects, the system may facilitate cross-platform compatibility and synchronized environmental updates that ensure consistent user experiences across different gaming devices and virtual reality platforms.

In some implementations, the digital twin system may enable content creators and game developers to rapidly prototype and iterate on environmental designs using real-world spatial data as foundation assets. In some cases, the system may provide automated asset generation capabilities that convert digital twin elements into game-ready models, textures, and interactive objects that may be directly integrated into game development workflows. In some aspects, the AI-powered analysis may identify reusable environmental components, architectural patterns, and spatial configurations that may be adapted across multiple gaming projects, reducing development time and resource requirements while maintaining high levels of environmental authenticity and visual quality.

In some implementations, the digital twin system may facilitate AI-driven product placement and purchase suggestions to enhance retail experiences and streamline product discovery workflows for customers and retailers. In some cases, manual product placement and comparison processes may be labor-intensive for both customers and retailers, requiring significant time and effort to evaluate product compatibility, spatial fit, and aesthetic coordination within existing environments. In some aspects, the digital twin system may address these challenges by providing automated product recognition, spatial analysis, and intelligent recommendation capabilities that leverage the detailed spatial understanding contained within digital twin representations.

In some examples, the system may implement “Scan-to-Buy” functionality where users may scan existing products within their physical space and receive shopping links for identical, related, complimentary, replacement, or similar products through integrated e-commerce platforms. In some cases, the digital twin system may utilize computer vision algorithms and product recognition models to identify furniture, appliances, decorative items, or other objects within the user's environment, subsequently generating direct purchase links or alternative product suggestions based on the identified items. In some implementations, the AI agents may analyze the text-based descriptors and spatial configurations within digital twins to determine product specifications, dimensional requirements, and style characteristics that inform targeted product recommendations.

In some aspects, the digital twin system may provide intelligent alternative product recommendations based on size constraints, price preferences, style compatibility, or functional requirements identified through spatial analysis of the user's environment. In some cases, users may scan their existing furniture or fixtures and receive suggestions for replacement products that offer similar dimensions but updated styles, improved functionality, or enhanced aesthetic appeal. In some implementations, the system may consider factors such as available space, traffic flow patterns, existing color schemes, and architectural features when generating product recommendations that optimize both spatial utilization and design coherence.

In some examples, users may scan their existing sofa and receive suggestions for replacement furniture that maintains similar dimensions while offering newer styles, updated materials, or improved comfort features that align with current design trends and personal preferences. In some cases, the digital twin system may analyze the spatial context surrounding the existing furniture, including room dimensions, adjacent objects, and accessibility requirements, to ensure that recommended replacement products will fit appropriately within the available space. In some aspects, the AI-driven analysis may consider factors such as seating capacity, storage requirements, and usage patterns to recommend products that enhance both functionality and aesthetic appeal.

In some implementations, the digital twin system may enable retailers to create virtual stores or showrooms where customers may visualize how various products would appear within their actual home environments before making purchase decisions. In some cases, retail partners may integrate their product catalogs with the digital twin platform, allowing customers to browse and virtually place merchandise within their personal spaces to evaluate fit, style compatibility, and overall visual impact. In some aspects, the system may provide augmented reality capabilities that overlay product representations onto the user's digital twin, enabling realistic visualization of how different furniture arrangements, color schemes, or decorative elements would transform their living spaces.

In some examples, the digital twin system may support comparative product analysis where customers may evaluate multiple product options simultaneously within their virtual environment to determine optimal selections based on spatial requirements, aesthetic preferences, and functional needs. In some cases, the system may generate side-by-side visualizations that show how different product choices would appear within the same space, enabling informed decision-making regarding style coordination, size appropriateness, and overall design impact. In some implementations, the AI analysis may provide quantitative metrics such as space utilization efficiency, traffic flow optimization, and visual balance assessments that support objective product selection criteria.

In some aspects, the digital twin system may facilitate inventory management and product recommendation optimization for retailers by analyzing customer preferences, spatial constraints, and purchase patterns across multiple digital twin environments. In some cases, retail partners may utilize aggregated spatial data and product placement analytics to identify trending design preferences, optimal product configurations, and emerging market opportunities that inform inventory planning and product development strategies. In some implementations, the system may provide retailers with insights regarding which products perform well in specific spatial contexts, room types, or demographic segments, enabling targeted marketing campaigns and personalized product recommendations.

In some implementations, the digital twin system may facilitate privacy protection capabilities through AI-driven detection and obfuscation of sensitive content within digital twin representations to safeguard personal information and maintain user confidentiality. In some cases, digital twins may unintentionally capture and expose sensitive information such as family photos, personal belongings, private documents, or other confidential materials that users may not wish to share with others. In some aspects, the digital twin system may address these privacy concerns by providing automated content detection, selective obfuscation, and customizable privacy controls that enable users to protect sensitive information while maintaining the utility and accuracy of their digital twin representations.

In some examples, the system may utilize AI-powered computer vision algorithms to detect and identify sensitive content within digital twin environments, including people, pets, faces, personal photographs, documents, computer screens, or other potentially private materials. In some cases, the digital twin system may analyze the text-based descriptors, registered images, and spatial configurations within digital twins to identify objects or areas that may contain sensitive information requiring protection. In some implementations, the machine learning models may be trained to recognize various categories of sensitive content, including biometric identifiers, personal artifacts, confidential documents, or proprietary information that may be present within residential, commercial, or industrial environments.

In some aspects, the digital twin system may provide automated obfuscation capabilities that blur, pixelate, or otherwise obscure sensitive content while preserving the spatial accuracy and functional utility of the digital twin representation. In some cases, the system may apply selective privacy filters that maintain the geometric properties and dimensional characteristics of protected objects while rendering their visual details unrecognizable or indistinguishable. In some implementations, the AI agents may analyze the spatial context and functional importance of detected sensitive content to determine optimal obfuscation strategies that balance privacy protection with digital twin usability and accuracy.

In some examples, homeowners may enable customizable privacy layers that allow them to specify which types of content should be protected and the level of obfuscation to be applied before sharing their digital twin with contractors, real estate agents, or other third parties. In some cases, the digital twin system may provide granular privacy controls that enable users to selectively protect specific rooms, objects, or areas within their digital twin while leaving other portions unmodified for sharing purposes. In some aspects, the system may support multiple privacy profiles or sharing configurations that allow users to create different versions of their digital twin with varying levels of content protection based on the intended audience or use case.

In some implementations, the digital twin system may extend privacy protection capabilities to enterprise and commercial environments where sensitive business information, proprietary documents, or confidential materials may be present within office spaces, manufacturing facilities, or other professional settings. In some cases, the system may detect and obscure computer screens displaying sensitive information, confidential documents on desks or walls, proprietary equipment specifications, or other business-critical materials that should not be visible in shared digital twin representations. In some aspects, enterprise users may configure privacy policies that protect specific categories of sensitive content based on organizational security requirements, regulatory compliance needs, or intellectual property protection strategies.

In some examples, the digital twin system may support dynamic privacy controls that allow users to adjust protection levels or modify obfuscation settings after the initial digital twin generation process. In some cases, users may review their digital twin representation and manually identify additional sensitive content that requires protection, or may choose to remove privacy filters from certain objects or areas that were previously obscured. In some implementations, the system may provide preview capabilities that enable users to visualize how their digital twin will appear to different audiences with various privacy settings applied, ensuring that sensitive information is adequately protected while maintaining the necessary level of detail for intended use cases.

In some aspects, the digital twin system may facilitate compliance with privacy regulations and data protection requirements by providing automated documentation of privacy measures applied to digital twin representations. In some cases, the system may generate privacy reports that detail which types of sensitive content were detected, what obfuscation methods were applied, and how personal information was protected throughout the digital twin generation and sharing process. In some implementations, the privacy protection capabilities may support regulatory compliance requirements such as General Data Protection Regulation (GDPR), California Consumer Privacy Act (CCPA), or other data protection frameworks that govern the collection, processing, and sharing of personal information in digital formats.

In some examples, the system may provide selective sharing capabilities that enable users to grant different levels of access to various parties based on their specific needs and authorization levels. In some cases, family members may have access to unfiltered digital twin representations, while service providers, contractors, or real estate professionals may only receive versions with appropriate privacy protections applied. In some aspects, the digital twin system may support time-limited access controls that expire sharing permissions or revert privacy settings after specified periods, ensuring that sensitive information remains protected even if sharing arrangements change over time.

In some implementations, the digital twin system may enable collaborative privacy management where multiple stakeholders may contribute to privacy decisions and content protection strategies. In some cases, family members, business partners, or organizational administrators may collectively define privacy policies, approve sharing configurations, or modify protection settings based on consensus or established authorization hierarchies. In some aspects, the system may provide audit trails and change tracking capabilities that document privacy-related modifications, enabling accountability and transparency in sensitive content management processes.

In some implementations, the digital twin system may facilitate renovation history and property record management through, for instance, time-stamped documentation capabilities that create detailed historical archives of property modifications and improvements. In some cases, property owners may struggle to maintain accurate records of renovations, repairs, and modifications over time, which may limit their ability to demonstrate property value, verify compliance with building codes, or provide documentation to potential buyers or regulatory authorities. In some aspects, the digital twin system may address these challenges by providing automated documentation capabilities that capture and preserve detailed records of property changes, creating a historical timeline that may be accessed and verified by various stakeholders.

In some examples, the system may utilize digital twin representations to create time-stamped records of renovations, repairs, and other property modifications by generating new layers of historical data with each update to the digital twin. In some cases, the digital twin system may capture before-and-after comparisons of renovation projects, documenting changes to room layouts, fixture installations, material upgrades, or structural modifications through detailed visual and textual records. In some implementations, the machine learning models may analyze the text-based descriptors and spatial configurations within digital twins to identify and document changes between different versions of the same property, creating renovation histories that include dimensional modifications, material specifications, and compliance documentation.

In some aspects, the digital twin system may enable homeowners to showcase renovations to potential buyers through verified documentation that demonstrates the quality, scope, and compliance status of property improvements. In some cases, the system may integrate with contractor certification systems, building permit databases, and inspection records to provide authenticated documentation of renovation work that has been completed according to professional standards and regulatory requirements. In some implementations, the digital twin representations may include embedded documentation such as permits, inspection reports, warranty information, and contractor certifications that provide potential buyers with information about the property's renovation history and current condition.

In some examples, municipalities may utilize digital twin property records to verify compliance with building codes and regulations through automated analysis of property modifications and improvements. In some cases, building departments may access digital twin representations to evaluate whether renovations have been completed according to approved plans, building codes, and zoning requirements. In some aspects, the system may provide regulatory authorities with tools to compare proposed renovation plans with completed work, identify potential code violations, and streamline inspection processes through detailed visual documentation and dimensional verification capabilities.

In some implementations, the digital twin system may support property valuation and insurance assessment processes by providing detailed documentation of property improvements, maintenance history, and current condition status. In some cases, real estate appraisers may utilize digital twin records to evaluate the impact of renovations on property value, assess the quality of improvements, and verify the accuracy of property descriptions. In some aspects, insurance companies may access renovation history data to evaluate risk factors, determine coverage requirements, and assess claims related to property damage or improvement disputes.

In some examples, the system may facilitate warranty and maintenance tracking capabilities that enable property owners to monitor the lifecycle of various building systems, fixtures, and improvements over time. In some cases, the digital twin representations may include maintenance schedules, warranty expiration dates, and service history records that help property owners optimize maintenance activities and ensure continued compliance with manufacturer requirements. In some implementations, the system may provide automated reminders for scheduled maintenance, warranty renewals, or inspection requirements based on the documented renovation history and equipment specifications contained within the digital twin records.

In some implementations, the digital twin system may facilitate urban and city management capabilities through large-scale digital twin models that enable city planners and managers to maintain up-to-date views of urban environments and infrastructure systems. In some cases, city managers may struggle to coordinate planning activities, monitor infrastructure health, and optimize resource allocation across complex urban environments that include multiple building types, transportation networks, and public facilities. In some aspects, the digital twin system may address these challenges by providing integrated urban models that combine individual building digital twins with infrastructure data, transportation networks, and environmental monitoring systems to create city-scale representations.

In some examples, the system may utilize large-scale urban models created from aggregated digital twins to monitor city health, manage infrastructure maintenance, and plan new development projects through spatial analysis and predictive modeling capabilities. In some cases, the digital twin system may integrate with IoT devices, sensor networks, and monitoring systems to track real-time data such as traffic patterns, air quality measurements, energy consumption, water usage, and environmental conditions across urban areas. In some implementations, the machine learning models may analyze the combined data from multiple digital twins and IoT systems to identify trends, predict infrastructure needs, and optimize city services based on actual usage patterns and environmental conditions.

In some aspects, the digital twin system may enable city planners to evaluate the impact of proposed developments, infrastructure improvements, or policy changes through simulation capabilities that model various scenarios and their potential effects on urban systems. In some cases, the system may analyze factors such as traffic flow, population density, environmental impact, and resource utilization to assess the feasibility and consequences of proposed urban planning initiatives. In some implementations, the digital twin representations may support zoning decisions, permit approvals, and development planning by providing detailed spatial analysis and impact assessment capabilities that inform evidence-based decision-making processes.

In some examples, urban digital twin models may be utilized to train autonomous vehicle systems by providing detailed spatial representations of city streets, traffic patterns, and infrastructure elements that enable machine learning algorithms to understand complex urban environments. In some cases, the digital twin data may include information about road configurations, traffic signal locations, pedestrian crossings, and parking areas that may be used to develop and test autonomous vehicle navigation systems. In some aspects, the system may provide simulation environments where autonomous vehicle algorithms may be trained and validated using accurate representations of real-world urban conditions before deployment in actual city environments.

In some implementations, the digital twin system may support public transportation optimization through analysis of ridership patterns, route efficiency, and infrastructure utilization across urban transit networks. In some cases, transportation authorities may utilize digital twin models to evaluate bus routes, subway systems, and other public transit options to identify opportunities for service improvements, capacity optimization, and cost reduction. In some aspects, the system may analyze passenger flow data, travel time patterns, and accessibility requirements to recommend route modifications, schedule adjustments, or infrastructure improvements that enhance public transportation effectiveness and user satisfaction.

In some examples, the digital twin system may facilitate large-scale disaster preparedness and emergency response planning through urban simulations that model various crisis scenarios and their potential impact on city infrastructure and populations. In some cases, emergency management agencies may utilize urban digital twin models to simulate natural disasters, security incidents, or infrastructure failures to develop optimized response strategies and resource allocation plans. In some implementations, the system may analyze evacuation routes, emergency service locations, and population distribution patterns to identify vulnerabilities, optimize emergency response procedures, and coordinate multi-agency disaster response activities across urban areas.

In some aspects, the digital twin system may enable smart city initiatives through integration of urban models with automated systems, sensor networks, and data analytics platforms that optimize city services and resource utilization. In some cases, the system may support applications such as intelligent traffic management, energy grid optimization, waste collection routing, and environmental monitoring through real-time analysis of urban conditions and automated response capabilities. In some implementations, the digital twin representations may facilitate citizen engagement and transparency by providing public access to city planning information, infrastructure status, and service performance metrics through interactive visualization platforms and mobile applications.

In some implementations, the digital twin system may facilitate digital twin lifecycle applications that serve as a unified information repository throughout a property's entire existence, addressing the challenge that many stakeholders interact with a property over its lifetime without access to consolidated historical and current information. In some cases, property stakeholders may include planners, contractors, real estate professionals, appraisers, insurance providers, maintenance personnel, and property managers who may lack access to property documentation that spans multiple phases of the property's lifecycle. In some aspects, the digital twin system may address these information gaps by providing a single source of truth that accompanies the property throughout its entire lifecycle, ensuring continuity and reducing errors or knowledge gaps that may occur during transitions between different stakeholders and property phases.

In some examples, the system may utilize digital twin representations to document and track property information across multiple lifecycle phases including planning, permitting, construction, estimation, sales, quoting, marketing, appraisal, financing and mortgage processes, insurance underwriting and adjustment, remodeling and renovation activities, restoration projects, maintenance operations, cleaning services, handyman activities, property management, and moving processes. In some cases, each phase of the property's existence may be recorded with time-stamped documentation, stakeholder annotations, and relevant documentation that may be accessed by authorized parties throughout the property's lifecycle. In some implementations, the machine learning models may analyze the accumulated lifecycle data to identify patterns, predict maintenance needs, and provide insights that inform decision-making across various property management activities.

In some aspects, the digital twin system may enable property owners and stakeholders to access historical representations of spaces, allowing users to visit or showcase previous states of the property for nostalgic, educational, or analytical purposes. In some cases, users may be able to view their childhood spaces, compare different renovation phases, or analyze how property modifications have evolved over time through interactive visualization capabilities. In some implementations, the system may provide temporal navigation features that enable users to move between different time periods in the property's history, viewing changes in layout, furnishings, and structural elements that have occurred over months, years, or decades.

In some examples, the digital twin lifecycle system may facilitate service estimation and bidding processes by providing contractors, service providers, and maintenance professionals with property information that enables accurate project scoping and cost estimation. In some cases, contractors may access digital twin representations to evaluate renovation requirements, calculate material quantities, and assess project complexity before submitting bids for construction, remodeling, or maintenance services. In some aspects, the system may enable service providers to generate more accurate estimates by analyzing the detailed spatial information, material specifications, and historical maintenance records contained within the digital twin lifecycle documentation.

In some implementations, the digital twin system may support mortgage and financing processes by providing lenders with property documentation that includes construction history, renovation records, maintenance status, and current condition assessments. In some cases, financial institutions may utilize digital twin data to evaluate property value, assess risk factors, and streamline underwriting processes through access to verified property information and historical documentation. In some aspects, the system may facilitate insurance underwriting and claims adjustment by providing insurers with detailed property representations, maintenance histories, and condition assessments that support accurate risk evaluation and claims processing.

In some examples, the digital twin system may facilitate AR, XR, and VR-based space annotation capabilities for future maps-type products that enable users to create immersive, contextual spatial data for indoor environments through custom user annotations and interactive spatial representations. In some cases, current digital mapping tools may lack the ability to provide detailed contextual information for indoor spaces or support user-generated annotations in fully immersive environments. In some aspects, the digital twin system may address these limitations by developing maps-type products for AR, XR, and VR platforms where users may scan and annotate spaces in three-dimensional representations, creating spatial databases that include user-generated content and contextual information.

In some implementations, the system may enable users to tag objects, add text or voice annotations, and provide reviews directly within spatial representations of physical environments through immersive annotation interfaces. In some cases, annotations may include comments on room utility, object placements, safety warnings, maintenance notes, usage instructions, or other contextual information that enhances the spatial understanding and usability of the environment. In some aspects, the digital twin system may support various annotation types including text labels, voice recordings, visual markers, dimensional callouts, and interactive elements that may be accessed through AR, XR, or VR interfaces.

In some examples, commercial building tenants may utilize the annotation system to document maintenance notes, room instructions, equipment specifications, or operational procedures directly within the spatial representation of their workspace. In some cases, retail environments may benefit from product details, special offers, promotional information, or navigation guidance that may be overlaid on the physical space to provide real-time assistance to shoppers and customers. In some implementations, the system may enable dynamic annotation updates that allow businesses to modify promotional content, pricing information, or product availability in real-time through the spatial annotation interface.

In some aspects, the digital twin system may facilitate spatial collaboration capabilities that enable real-time multi-user collaboration where multiple users may contribute to and interact with annotations simultaneously within shared spatial environments. In some cases, collaborative annotation sessions may allow team members, stakeholders, or community members to collectively document spaces, share insights, and coordinate activities through synchronized spatial interfaces. In some implementations, the system may provide user permission controls, annotation ownership tracking, and collaborative editing capabilities that ensure appropriate access levels while maintaining annotation quality and accuracy.

In some examples, the system may support advanced search and filtering capabilities that allow users to search for specific tags, annotations, or content within three-dimensional environments, or filter views based on relevance, user interest, annotation type, or temporal criteria. In some cases, users may be able to locate specific information within complex spatial environments by searching for keywords, user names, annotation categories, or content types through intelligent search algorithms. In some aspects, the filtering capabilities may enable users to customize their spatial experience by displaying only relevant annotations, hiding certain content types, or focusing on information from specific contributors or time periods.

In some implementations, the digital twin annotation system may support various industry applications including real estate, museums, educational institutions, healthcare facilities, and commercial spaces. In some cases, real estate agents may utilize the annotation tools to highlight property features, document condition issues, provide maintenance recommendations, or create interactive property tours that include detailed information about specific rooms, fixtures, or architectural elements. In some aspects, museums may tag artifacts, exhibits, or architectural features with additional information, historical context, multimedia content, or interactive educational materials that enhance visitor experiences through immersive spatial interfaces.

In some examples, educational institutions may utilize spatial annotations to create interactive learning environments where students may access course materials, historical information, or instructional content directly within physical spaces through AR or VR interfaces. In some cases, healthcare facilities may benefit from spatial annotations that provide equipment information, safety protocols, patient care instructions, or facility navigation assistance that may be accessed by staff members or visitors through immersive spatial interfaces. In some implementations, the system may enable facility managers to document maintenance schedules, equipment specifications, safety procedures, or operational instructions directly within the spatial representation of their facilities, creating facility management resources that may be accessed through various immersive technologies.

In some implementations, the digital twin system may facilitate comparison of similar homes, layouts, and build years for renovation insights through AI-driven analysis of anonymized property data to provide homeowners with contextual inspiration and data-driven renovation recommendations. In some cases, homeowners may lack context or inspiration for home renovations based on similar properties in their area or built during the same time period, which may limit their ability to make informed decisions about improvement projects or understand current design trends within their local market. In some aspects, the digital twin system may address these challenges by creating a database of anonymized property information that enables comparative analysis while protecting individual privacy and providing valuable insights for renovation planning.

In some examples, the system may utilize digital twin representations to identify and anonymize similar homes based on layout configurations, architectural style, build year, square footage, and other property characteristics. In some cases, the digital twin system may analyze spatial configurations, room arrangements, structural elements, and design features to group properties with similar characteristics while removing identifying information that could compromise homeowner privacy. In some implementations, the machine learning models may process the text-based descriptors and spatial data from multiple digital twins to identify patterns, trends, and commonalities among properties that share similar attributes, enabling the system to generate relevant recommendations and insights for homeowners considering renovation projects.

In some aspects, the digital twin system may provide homeowners with insights regarding popular renovation choices and design trends based on anonymized data from similar homes in their area. In some cases, a homeowner may be able to discover which countertops, kitchen cabinets, flooring materials, or fixture styles are trending among homes built in particular periods of time within their particular neighborhood or demographic area. In some implementations, the system may analyze renovation patterns, material selections, and design preferences across similar properties to identify emerging trends, popular upgrades, and successful improvement strategies that may inform the homeowner's renovation decisions.

In some examples, property managers and real estate investors may utilize the comparative analysis capabilities to identify which building upgrades are trending for similar rental properties or investment properties within their market area. In some cases, the system may analyze renovation data from comparable rental units to determine which improvements provide the best return on investment, attract tenants most effectively, or align with current market preferences. In some aspects, the digital twin system may provide property managers with data-driven insights regarding optimal upgrade strategies, budget allocation priorities, and market positioning approaches based on successful renovation projects in similar properties.

In some implementations, the digital twin system may support neighborhood comparison capabilities that suggest renovation options based on trending improvements in the local area, filtered by factors such as property value, home size, architectural style, and demographic characteristics. In some cases, the system may analyze renovation patterns within specific geographic areas, price ranges, or property types to identify location-specific trends and preferences that may influence renovation decisions. In some aspects, the neighborhood comparison features may enable homeowners to understand how their property compares to similar homes in terms of modernization levels, energy efficiency improvements, and design updates, providing context for renovation planning and investment decisions.

In some examples, the digital twin system may facilitate virtual neighborhood tours that provide users with immersive experiences of anonymized neighboring properties to showcase how similar homes have been upgraded and renovated. In some cases, users may explore virtual representations of comparable properties to view different renovation approaches, design solutions, and improvement strategies that have been implemented in homes with similar layouts or characteristics. In some implementations, the virtual tours may include before-and-after comparisons, cost information, and performance metrics that demonstrate the impact and effectiveness of various renovation projects, enabling homeowners to evaluate different improvement options based on real-world examples from their local area.

In some aspects, the digital twin system may provide benchmarking analytics capabilities that offer anonymized comparative data to show users where their home stands relative to similar properties in terms of design modernization, energy efficiency, and overall condition. In some cases, the benchmarking analytics may include scoring systems, performance metrics, and comparative assessments that help homeowners understand their property's position within the local market and identify areas where improvements may provide the greatest value or impact. In some implementations, the system may generate personalized recommendations based on the benchmarking results, suggesting specific upgrades or modifications that could improve the property's competitiveness, efficiency, or market appeal relative to comparable homes in the area.

In some examples, the digital twin system may support privacy-protected data sharing mechanisms that enable the aggregation of renovation insights while maintaining strict anonymization protocols to protect individual homeowner information. In some cases, the system may utilize advanced data anonymization techniques, geographic generalization, and statistical aggregation methods to ensure that individual properties cannot be identified while still providing valuable comparative insights and trend analysis. In some aspects, the privacy protection capabilities may include user consent management, data retention controls, and selective sharing options that allow homeowners to contribute to the comparative database while maintaining control over their personal information and property details.

In some implementations, the digital twin system may facilitate influencer space publishing and monetization capabilities through interactive digital tours that enable content creators to showcase their spaces while generating revenue through integrated e-commerce functionality. In some cases, influencers and designers may lack streamlined methods to showcase their spaces and styles in interactive ways that lead to direct monetization opportunities. In some aspects, the digital twin system may address these challenges by providing platforms that allow influencers to create and publish interactive tours of their spaces, which may include integrated e-commerce functionality that enables users to click on items within the digital twin to view details and purchase directly, with the influencer earning commissions on sales.

In some examples, the system may enable celebrities to offer virtual tours of their homes with links to purchase the same furniture or decor items featured within their spaces. In some cases, interior designers may showcase portfolios of staged homes with e-commerce links for each item, allowing viewers to purchase featured products directly from the digital twin representation. In some implementations, the machine learning models may analyze the text-based descriptors and spatial configurations within influencer digital twins to identify purchasable items, generate product recommendations, and optimize placement of e-commerce links to maximize engagement and conversion rates.

In some aspects, the digital twin system may support sponsored tours and product placement capabilities that enable influencers to offer sponsored content within their digital twin representations, with analytics to track engagement and sales performance. In some cases, brands may partner with influencers to feature specific products within virtual tours, with the system providing detailed metrics regarding user interactions, click-through rates, and purchase conversions. In some implementations, the system may enable dynamic product placement where sponsored items may be temporarily integrated into existing digital twin spaces, allowing influencers to test different product configurations and optimize placement strategies based on user engagement data.

In some examples, the digital twin system may facilitate interactive design challenges where influencers may host collaborative design activities that allow users to propose their own decor suggestions for the influencer's space. In some cases, users may submit design modifications, furniture arrangements, or styling suggestions that may be visualized within the digital twin representation, with the best designs being featured, rewarded, or implemented by the influencer. In some aspects, the system may provide voting mechanisms, community feedback tools, and design comparison capabilities that enable audiences to participate in collaborative design processes while generating engagement and content for the influencer's platform.

In some implementations, the digital twin system may support subscription or pay-per-view access models that provide influencers with additional revenue streams through premium tour content. In some cases, influencers may offer exclusive access to private spaces, behind-the-scenes content, or detailed design insights through subscription-based digital twin experiences. In some aspects, the system may enable tiered access levels where basic tours are available for free while premium content, interactive features, or personalized design consultations require paid subscriptions or individual purchase transactions.

In some examples, the system may provide analytics and performance tracking capabilities that enable influencers to monitor engagement metrics, conversion rates, and revenue generation across their digital twin content. In some cases, the analytics may include user interaction patterns, popular product categories, geographic distribution of viewers, and seasonal trends that inform content strategy and monetization optimization. In some implementations, the system may generate automated reports that track commission earnings, sponsored content performance, and audience growth metrics to support influencer business development and partnership negotiations.

In some aspects, the digital twin system may facilitate brand partnership integration where companies may collaborate with influencers to create co-branded digital twin experiences that showcase products within authentic living environments. In some cases, furniture manufacturers, home decor brands, or lifestyle companies may sponsor influencer digital twins to demonstrate their products in realistic settings while providing audiences with immersive shopping experiences. In some implementations, the system may enable dynamic inventory integration where product availability, pricing, and promotional offers may be updated in real-time within the digital twin representation, ensuring that e-commerce functionality remains current and accurate.

In some implementations, the digital twin system may facilitate comparison of existing documentation with reality through AI-driven analysis of digital twins (such as via the text-based descriptors) that identifies discrepancies between as-built documentation and current physical spaces to reduce project delays, errors, and cost overruns. In some cases, discrepancies between blueprints, floor plans, or other architectural documentation and the actual physical structure may lead to significant challenges during construction, renovation, or inspection processes. In some aspects, the digital twin system may address these challenges by providing automated comparison capabilities that analyze digital twin representations against existing documentation to identify areas where the physical structure deviates from documented plans, flagging unpermitted work, dimensional discrepancies, or unauthorized modifications.

In some examples, the system may utilize digital twin representations to compare existing architectural documentation against current physical spaces through spatial analysis and dimensional verification. In some cases, the digital twin system may process blueprints, CAD drawings, or building information modeling data together with the text-based descriptors and spatial configurations within digital twins to identify inconsistencies, missing elements, or structural modifications that were not reflected in the original documentation. In some implementations, the machine learning models may analyze the geometric data, dimensional specifications, and spatial relationships within both the digital twin and the documentation to generate detailed comparison reports that highlight specific areas of deviation.

In some aspects, the digital twin system may provide contractors with validation tools that enable them to assess construction progress against approved plans and identify potential compliance issues before they become costly problems. In some cases, construction managers may utilize the comparison capabilities to verify that work is being completed according to specifications, building codes, and permit requirements. In some implementations, the system may generate progress reports that document construction milestones, identify deviations from approved plans, and provide recommendations for corrective actions that ensure project compliance and quality standards.

In some examples, city inspectors may utilize the digital twin comparison system to identify unpermitted renovations during property inspections through automated analysis of structural modifications and building code compliance. In some cases, building departments may access digital twin representations to evaluate whether renovations have been completed according to approved permits and regulatory requirements. In some aspects, the system may provide inspection tools that enable regulatory authorities to compare current property conditions with historical documentation, permitted modifications, and zoning compliance requirements to identify potential violations or safety concerns.

In some implementations, the digital twin system may support 3D-to-2D overlay comparison capabilities that generate three-dimensional overlays on top of two-dimensional plans to visualize differences and identify potential structural issues. In some cases, the system may create interactive visualizations that show how the current physical space relates to the original architectural drawings, highlighting areas where dimensions, layouts, or structural elements differ from the documented specifications. In some aspects, the overlay comparisons may enable users to toggle between different views, examine specific areas of concern, and understand the spatial implications of identified discrepancies.

In some examples, the digital twin system may provide automated reporting and alert capabilities that generate reports for identified discrepancies, with priority alerts for deviations that may impact structural integrity or regulatory compliance. In some cases, the system may analyze the severity and implications of identified differences to prioritize issues based on safety concerns, code violations, or project impact factors. In some implementations, the automated reporting may include detailed documentation of discrepancies, photographic evidence, dimensional measurements, and recommended corrective actions that support decision-making and remediation planning.

In some implementations, the digital twin system may facilitate virtual review of spaces for buyers, renters, and occupants through interactive digital tours that enable property assessment and issue identification before making occupancy decisions. In some cases, buyers and renters may be unable to fully assess a property's suitability or identify potential problems during traditional viewing sessions, which may lead to unexpected issues or dissatisfaction after occupancy. In some aspects, the digital twin system may address these challenges by providing immersive virtual tours that allow potential buyers or renters to interact with and thoroughly review properties, with AI-powered analysis that highlights potential issues, such as structural damage, inefficient layouts, or hazardous elements.

In some examples, the system may enable real estate platforms to integrate property evaluation capabilities that provide potential buyers or renters with detailed insights about property conditions, functionality, and suitability for their specific needs. In some cases, real estate agents may utilize digital twin tours to showcase properties remotely, provide detailed property information, and address buyer concerns through interactive visualization and AI-generated property assessments. In some implementations, the system may enable buyers to conduct thorough property evaluations from remote locations, reducing the need for multiple in-person visits while providing more information than traditional property listings.

In some aspects, the digital twin system may support home inspectors in performing remote inspections that identify potential issues and generate detailed reports for buyers without requiring physical presence at the property. In some cases, professional inspectors may utilize digital twin representations to evaluate structural elements, identify maintenance concerns, and assess property conditions through detailed spatial analysis and AI-powered issue detection. In some implementations, the remote inspection capabilities may enable inspectors to provide preliminary assessments, identify areas requiring in-person evaluation, and generate inspection reports that inform buyer decision-making processes.

In some examples, the digital twin system may provide interactive fit and functionality testing capabilities that allow users to test-fit furniture or equipment within the space and simulate usage scenarios to ensure the property meets their specific requirements. In some cases, potential buyers or renters may utilize the system to virtually place their existing furniture, evaluate room layouts, and assess whether the space will accommodate their lifestyle needs and functional requirements. In some aspects, the system may enable users to experiment with different furniture arrangements, evaluate traffic flow patterns, and determine optimal space utilization before making occupancy commitments.

In some implementations, the digital twin system may support AI-driven issue detection capabilities that identify common property problems such as moisture damage, uneven flooring, structural concerns, or safety hazards, generating visual reports that inform potential buyers about property conditions. In some cases, the machine learning models may analyze the text-based descriptors, spatial configurations, and visual data within digital twins to detect signs of water damage, foundation issues, electrical problems, or other maintenance concerns that may not be immediately apparent during traditional property viewings. In some aspects, the AI-powered analysis may generate property condition reports that include identified issues, severity assessments, estimated repair costs, and recommendations for professional evaluation or remediation.

In some implementations, the digital twin system may facilitate universal representation and format conversion capabilities that enable seamless interoperability between different digital twin formats and applications across various industries. In some cases, digital twins may be created and stored in proprietary formats that limit their compatibility with different software platforms, analysis tools, and industry-specific applications, which may restrict their utility and prevent effective data sharing between stakeholders. In some aspects, the digital twin system may address these interoperability challenges by providing universal format conversion capabilities that enable the same digital twin representation to be utilized across multiple industries, applications, and technical platforms without requiring separate data capture or reconstruction processes.

In some examples, the system may develop a universal digital twin format that supports seamless conversion between various representation types including visual-spatial formats such as point clouds, 3D scans, mesh models, neural radiance fields (NeRFs), and Gaussian Splats, as well as auditory data, textual descriptors, and structured CAD/BIM representations. In some cases, the universal format may serve as a common foundation that preserves the spatial accuracy, semantic information, and geometric relationships contained within the original digital twin while enabling transformation into specialized formats optimized for specific use cases or industry requirements. In some implementations, the machine learning models may analyze the universal digital twin representation to generate format-specific outputs that maintain data integrity and spatial consistency across different representation types.

In some aspects, the digital twin system may enable architects to utilize digital twins created for construction planning and convert them into point cloud formats for structural analysis, mesh representations for visualization purposes, or CAD formats for detailed engineering workflows. In some cases, the same digital twin may be transformed into NeRF representations for photorealistic rendering applications or Gaussian Splat formats for real-time interactive visualization. In some implementations, the system may support conversion to auditory formats that capture acoustic properties of spaces for sound design applications, or textual formats that provide detailed semantic descriptions for natural language processing and AI analysis.

In some examples, e-commerce platforms may utilize the universal format conversion capabilities to extract visual data from architectural digital twins for virtual staging applications, product placement simulations, or immersive shopping experiences. In some cases, retail applications may convert digital twin representations into formats optimized for augmented reality product visualization, virtual showroom experiences, or automated interior design recommendations. In some aspects, the system may enable manufacturing companies to convert facility digital twins into formats suitable for robotics path planning, automated inventory management, or industrial process optimization.

In some implementations, the digital twin system may provide a standardized application programming interface (API) that enables on-demand format conversion capabilities, ensuring compatibility with a wide range of software platforms, analysis tools, and industry-specific applications. In some cases, the API may support batch conversion operations that enable users to transform multiple digital twins simultaneously, or real-time conversion services that generate format-specific representations as needed for specific applications or workflows. In some aspects, the standardized API may include authentication mechanisms, usage tracking capabilities, and quality assurance features that ensure reliable format conversion while maintaining data security and intellectual property protection.

In some examples, the API may enable software developers to integrate digital twin format conversion capabilities directly into their applications, allowing users to access and utilize digital twin data without requiring specialized knowledge of different format specifications or conversion processes. In some cases, cloud-based conversion services may provide scalable processing capabilities that handle complex format transformations, large dataset conversions, or computationally intensive operations such as NeRF generation or Gaussian Splat optimization. In some implementations, the API may support version control and change tracking capabilities that document format conversion history and enable users to revert to previous representations or track modifications across different format types.

In some aspects, the digital twin system may facilitate integration with artificial intelligence tools and large language models through structured universal formats that enable direct input processing and spatial reasoning capabilities. In some cases, the universal format may be designed to provide machine learning models with spatial information, semantic annotations, and contextual relationships that enhance AI analysis and decision-making processes. In some implementations, the system may enable AI models to process digital twin data in multiple formats simultaneously, combining visual-spatial information with textual descriptions and structured metadata to generate more insights and recommendations.

In some examples, the integration capabilities may enable large language models to analyze digital twin representations and generate natural language descriptions, answer spatial queries, or provide design recommendations based on the spatial and semantic information contained within the universal format. In some cases, computer vision models may process visual-spatial representations while natural language processing models simultaneously analyze textual descriptors, enabling multi-modal AI analysis that leverages different aspects of the digital twin data. In some aspects, the system may support AI-driven format optimization that selects the most appropriate representation type for specific analysis tasks or application requirements.

In some implementations, the digital twin system may enable cross-industry collaboration and data sharing through standardized format conversion capabilities that allow stakeholders from different sectors to access and utilize the same digital twin data using their preferred tools and workflows. In some cases, construction companies may share digital twins with facility management teams, who may convert the representations into formats suitable for maintenance planning, energy analysis, or space optimization applications. In some aspects, the universal format approach may facilitate collaboration between architects, engineers, contractors, and facility managers by providing a common data foundation that may be adapted to meet the specific requirements of each discipline while maintaining consistency and accuracy across all applications.

In some implementations, the digital twin system may facilitate AI and LLM integration capabilities through structured spatial data representation that enables advanced spatial reasoning and contextual interactions within real-world environments. In some cases, traditional AI tools and large language models may lack direct integration with spatial data, which may limit their ability to understand or reason about physical environments and provide contextually relevant responses to spatial queries. In some aspects, the digital twin system may address these limitations by representing digital twins in structured formats that may be directly ingested by AI models, enabling enhanced spatial reasoning capabilities and more sophisticated contextual interactions for design, construction, and property management applications.

In some examples, the system may enable AI assistants to utilize digital twin representations to answer complex spatial queries about room dimensions, ceiling heights, floor areas, and volumetric calculations with precise accuracy based on the actual measured characteristics of the physical environment. In some cases, users may ask natural language questions such as “What is the square footage of the master bedroom?” or “How much clearance is there between the kitchen island and the refrigerator?” and receive immediate, accurate responses based on the spatial data contained within the digital twin. In some implementations, the AI models may process the text-based descriptors and geometric information within digital twins to provide detailed measurements, spatial relationships, and dimensional analysis that would typically require manual measurement or calculation.

In some aspects, the digital twin system may support AI-driven interior design recommendations that analyze spatial configurations, traffic flow patterns, and existing architectural elements to suggest optimal furniture arrangements and design solutions. In some cases, AI assistants may utilize digital twin data to recommend specific furniture pieces based on room dimensions, doorway widths, and spatial constraints, ensuring that suggested items will fit appropriately within the available space. In some implementations, the system may enable users to request design suggestions such as “How should I arrange furniture in my living room for better traffic flow?” or “What size dining table would work best in this space?” with the AI providing detailed recommendations based on spatial analysis and design principles.

In some examples, the digital twin system may enable AI models to simulate renovation scenarios and provide analysis of proposed modifications before physical work begins. In some cases, users may describe renovation ideas in natural language, such as “What would it look like if I removed the wall between the kitchen and dining room?” and the AI may analyze the structural implications, spatial changes, and visual impact of the proposed modification. In some aspects, the AI-powered simulation capabilities may include cost estimation, timeline projections, and feasibility assessments that help users make informed decisions about renovation projects based on the specific characteristics of their physical environment.

In some implementations, the digital twin system may support construction planning and project management through AI analysis of spatial requirements, material quantities, and workflow optimization. In some cases, construction professionals may utilize AI assistants that access digital twin data to calculate material requirements, identify potential construction challenges, and optimize work sequences based on the spatial characteristics of the project site. In some aspects, the AI models may analyze digital twin representations to suggest efficient construction approaches, identify areas where specialized equipment may be required, and provide recommendations for staging materials and coordinating trades based on spatial constraints and accessibility considerations.

In some examples, the system may facilitate property management applications where AI assistants utilize digital twin data to optimize maintenance schedules, space utilization, and operational efficiency. In some cases, facility managers may interact with AI systems that understand the spatial layout, equipment locations, and infrastructure characteristics of their buildings to receive recommendations for preventive maintenance, energy optimization, or space reconfiguration. In some implementations, the AI models may analyze occupancy patterns, traffic flow data, and spatial utilization metrics contained within digital twins to suggest improvements to building operations, tenant satisfaction, or resource allocation strategies.

In some aspects, the digital twin system may enable AI-powered real estate analysis that combines spatial data with market information to provide property assessments and investment recommendations. In some cases, real estate professionals may utilize AI assistants that access digital twin representations to evaluate property characteristics, compare spatial features with market preferences, and identify opportunities for value enhancement through strategic modifications. In some implementations, the AI models may analyze room layouts, architectural features, and spatial relationships within digital twins to assess market appeal, rental potential, or resale value based on current market trends and buyer preferences.

In some examples, the system may support educational applications where AI tutors utilize digital twin data to provide immersive learning experiences about architecture, construction, and spatial design principles. In some cases, students may interact with AI systems that can explain architectural concepts, demonstrate construction techniques, or analyze design decisions using actual building examples represented in digital twin format. In some aspects, the AI-powered educational capabilities may include interactive spatial exploration, comparative analysis of different design approaches, and hands-on learning experiences that combine theoretical knowledge with practical spatial understanding.

In some implementations, the digital twin system may facilitate accessibility analysis through AI models that evaluate spatial configurations for compliance with accessibility standards and identify opportunities for inclusive design improvements. In some cases, AI assistants may analyze digital twin data to assess wheelchair accessibility, identify potential barriers, and suggest modifications that enhance usability for individuals with mobility limitations. In some aspects, the AI-powered accessibility analysis may include detailed recommendations for ramp installations, doorway modifications, or bathroom adaptations based on the specific spatial characteristics and constraints identified within the digital twin representation.

In some implementations, the digital twin system may facilitate autogenerated AI descriptions and virtual tours based on digital twin representations to streamline property marketing and documentation processes. In some cases, creating detailed descriptions, marketing content, and virtual tours for properties may be time-consuming and require specialized expertise that may not be readily available to property owners, real estate professionals, or rental operators. In some aspects, the digital twin system may address these challenges by utilizing AI-powered content generation capabilities that analyze digital twin data to produce dynamic descriptions, marketing materials, virtual tours, floor plans, and other promotional content tailored to specific use cases and target audiences.

In some examples, the system may utilize AI models to generate property descriptions that incorporate spatial data, architectural features, and environmental characteristics extracted from digital twin representations. In some cases, real estate agents may utilize the autogenerated content capabilities to create detailed property listings that highlight key features, room dimensions, layout advantages, and unique selling points based on the actual spatial characteristics contained within the digital twin. In some implementations, the AI models may analyze the text-based descriptors, spatial configurations, and visual elements within digital twins to generate compelling marketing copy that accurately represents the property while emphasizing features most likely to appeal to potential buyers or renters.

In some aspects, the digital twin system may support context-specific content generation that tailors descriptions, imagery, and promotional materials based on the intended use case, such as property sales, rental listings, insurance documentation, or appraisal reports. In some cases, the system may adjust the tone, focus, and technical detail level of generated content to match the requirements of different audiences and applications. In some implementations, vacation rental owners may utilize the system to generate virtual tours and property descriptions that emphasize amenities, local attractions, and guest experience features, while insurance companies may receive technical documentation that focuses on structural elements, safety features, and risk assessment factors.

In some examples, the digital twin system may enable AI-assisted content personalization that allows users to modify or refine generated content with AI guidance while retaining core spatial details and accuracy. In some cases, property owners may collaborate with AI assistants to customize marketing descriptions, adjust emphasis on particular features, or incorporate personal touches that reflect their unique selling propositions. In some aspects, the system may provide interactive editing capabilities where users may request specific modifications such as “emphasize the natural lighting in the living room” or “highlight the proximity to local schools” and receive updated content that incorporates these preferences while maintaining factual accuracy based on the digital twin data.

In some implementations, the digital twin system may generate virtual tour experiences that combine spatial navigation with AI-generated narration, annotations, and contextual information. In some cases, the virtual tours may include dynamic content that adapts based on viewer interests, property features, or market positioning strategies. In some aspects, the system may enable real estate professionals to create multiple versions of virtual tours for the same property, each optimized for different buyer demographics, price points, or marketing channels while utilizing the same underlying digital twin representation.

In some examples, the system may support automated floor plan generation and architectural documentation that provides professional-quality drawings, dimensional specifications, and spatial analysis reports based on digital twin data. In some cases, appraisers may utilize the AI-generated documentation to support property valuations, while architects may access detailed spatial information for renovation planning or design consultations. In some implementations, the system may generate multiple document formats including PDF reports, interactive web presentations, and printable marketing materials that may be customized for different professional applications and client requirements.

In some implementations, the digital twin system may facilitate property management interactions through interactive digital twin interfaces that enhance tenant-landlord communication and space management capabilities. In some cases, traditional property management approaches may lack interactive digital tools that enable effective communication between tenants and property managers regarding maintenance issues, space utilization, or improvement requests. In some aspects, the digital twin system may address these communication challenges by providing interactive platforms where tenants may submit maintenance requests, annotate issues directly on digital models, and communicate more effectively with landlords or property management companies through spatially contextualized interactions.

In some examples, the system may enable tenants to utilize digital twin representations to submit maintenance requests by clicking on specific locations within the three-dimensional model and providing detailed descriptions of issues or concerns. In some cases, tenants may annotate problems such as leaky faucets, electrical issues, or cosmetic damage directly on the digital twin, providing property managers with precise location information and visual context that facilitates more efficient problem resolution. In some implementations, the interactive annotation capabilities may include photo uploads, voice recordings, and priority level indicators that help property managers understand the urgency and scope of maintenance requests without requiring initial site visits.

In some aspects, the digital twin system may provide property managers with review capabilities that enable them to assess tenant-submitted annotations, understand exact problem locations, and evaluate potential solutions or renovations virtually before conducting physical site visits. In some cases, property managers may utilize the digital twin interface to prioritize maintenance requests, coordinate with service providers, and track resolution progress through integrated project management tools. In some implementations, the system may enable property managers to provide tenants with status updates, estimated completion timelines, and communication regarding maintenance activities directly through the digital twin interface.

In some examples, the digital twin system may maintain virtual maintenance logs and history that provide documentation of all maintenance actions, requests, and renovations within the digital twin representation. In some cases, the maintenance history may include time-stamped records of completed work, before-and-after documentation, warranty information, and service provider details that enable property managers to track the property's condition over time. In some aspects, the virtual maintenance logs may support predictive maintenance capabilities by analyzing patterns in maintenance requests, identifying recurring issues, and recommending preventive measures based on historical data and spatial analysis.

In some implementations, the system may support tenant collaboration tools that allow multiple tenants to collaborate on the digital twin to suggest room configurations, paint choices, shared amenity improvements, or common area modifications. In some cases, tenants in multi-unit buildings may utilize collaborative features to propose improvements to shared spaces, coordinate decorating decisions, or communicate preferences regarding building amenities and services. In some aspects, the tenant collaboration capabilities may include voting mechanisms, discussion forums, and proposal submission tools that enable democratic decision-making regarding property improvements and community initiatives while providing property managers with consolidated feedback and tenant preferences.

In some examples, the digital twin system may facilitate lease management and property inspection processes through integrated documentation capabilities that track lease terms, tenant responsibilities, and property condition assessments within the spatial context of the digital twin. In some cases, property managers may utilize the system to conduct virtual pre-lease inspections, document existing conditions, and establish baseline property states that may be referenced throughout the tenancy period. In some implementations, the system may support move-in and move-out documentation processes by enabling comparative analysis between different time periods, automated damage assessment, and security deposit determination based on documented changes to the property condition.

In some implementations, the digital twin system may facilitate material and product identification capabilities through AI-powered scanning and recognition technologies that enable homeowners and tenants to identify specific materials, fixtures, and finishes used within their spaces. In some cases, homeowners and tenants may struggle to identify exact paint colors, flooring materials, fixture models, or other products used in their space when repairs, replacements, or upgrades are needed, which may lead to mismatched materials or difficulty sourcing appropriate products. In some aspects, the digital twin system may address these challenges by providing automated scanning features that identify and catalog the models, materials, and paint colors used throughout a space, utilizing visual recognition algorithms, manufacturer metadata, and historical renovation data to provide users with detailed product information and purchasing guidance.

In some examples, the system may utilize computer vision algorithms and material recognition models to analyze digital twin representations and identify specific products, materials, and finishes present within the physical environment. In some cases, homeowners may scan their walls to identify the exact shade of paint for touch-up work, with the system providing detailed color specifications, manufacturer information, and retailer locations where matching paint may be purchased. In some implementations, tenants may scan kitchen fixtures such as sinks or faucets to identify replacement parts for broken components, with the AI models analyzing visual characteristics, dimensional specifications, and manufacturer markings to provide precise product identification and sourcing information.

In some aspects, the digital twin system may integrate with e-commerce platforms and local retailers through product matching algorithms that identify exact matches or visually similar alternatives for identified materials and products. In some cases, the system may provide users with direct purchasing links, price comparisons, and availability information from multiple suppliers to facilitate efficient product sourcing. In some implementations, the product matching capabilities may include compatibility assessments that ensure recommended products will work appropriately with existing installations, taking into account factors such as dimensions, mounting requirements, and technical specifications.

In some examples, the system may provide replacement recommendations that suggest upgraded options for obsolete products or alternatives when original products are no longer available. In some cases, the AI models may analyze the characteristics and functionality of discontinued items to recommend modern equivalents that provide similar or enhanced performance while maintaining compatibility with existing installations. In some aspects, the replacement recommendation system may consider factors such as energy efficiency improvements, updated safety standards, and aesthetic compatibility when suggesting alternative products.

In some implementations, the digital twin system may maintain material and product databases that include manufacturer specifications, installation requirements, maintenance recommendations, and compatibility information for various building materials and fixtures. In some cases, the system may utilize machine learning models trained on extensive product catalogs, manufacturer data, and visual recognition datasets to improve identification accuracy and expand the range of recognizable materials and products. In some aspects, the material identification capabilities may include historical tracking that documents when products were installed, expected lifespan, and recommended replacement schedules based on manufacturer guidelines and usage patterns.

In some implementations, the digital twin system may facilitate virtual check-in and check-out capabilities for rental and vacation properties through automated property condition documentation and damage detection technologies. In some cases, manual check-in and check-out processes for rental properties may be time-consuming, subjective, and prone to disputes regarding property condition and damages, which may create challenges for both property owners and tenants. In some aspects, the digital twin system may address these challenges by providing virtual check-in and check-out systems that utilize digital twin representations to document property states before and after rental periods, with AI-powered comparison algorithms that detect damage, missing items, or unauthorized changes.

In some examples, the system may enable vacation rental hosts to scan their properties before and after each guest's stay, generating reports that identify any changes, damages, or missing items through automated comparison of digital twin representations captured at different time periods. In some cases, the AI algorithms may analyze spatial configurations, object positioning, surface conditions, and inventory status to detect discrepancies between pre-arrival and post-departure property states. In some implementations, the automated damage detection capabilities may include severity assessments, cost estimation for repairs, and photographic documentation that provides objective evidence for property condition evaluations.

In some aspects, the digital twin system may provide dispute resolution interfaces that enable tenants and landlords to address disagreements regarding property condition or damage claims through digital evidence and interactive comparison tools. In some cases, the system may generate side-by-side visualizations that highlight specific areas of concern, provide detailed documentation of identified issues, and enable both parties to review and discuss findings through collaborative digital platforms. In some implementations, the dispute resolution capabilities may include third-party mediation tools, automated damage assessment algorithms, and integration with security deposit management systems that facilitate fair and transparent resolution of property-related disputes.

In some examples, the virtual check-in and check-out system may support multi-property management scenarios where property managers oversee multiple rental units and require efficient documentation and comparison capabilities across their entire portfolio. In some cases, the system may provide centralized dashboards that track property conditions, identify recurring issues, and generate maintenance recommendations based on patterns observed across multiple properties and rental periods. In some aspects, the automated documentation capabilities may include integration with cleaning services, maintenance providers, and insurance companies to streamline property management workflows and ensure consistent quality standards across rental operations.

In some implementations, the system may provide predictive maintenance capabilities that analyze property condition trends over time to identify areas that may require preventive attention or upgrades. In some cases, the AI models may process historical check-in and check-out data to identify patterns in wear and tear, predict when specific components or areas may require maintenance, and recommend proactive measures that reduce the likelihood of damage or guest complaints. In some aspects, the predictive maintenance features may include cost-benefit analysis tools that help property owners optimize their maintenance budgets and prioritize improvements that provide the greatest return on investment in terms of guest satisfaction and property preservation.

In some implementations, the digital twin system may facilitate renovation documentation capabilities through step-by-step scanning and digital twin generation that creates detailed visual records of construction processes and work quality verification. In some cases, property renovations may lack adequate documentation of work performed behind walls, under floors, or in other concealed areas, which may create challenges for future maintenance, repairs, or regulatory compliance verification. In some aspects, the digital twin system may address these documentation gaps by providing systematic scanning capabilities that capture each phase of renovation work, creating time-stamped digital records that document the progression of construction activities and verify compliance with building standards and quality requirements.

In some examples, the system may enable contractors to document renovation steps through sequential digital twin captures that record the installation of infrastructure elements such as plumbing, electrical wiring, HVAC systems, insulation, waterproofing, and structural modifications before these components become concealed by finishing materials. In some cases, a contractor may scan a bathroom renovation to document the proper installation of new plumbing lines, drain connections, and waterproofing membranes before installing drywall and tile finishes. In some implementations, the digital twin system may generate detailed visual records that show exact pipe routing, connection points, shut-off valve locations, and compliance with plumbing codes, providing homeowners and future service providers with precise documentation of concealed infrastructure.

In some aspects, the digital twin system may provide time-stamped documentation capabilities that create chronological records of renovation progress, enabling verification of work sequence, quality control checkpoints, and milestone completion. In some cases, the system may timestamp each scan or digital twin capture, creating an immutable record of when specific work was completed and documented. In some implementations, the time-stamped records may include metadata such as weather conditions, ambient temperature, humidity levels, and other environmental factors that may affect construction quality or material performance, providing context for future reference or warranty claims.

In some examples, the system may facilitate digital certification processes that integrate with local regulatory bodies and building inspection departments to verify compliance with building codes and construction standards. In some cases, building inspectors may utilize the digital twin documentation to conduct remote preliminary reviews, identify areas requiring in-person inspection, and verify that work has been completed according to approved plans and regulatory requirements. In some implementations, the digital certification capabilities may include automated code compliance checking that analyzes the digital twin data against local building codes, identifying potential violations or areas requiring correction before final inspection approval.

In some aspects, the digital twin system may support quality assurance workflows that enable contractors, project managers, and property owners to review work quality and identify potential issues before they become concealed or more expensive to address. In some cases, the system may provide comparative analysis tools that allow users to compare actual installation work against approved plans, manufacturer specifications, or industry best practices. In some implementations, the quality assurance features may include automated detection of common installation errors, such as improper pipe slopes, inadequate electrical clearances, or missing safety components, generating alerts that enable corrective action before work proceeds to the next phase.

In some examples, the digital twin system may maintain renovation histories that document all phases of construction work, creating permanent records that may be accessed by future property owners, service providers, or regulatory authorities. In some cases, the renovation documentation may include detailed specifications of materials used, installation methods employed, warranty information, and contact details for contractors and suppliers involved in the work. In some implementations, the system may generate renovation reports that combine visual documentation with technical specifications, compliance certifications, and maintenance recommendations, providing property owners with complete records of all work performed.

In some implementations, the system may provide version control and change tracking capabilities that enable users to compare different phases of renovation work and understand how the property has evolved over time. In some cases, the version control features may allow users to navigate between different time periods in the renovation process, viewing before-and-after comparisons or tracking the progression of specific work areas. In some aspects, the change tracking capabilities may include automated identification of modifications, additions, or corrections made during the renovation process, documenting decision-making rationale and providing accountability for work quality and compliance.

In some examples, the digital twin system may support warranty and maintenance planning through detailed documentation of installed components, materials, and systems that enables proactive maintenance scheduling and warranty claim processing. In some cases, the system may integrate with manufacturer warranty databases to track warranty periods, maintenance requirements, and recommended service schedules for installed products and systems. In some implementations, the warranty integration capabilities may include automated reminders for scheduled maintenance, warranty expiration notifications, and direct links to manufacturer support resources or authorized service providers.

In some aspects, the digital twin system may facilitate insurance and liability documentation through visual records that demonstrate proper installation practices, code compliance, and quality workmanship. In some cases, insurance companies may utilize the renovation documentation to assess risk factors, verify proper installation of safety systems, and evaluate claims related to construction defects or water damage. In some implementations, the insurance integration capabilities may include automated risk assessment tools that analyze the digital twin data to identify potential liability issues, recommend risk mitigation measures, and provide documentation that supports favorable insurance rates or coverage terms.

In some examples, the system may enable collaborative review processes that allow multiple stakeholders including contractors, architects, engineers, and property owners to review and approve work progress through shared access to the digital twin documentation. In some cases, the collaborative features may include annotation tools that enable reviewers to add comments, identify concerns, or approve specific work phases directly within the digital twin interface. In some implementations, the collaborative review capabilities may include approval workflows that require sign-off from designated parties before work can proceed to subsequent phases, ensuring quality control and stakeholder alignment throughout the renovation process.

In some implementations, the digital twin system may support regulatory compliance integration that submits required documentation to local building departments, utility companies, or other regulatory authorities as work progresses. In some cases, the system may generate standardized compliance reports that include required technical specifications, safety certifications, and inspection documentation in formats specified by local regulatory requirements. In some aspects, the regulatory integration capabilities may include automated permit tracking that monitors permit status, inspection schedules, and approval requirements, ensuring that renovation work remains compliant with all applicable regulations and avoiding costly delays or rework due to compliance issues.

In some implementations, the digital twin system may facilitate virtual inspection capabilities through human or AI-powered review of digital twin scans that enable property assessment without requiring physical site visits. In some cases, traditional physical inspections may be time-consuming, costly, and logistically challenging, particularly when multiple stakeholders need to coordinate schedules or when properties are located in remote or difficult-to-access areas. In some aspects, the digital twin system may address these challenges by providing virtual inspection platforms that allow human inspectors or AI models to conduct thorough property evaluations using detailed digital twin representations, reducing travel time, inspection costs, and scheduling constraints while maintaining assessment capabilities.

In some examples, the system may enable home inspectors to conduct virtual inspections for pre-sale or rental properties through detailed analysis of digital twin scans that identify structural damage, water leaks, pest infestations, or other property issues without requiring on-site visits. In some cases, inspectors may utilize the digital twin interface to navigate through properties, examine specific areas of concern, and document findings through integrated annotation and reporting tools. In some implementations, the virtual inspection capabilities may include high-resolution visual analysis, dimensional measurements, and comparative assessments that provide inspectors with detailed information about property conditions and potential maintenance requirements.

In some aspects, the digital twin system may provide AI-powered inspection that analyze digital twin data to identify potential problem areas and flag issues for further human review. In some cases, the AI models may be trained to recognize signs of structural damage, moisture intrusion, electrical hazards, HVAC inefficiencies, or other common property issues through analysis of visual patterns, dimensional anomalies, and environmental indicators contained within the digital twin representation. In some implementations, the AI inspection capabilities may include severity assessments, risk evaluations, and prioritized recommendations that help inspectors focus their attention on the most significant issues while ensuring coverage of all property areas.

In some examples, the system may support customizable inspection parameters that enable AI algorithms to be tailored for specific areas of concern or inspection requirements. In some cases, moisture detection algorithms may analyze surface patterns, discoloration, and environmental conditions to identify potential water damage or humidity issues. In some aspects, structural integrity assessments may evaluate dimensional relationships, surface conditions, and architectural elements to identify potential foundation problems, settling issues, or structural defects. In some implementations, electrical safety evaluations may examine outlet locations, panel configurations, and wiring pathways to identify code violations, safety hazards, or upgrade requirements based on current electrical standards.

In some implementations, the digital twin system may facilitate collaborative inspection sessions that enable multiple parties including contractors, property owners, inspectors, and real estate professionals to participate in real-time virtual inspections and collaborate on findings. In some cases, the collaborative features may include shared viewing capabilities, synchronized navigation, and interactive annotation tools that allow participants to discuss specific areas, highlight concerns, and coordinate remediation strategies. In some aspects, the collaborative inspection platform may support voice communication, screen sharing, and document sharing capabilities that enable discussion and decision-making during virtual inspection sessions.

In some examples, the system may provide specialized inspection workflows for different property types and use cases, including residential home inspections, commercial building assessments, rental property evaluations, and insurance claim investigations. In some cases, residential inspections may focus on safety systems, structural elements, and maintenance issues that affect habitability and property value. In some aspects, commercial building assessments may emphasize code compliance, accessibility requirements, and system functionality that impact business operations and regulatory compliance. In some implementations, rental property evaluations may prioritize tenant safety, maintenance requirements, and property condition factors that affect rental income and tenant satisfaction.

In some aspects, the digital twin system may integrate with inspection reporting standards and regulatory requirements to generate inspection reports that meet industry standards and legal requirements. In some cases, the system may populate inspection forms, generate standardized reports, and include required documentation such as photographs, measurements, and compliance certifications. In some implementations, the reporting capabilities may include customizable templates, automated calculations, and integration with inspection databases that streamline the documentation process and ensure consistency across multiple inspections.

In some examples, the virtual inspection system may support follow-up monitoring and re-inspection capabilities that enable tracking of remediation progress and verification of completed repairs. In some cases, property owners may utilize the system to document repair work, compare before-and-after conditions, and verify that identified issues have been properly addressed. In some aspects, the follow-up capabilities may include automated change detection, progress tracking, and compliance verification that ensure remediation work meets inspection requirements and industry standards.

In some implementations, the digital twin system may provide training and certification support for virtual inspection methodologies through educational resources, practice scenarios, and competency assessments. In some cases, inspectors may utilize the system to develop virtual inspection skills, learn new assessment techniques, and maintain professional certifications through continuing education programs. In some aspects, the training capabilities may include simulated inspection scenarios, performance feedback, and knowledge assessments that ensure inspectors maintain proficiency in virtual inspection methodologies and digital twin analysis techniques.

In some implementations, the digital twin system may facilitate punch-list creation for construction projects through AI-powered comparison of current project states against intended designs and specifications to streamline project completion workflows. In some cases, finalizing construction projects may be delayed by the need to manually create and review punch lists of outstanding tasks, which may be time-consuming and prone to human oversight that can result in missed items or incomplete documentation. In some aspects, the digital twin system may address these challenges by providing automated punch list generation capabilities that utilize AI-powered analysis to compare current digital twin scans of construction projects with intended designs, blueprints, or specification documents to identify remaining tasks, incomplete work, and areas requiring correction.

In some examples, the system may utilize machine learning models to analyze digital twin representations of construction sites and automatically generate punch lists by comparing the current state of the project against approved plans, design specifications, and quality standards. In some cases, a general contractor may scan a newly built house and receive an automated list of tasks to complete, such as installing outlet covers, painting or priming areas, completing trim work, or addressing code compliance issues identified through the comparison analysis. In some implementations, the AI-powered punch list generation may include detailed location information, priority assessments, and photographic documentation that enables contractors to efficiently locate and address outstanding items without requiring extensive manual inspection processes.

In some aspects, the digital twin system may provide dynamic punch list updates that automatically refresh as new scans are added to the project documentation. In some cases, as construction work progresses and new digital twin captures are performed, the system may remove completed items from the punch list while adding newly identified findings or issues that require attention. In some implementations, the dynamic updating capabilities may include progress tracking that documents completion rates, identifies recurring issues, and provides project managers with substantially real-time visibility into construction progress and remaining work requirements.

In some examples, the system may support integration with project management tools that enable contractors to assign tasks directly from the automatically generated punch list to specific team members or subcontractors. In some cases, the punch list integration may include task assignment workflows, deadline tracking, and progress monitoring capabilities that streamline project coordination and ensure accountability for completion of outstanding items. In some aspects, the project management integration may include automated notifications, status updates, and completion verification that enable project managers to maintain oversight of punch list progress without requiring manual tracking or coordination activities.

In some implementations, the digital twin system may provide customizable punch list criteria that enable contractors and project managers to define specific quality standards, completion requirements, and inspection parameters based on project specifications and regulatory requirements. In some cases, the system may analyze digital twin data against building codes, safety standards, and quality benchmarks to identify areas where work does not meet specified requirements. In some aspects, the customizable criteria may include material specifications, dimensional tolerances, finish quality standards, and installation requirements that ensure punch list items address both aesthetic and functional completion requirements.

In some examples, the system may facilitate collaborative punch list review processes that enable multiple stakeholders including contractors, architects, inspectors, and property owners to review and approve punch list items through shared digital platforms. In some cases, the collaborative features may include annotation tools that allow reviewers to add comments, modify priorities, or approve completed work directly within the digital twin interface. In some implementations, the collaborative review capabilities may include approval workflows that require sign-off from designated parties before items can be marked as complete, ensuring quality control and stakeholder satisfaction throughout the project completion process.

In some aspects, the digital twin system may support specialized punch list categories that address different aspects of construction completion including safety compliance, code adherence, aesthetic finishing, and functional testing requirements. In some cases, safety compliance punch lists may identify missing safety equipment, incomplete guardrails, or inadequate lighting that must be addressed before occupancy approval. In some implementations, code adherence punch lists may highlight electrical violations, plumbing deficiencies, or structural issues that require correction to meet regulatory requirements, while aesthetic finishing punch lists may focus on paint touch-ups, trim installation, and cosmetic details that affect project appearance and client satisfaction.

In some examples, the system may provide automated documentation and reporting capabilities that generate punch list reports including photographic evidence, location references, and completion tracking for project records and regulatory compliance. In some cases, the automated reporting may include before-and-after comparisons, completion timestamps, and contractor verification that provide documentation of project completion activities. In some aspects, the reporting capabilities may include integration with inspection databases, permit tracking systems, and client communication platforms that streamline project closeout processes and ensure proper documentation of all completion activities.

In some implementations, the digital twin system may facilitate virtual collaboration with retailers and designers through interactive digital twin platforms that enable remote space planning and product selection without requiring multiple in-person visits or consultations. In some cases, traditional retail collaboration processes may be time-consuming and logistically challenging, requiring customers to coordinate schedules with designers, visit physical showrooms, and make multiple trips to finalize design decisions. In some aspects, the digital twin system may address these challenges by providing virtual collaboration capabilities that allow customers to work directly with retailers and designers using their digital twin representations, enabling efficient space planning, furniture placement, and product selection through remote interactive sessions.

In some examples, the system may enable homeowners to share their digital twin representations with retailers or designers to facilitate virtual consultation sessions where space planning and product selection may be conducted collaboratively in substantially real-time. In some cases, a homeowner may meet virtually with a designer from a home goods store, where they may interactively plan furniture placements, evaluate different layout options, and visualize product selections using the digital twin of their home. In some implementations, the virtual collaboration platform may provide synchronized viewing capabilities that allow both the customer and designer to navigate through the digital twin simultaneously, discussing design options and making modifications in substantially real-time while maintaining visual alignment throughout the consultation process.

In some aspects, the digital twin system may provide substantially real-time virtual placement capabilities that enable participants to place and adjust furniture or decor items within the digital twin during collaborative sessions, with changes appearing instantly for all participants to review and evaluate. In some cases, the substantially real-time placement features may include drag-and-drop functionality, rotation controls, and scaling options that allow designers and customers to experiment with different furniture arrangements, test various product configurations, and optimize space utilization based on the specific dimensions and characteristics of the physical environment. In some implementations, the system may provide visual feedback regarding spatial constraints, traffic flow patterns, and aesthetic compatibility to guide placement decisions and ensure that selected arrangements will function effectively in the actual physical space.

In some examples, the digital twin system may integrate shopping functionality that converts selected furniture placements and design elements into shopping lists with direct links to the retailer's inventory and purchasing systems. In some cases, as furniture and decor items are placed within the digital twin during the collaborative session, the system may automatically generate itemized shopping lists that include product specifications, pricing information, availability status, and direct purchase links. In some aspects, the shopping integration may include inventory verification that confirms product availability, delivery timelines, and compatibility with the customer's requirements, enabling immediate purchase decisions and streamlined ordering processes without requiring separate product research or availability checking.

In some implementations, the system may support multi-retailer collaboration sessions where customers may work with representatives from different stores or brands simultaneously to create design solutions that incorporate products from multiple sources. In some cases, the multi-retailer approach may enable customers to compare products, pricing, and availability across different vendors while maintaining a unified design vision within their digital twin representation. In some aspects, the system may provide coordination tools that help manage product compatibility, delivery scheduling, and installation sequencing when items are sourced from multiple retailers, ensuring that the overall design implementation proceeds smoothly and efficiently.

In some examples, the digital twin system may facilitate design iteration and comparison capabilities that enable customers and designers to create multiple design scenarios within the same digital twin, allowing for side-by-side evaluation of different approaches and product selections. In some cases, the design iteration features may include version control that preserves different design concepts, enabling customers to review and compare various options before making final decisions. In some implementations, the system may provide cost comparison tools that analyze the financial implications of different design scenarios, helping customers make informed decisions based on both aesthetic preferences and budget considerations.

In some aspects, the digital twin system may support appointment scheduling and session management capabilities that enable retailers to offer virtual consultation services as part of their customer service offerings. In some cases, retail staff may utilize the system to manage virtual appointment calendars, prepare for customer sessions by reviewing digital twin data in advance, and maintain records of design decisions and product recommendations for follow-up communications. In some implementations, the session management features may include recording capabilities that document design decisions, product selections, and customer preferences for future reference and continued collaboration.

In some examples, the system may provide augmented reality integration that enables customers to view selected products within their actual physical spaces using mobile devices or AR headsets, bridging the gap between virtual collaboration and real-world implementation. In some cases, customers may utilize AR capabilities to verify that virtually selected furniture and decor items will appear as expected in their actual rooms, providing additional confidence in purchase decisions made during virtual collaboration sessions. In some aspects, the AR integration may include measurement verification tools that confirm product dimensions and spatial fit within the physical environment, reducing the likelihood of sizing errors or compatibility issues.

In some implementations, the digital twin system may facilitate post-purchase support through delivery coordination and installation guidance that utilizes the digital twin data to optimize logistics and setup processes. In some cases, delivery teams may access the digital twin representations to understand room layouts, identify optimal delivery routes, and plan furniture placement strategies before arriving at the customer's location. In some aspects, the system may provide installation guidance that references the virtual design decisions made during collaboration sessions, ensuring that the physical implementation matches the planned design and meets customer expectations established during the virtual consultation process.

In some implementations, the digital twin system may facilitate progress tracking for remodeling projects through interval scanning capabilities that enable documentation and analysis of construction progress at each stage of the project lifecycle. In some cases, tracking the progress of remodeling projects may be challenging without systematic documentation that captures the state of work at regular intervals, which may lead to delays, cost overruns, or quality issues that could have been identified and addressed earlier in the construction process. In some aspects, the digital twin system may address these challenges by providing automated interval scanning capabilities that capture digital twin representations at predetermined milestones throughout the remodeling project, enabling project managers and contractors to monitor progress, identify potential delays, and ensure that work is proceeding according to planned timelines and quality standards.

In some examples, the system may enable remodeling firms to conduct interval scanning throughout construction projects to track progress and compare actual work completion against planned timelines and milestones. In some cases, a remodeling firm may scan a kitchen renovation project at different stages of construction including demolition completion, rough plumbing and electrical installation, drywall completion, cabinet installation, and final finishing to ensure that each phase is completed correctly and on schedule. In some implementations, the machine learning models may analyze the digital twin data captured at each interval to identify completed work, assess quality standards, and compare progress against the original project timeline and specifications.

In some aspects, the digital twin system may provide automated progress reporting capabilities that generate reports comparing actual progress against planned timelines, highlighting areas where delays may occur or where work quality may not meet specified standards. In some cases, the automated progress reports may include completion percentages for different project phases, identification of work areas that are ahead of or behind schedule, and recommendations for resource allocation or schedule adjustments to maintain project timelines. In some implementations, the AI-powered analysis may evaluate factors such as work quality, material installation accuracy, and compliance with building codes to provide assessments that support project management decision-making and quality control processes.

In some examples, the system may create visual timelines that overlay scan data from different project intervals, providing stakeholders with clear visual representations of how the remodeling project has evolved over time. In some cases, the visual timelines may include before-and-after comparisons, progress animations, and milestone markers that enable project managers, contractors, and property owners to understand the scope of work completed and identify areas requiring attention. In some aspects, the visual timeline capabilities may include interactive features that allow users to navigate between different time periods, examine specific work areas in detail, and access detailed information about materials, installations, and quality assessments for each project phase.

In some implementations, the digital twin system may support predictive project management capabilities that utilize historical progress data and current work status to forecast project completion timelines and identify potential bottlenecks or resource constraints. In some cases, the AI models may analyze patterns in work completion rates, material delivery schedules, and contractor productivity to generate updated project timelines and recommend proactive measures to maintain schedule adherence. In some aspects, the predictive capabilities may include risk assessment tools that identify factors such as weather delays, material availability issues, or permit approval timelines that may impact project completion and suggest mitigation strategies to minimize schedule disruptions.

In some examples, the interval scanning system may facilitate quality control workflows that enable contractors and inspectors to identify and address construction issues before they become more expensive to correct in later project phases. In some cases, the system may compare work completed at each interval against approved plans, building codes, and quality standards to identify deviations that require correction. In some implementations, the quality control features may include automated detection of common construction errors, dimensional discrepancies, or installation issues that may be flagged for immediate attention and resolution.

In some aspects, the digital twin system may provide stakeholder communication tools that enable project managers to share progress updates, visual documentation, and timeline information with property owners, contractors, and other project participants through interactive digital platforms. In some cases, the communication features may include automated progress notifications, milestone completion alerts, and visual progress reports that keep all stakeholders informed about project status without requiring frequent site visits or manual reporting processes. In some implementations, the system may support collaborative review sessions where stakeholders may examine progress documentation, discuss concerns, and approve work completion before proceeding to subsequent project phases.

In some examples, the system may integrate with project management software and scheduling tools to provide seamless coordination between digital twin progress tracking and existing project management workflows. In some cases, the integration capabilities may include automatic updates to project schedules based on actual progress data, resource allocation recommendations based on work completion rates, and budget tracking that correlates expenses with completed work phases. In some aspects, the integration may enable contractors to maintain project documentation that combines traditional project management data with detailed visual progress records captured through interval scanning processes.

In some implementations, the digital twin system may facilitate automated placement suggestions for home devices through AI-driven spatial analysis that optimizes device positioning based on room dimensions, furniture arrangements, and performance requirements. In some cases, homeowners may struggle to determine optimal placement locations for devices such as Wi-Fi routers, speakers, thermostats, or other connected home equipment without detailed understanding of spatial factors that affect device performance. In some aspects, the digital twin system may address these challenges by providing automated placement recommendation capabilities that analyze the text-based descriptors and spatial configurations within digital twins to identify optimal device locations based on coverage requirements, signal propagation patterns, and environmental factors.

In some examples, the system may utilize digital twin representations to automatically suggest optimal placement locations for home devices by analyzing factors such as room dimensions, existing furniture placement, wall materials, ceiling heights, and connectivity requirements. In some cases, a homeowner may request placement recommendations for a new Wi-Fi router to maximize coverage across multiple floors, with the system analyzing the digital twin data to identify locations that provide optimal signal distribution while minimizing interference from structural elements and furniture. In some implementations, the machine learning models may process the spatial characteristics, material properties, and architectural features contained within the digital twin to generate placement suggestions that optimize device performance based on the specific physical environment.

In some aspects, the digital twin system may provide device placement simulations that enable users to evaluate the effectiveness of different placement options before making final installation decisions. In some cases, the system may simulate Wi-Fi coverage patterns, speaker audio projection areas, or thermostat temperature control zones based on proposed device locations within the digital twin representation. In some implementations, the simulation capabilities may include heat map visualizations that show coverage areas, dead zones, signal strength variations, or performance metrics associated with different placement scenarios, enabling users to compare options and select optimal locations based on their specific requirements.

In some examples, the system may generate interactive heat maps or recommended zones for device placement that provide visual guidance regarding optimal installation locations within the physical environment. In some cases, the heat maps may display color-coded regions that indicate signal strength, coverage quality, or performance effectiveness for different areas within the digital twin. In some aspects, the recommended zones may include priority rankings, installation considerations, and performance predictions that help users understand the benefits and limitations of different placement options.

In some implementations, the digital twin system may support interactive adjustment tools that allow users to virtually move devices within the digital twin and observe the simulated impact on performance metrics in real-time. In some cases, users may drag and drop device representations to different locations within the three-dimensional model and immediately see updated coverage maps, signal strength indicators, or performance projections. In some aspects, the interactive adjustment capabilities may include rotation controls, height adjustments, and orientation settings that enable users to fine-tune device positioning and evaluate how different installation parameters affect overall performance.

In some examples, the system may provide specialized analysis for different device types, including Wi-Fi routers that require optimization for signal propagation and interference minimization, speakers that need positioning for optimal acoustic performance and sound distribution, and thermostats that require placement for accurate temperature sensing and efficient climate control. In some cases, the Wi-Fi analysis may consider factors such as wall materials, floor layouts, interference sources, and multi-floor coverage requirements to recommend router locations that maximize network performance. In some implementations, the speaker placement analysis may evaluate room acoustics, furniture arrangements, and listening positions to suggest locations that provide optimal sound quality and coverage.

In some aspects, the digital twin system may facilitate thermostat placement optimization through analysis of air circulation patterns, heat sources, and temperature distribution characteristics within the physical environment. In some cases, the system may identify locations that provide representative temperature readings while avoiding direct sunlight, drafts, or heat sources that could affect thermostat accuracy. In some implementations, the thermostat analysis may consider HVAC system characteristics, room usage patterns, and climate control objectives to recommend placement locations that optimize energy efficiency and comfort levels.

In some examples, the system may support multi-device coordination analysis that optimizes the placement of multiple connected devices simultaneously to ensure compatibility and performance optimization across the entire home automation system. In some cases, the multi-device analysis may consider factors such as network topology, device interference, power requirements, and user accessibility when generating placement recommendations for multiple devices. In some aspects, the coordination capabilities may include mesh network optimization for Wi-Fi systems, audio zone planning for multi-room speaker installations, or climate control zoning for multiple thermostat deployments.

In some implementations, the digital twin system may provide installation guidance and documentation that assists users with the physical placement and setup of devices based on the virtual placement decisions. In some cases, the installation guidance may include precise location coordinates, mounting instructions, cable routing recommendations, and configuration settings that ensure the physical installation matches the optimized virtual placement. In some aspects, the system may generate installation reports that include placement rationale, expected performance metrics, and troubleshooting guidance that support successful device deployment and operation.

In some examples, the system may facilitate post-installation validation through comparison of actual device performance with predicted performance metrics generated during the virtual placement process. In some cases, users may provide feedback regarding actual coverage areas, signal strength measurements, or performance characteristics that enable the system to refine its placement algorithms and improve future recommendations. In some implementations, the validation capabilities may include performance monitoring tools that track device effectiveness over time and suggest adjustments or relocations when performance degrades or requirements change.

In some aspects, the digital twin system may support seasonal or usage-based placement optimization that accounts for changes in furniture arrangements, occupancy patterns, or environmental conditions that may affect device performance. In some cases, the system may recommend temporary device relocation or configuration adjustments based on seasonal factors such as furniture rearrangements, holiday decorations, or climate variations that impact device effectiveness. In some implementations, the adaptive placement capabilities may include automated monitoring of performance metrics and proactive recommendations for placement adjustments when environmental changes affect device operation.

In some implementations, the digital twin system may facilitate authentication using scan or digital twin footprints through unique spatial signature verification that enables secure digital interactions based on physical space characteristics. In some cases, proving ownership or authorized access based on a physical space's layout may be difficult in digital applications, which may lead to security risks such as rental scams, unauthorized property transactions, or fraudulent listings. In some aspects, the digital twin system may address these security challenges by utilizing the unique features of a space (e.g., a digital space “thumbprint”) as an authentication mechanism for digital interactions, where access or transactions may only be initiated from particular rooms or locations based on verified spatial characteristics from a scanning session or captured image data registration with known digital twins.

In some examples, the system may utilize digital twin representations to create unique spatial signatures that serve as authentication credentials for property-related transactions and digital interactions. In some cases, a landlord may authenticate rental transactions by requiring a scan footprint of the room where the agreement is being made, preventing unauthorized sublets or fraudulent listings by verifying that the person initiating the transaction has physical access to the actual property. In some implementations, the machine learning models may analyze the text-based descriptors, spatial configurations, and architectural features contained within the digital twin to generate unique spatial fingerprints that may be used to verify legitimate access to specific physical locations.

In some aspects, the digital twin system may provide geofencing authentication capabilities that implement location-based access controls to allow certain actions only when users are within specific locations within the home or property. In some cases, the geofencing features may enable IoT device control, smart home interactions, or property management functions only when the user is physically present within designated areas of the property. In some implementations, the system may utilize the digital twin data to define precise spatial boundaries and access zones that correspond to specific rooms, areas, or functional spaces within the physical environment.

In some examples, the system may facilitate digital identity verification through linking scan footprints to digital identities, enhancing security for property transactions, smart home interactions, and authorized access control. In some cases, property owners may register their digital twin footprints with their digital identity credentials, creating a secure authentication mechanism that verifies both identity and physical presence within the property. In some aspects, the digital identity verification may include biometric integration, device authentication, and temporal validation that ensure authorized users are physically present within the verified space during authentication processes.

In some implementations, the digital twin system may support rental fraud prevention through spatial verification mechanisms that require potential tenants or property managers to demonstrate physical access to the property during transaction processes. In some cases, the system may generate authentication challenges that require users to capture specific spatial features, room configurations, or architectural details that match the registered digital twin footprint. In some aspects, the fraud prevention capabilities may include comparative analysis between submitted spatial data and verified property records to identify discrepancies that may indicate fraudulent activity or unauthorized access attempts.

In some examples, the system may provide property ownership verification through digital twin authentication that enables property owners to prove legitimate ownership or authorized access during disputes, transactions, or legal proceedings. In some cases, the spatial authentication may serve as evidence of physical control and access to the property, supporting ownership claims or authorized occupancy status. In some implementations, the ownership verification may include timestamped spatial captures, location-based authentication logs, and comparative analysis with historical property records that provide documentation of legitimate access and control.

In some aspects, the digital twin system may facilitate smart contract integration where property transactions, rental agreements, or access permissions may be automatically executed based on verified spatial authentication. In some cases, blockchain-based smart contracts may utilize digital twin footprints as authentication triggers that enable automatic execution of agreements when spatial verification requirements are met. In some implementations, the smart contract capabilities may include escrow services, automated payments, and conditional access grants that are triggered by successful spatial authentication processes.

In some examples, the system may support multi-factor spatial authentication that combines digital twin footprints with additional security measures such as biometric verification, device authentication, or temporal constraints. In some cases, the multi-factor approach may require users to provide spatial verification together with fingerprint scanning, facial recognition, or device-specific credentials to access sensitive functions or complete high-value transactions. In some aspects, the temporal constraints may include time-based access windows, recurring verification requirements, or session-based authentication that ensures continued legitimate access throughout extended interaction periods.

In some implementations, the digital twin system may provide audit trails and authentication logging that document all spatial authentication attempts, successful verifications, and access patterns for security monitoring and compliance purposes. In some cases, the audit capabilities may include detailed logs of authentication events, spatial verification results, and user access patterns that enable property owners or security administrators to monitor authorized access and identify potential security threats. In some aspects, the logging features may include integration with security systems, alert mechanisms for unauthorized access attempts, and reporting capabilities that support security analysis and incident response procedures.

In some examples, the system may facilitate emergency access override capabilities that enable authorized personnel such as emergency responders, maintenance staff, or property managers to access properties during emergency situations while maintaining security protocols. In some cases, the emergency access features may include temporary authentication codes, override mechanisms, or alternative verification methods that enable legitimate access when standard spatial authentication may not be feasible. In some implementations, the emergency capabilities may include automatic notification systems, temporary access logging, and post-emergency verification procedures that ensure security is maintained while enabling necessary emergency access.

In some aspects, the digital twin system may support scalable authentication deployment across multiple properties, enabling property management companies, real estate organizations, or institutional property owners to implement spatial authentication across their entire portfolio. In some cases, the scalable deployment may include centralized authentication management, standardized spatial verification protocols, and integrated reporting capabilities that enable efficient security administration across multiple properties and locations. In some implementations, the system may provide role-based access controls, hierarchical authentication permissions, and automated policy enforcement that ensure consistent security standards while accommodating different access requirements across various property types and user categories.

In some implementations, the digital twin system may facilitate a registry for digital twins that enables public and private storage, sharing, and collaborative development of digital twin representations across various industries and use cases. In some cases, the lack of a unified system for storing and accessing digital twin data may create inefficiencies and missed opportunities for collaboration, research, and professional development activities. In some aspects, the digital twin system may address these challenges by providing a centralized registry platform that enables users to store, license, rent, and build upon existing digital twin representations while maintaining appropriate access controls, version management, and attribution systems.

In some examples, the system may enable customers and professionals to access or license digital twins for specific use cases such as academic research, city planning, architectural studies, or commercial development projects. In some cases, researchers may access anonymized digital twin data from residential properties to study housing patterns, energy efficiency trends, or architectural evolution across different time periods and geographic regions. In some implementations, the registry may provide search and filtering capabilities that enable users to identify digital twins based on criteria such as building type, construction year, geographic location, architectural style, or specific features that align with their research or project requirements.

In some aspects, the digital twin registry may support municipal and governmental applications where building inspectors, city planners, and regulatory authorities may upload and access digital twin data to monitor building conditions, track construction progress, and evaluate compliance with zoning regulations and building codes. In some cases, municipal building inspectors may upload scans to a city-wide registry that creates an evolving record of building conditions over time, enabling predictive maintenance planning, infrastructure assessment, and regulatory compliance monitoring across entire municipalities. In some implementations, the registry may provide automated change detection capabilities that identify modifications to buildings between different scan sessions, alerting inspectors to potential unpermitted work or structural changes that require evaluation.

In some examples, the system may facilitate community-wide planning and development initiatives where designers, architects, and urban planners may access registry data to plan improvements, evaluate development proposals, or coordinate infrastructure projects across multiple properties and neighborhoods. In some cases, designers may access a registry of digital twins to analyze existing architectural patterns, identify opportunities for community improvements, or develop design proposals that complement existing neighborhood characteristics. In some aspects, the registry may enable collaborative planning sessions where multiple stakeholders may access shared digital twin data to coordinate development activities, evaluate environmental impact, or optimize resource allocation across community-wide projects.

In some implementations, the digital twin registry may provide version control and attribution systems that enable contributors to maintain ownership records, track modifications, and receive appropriate recognition for their contributions to digital twin development and maintenance. In some cases, the version control capabilities may include detailed change tracking that documents who made specific modifications, when changes were implemented, and what alterations were made to the digital twin representation. In some aspects, the attribution system may provide contributors with professional recognition, licensing revenue, or academic credit for their contributions to the registry, encouraging continued participation and high-quality data submission.

In some examples, the system may support professional credentialing and quality assurance mechanisms that verify the accuracy and reliability of digital twin submissions before they are made available through the registry. In some cases, licensed professionals such as architects, engineers, or certified inspectors may provide validation services that ensure digital twin data meets industry standards and accuracy requirements. In some implementations, the quality assurance process may include automated verification algorithms that check for dimensional consistency, structural feasibility, and compliance with building codes before digital twins are approved for registry inclusion.

In some aspects, the digital twin registry may implement sophisticated access control and permission management systems that enable property owners and contributors to specify who may access, modify, or license their digital twin representations. In some cases, property owners may grant different levels of access to various user categories, such as providing full access to family members, limited access to service providers, and restricted access to researchers or commercial users. In some implementations, the permission system may include temporal controls that enable time-limited access, usage-based licensing, or subscription models that provide ongoing access to updated digital twin data.

In some examples, the system may facilitate commercial licensing opportunities where digital twin creators may monetize their contributions through rental fees, licensing agreements, or usage-based pricing models. In some cases, professional scanning companies, architectural firms, or property management organizations may generate revenue by contributing high-quality digital twins to the registry and licensing access to commercial users. In some aspects, the licensing system may include automated payment processing, usage tracking, and revenue sharing mechanisms that ensure contributors receive appropriate compensation for their digital twin contributions.

In some implementations, the digital twin registry may support collaborative development workflows where multiple contributors may work together to enhance, update, or expand existing digital twin representations. In some cases, builders, inspectors, architects, and property owners may submit updated scans or modifications that maintain an evolving record of spaces as they change over time through renovations, maintenance, or natural aging processes. In some aspects, the collaborative features may include conflict resolution mechanisms, merge capabilities, and approval workflows that ensure quality and accuracy are maintained when multiple parties contribute to the same digital twin.

In some examples, the system may provide specialized registry categories that serve different industries and use cases, such as residential properties, commercial buildings, industrial facilities, public infrastructure, or historical landmarks. In some cases, each category may have specific metadata requirements, quality standards, and access protocols that align with the unique needs and regulatory requirements of different sectors. In some implementations, the specialized categories may include industry-specific search filters, compliance checking, and integration capabilities that enable seamless workflow integration with existing professional tools and processes.

In some aspects, the digital twin registry may facilitate educational and research applications through partnerships with academic institutions, research organizations, and educational technology providers. In some cases, universities may access anonymized digital twin data for architectural education, urban planning research, or engineering studies that require realistic spatial data for analysis and experimentation. In some implementations, the educational access may include special pricing, bulk licensing options, and educational resources that support curriculum development and student learning objectives.

In some examples, the system may support international collaboration and data sharing through standardized formats, multilingual interfaces, and cross-border licensing agreements that enable global access to digital twin resources. In some cases, international research collaborations, multinational development projects, or global architectural studies may benefit from access to digital twin data from different countries and regions. In some aspects, the international capabilities may include currency conversion, regional compliance features, and cultural adaptation tools that ensure the registry serves users across different geographic and regulatory environments.

In some implementations, the digital twin registry may provide analytics and reporting capabilities that enable contributors and administrators to monitor usage patterns, track performance metrics, and optimize registry operations. In some cases, the analytics may include user engagement statistics, popular search terms, licensing revenue reports, and quality metrics that inform registry management decisions and contributor strategies. In some aspects, the reporting features may include automated notifications, performance dashboards, and trend analysis tools that support data-driven decision making and continuous improvement of registry services.

In some implementations, the digital twin system may facilitate before and/or after scanning capabilities for final state capture post-renovation through systematic documentation that creates detailed records of property conditions before and after construction or renovation projects. In some cases, documentation of renovation or construction projects may be incomplete, making it difficult to verify that work has been completed to specification or to analyze changes over time. In some aspects, the digital twin system may address these documentation challenges by providing scanning capabilities that capture detailed “before” and “after” states of a property following renovations or construction, including all final finishes, materials, and modifications that may be used to power AI models for analyzing work quality, identifying deviations from plans, or assisting in future maintenance activities.

In some examples, the system may enable property owners to capture high-fidelity scans of renovated spaces that serve as reference documentation for future renovations, appraisals, or maintenance activities. In some cases, a property owner may utilize the system to capture a scan of a renovated kitchen, documenting the final state of all installations, finishes, and modifications that have been completed during the renovation project. In some implementations, the captured scan may include detailed representations of countertops, cabinetry, appliances, flooring, lighting fixtures, and other elements that provide a complete record of the renovation work and may serve as a baseline for future modifications or assessments.

In some aspects, construction firms may utilize the before/after scanning capabilities to demonstrate compliance with project specifications and provide clients with documentation of completed work. In some cases, contractors may capture detailed scans at project completion that verify all work has been performed according to approved plans, building codes, and quality standards. In some implementations, the final state documentation may include dimensional verification, material specifications, installation quality assessments, and compliance certifications that provide clients with confidence in the completed work and support warranty claims or future maintenance requirements.

In some examples, the digital twin system may provide AI-powered change detection and quality analysis capabilities that compare before and after scans to identify subtle changes or quality issues that may not be immediately apparent during manual inspections. In some cases, the AI models may analyze the digital twin representations to detect variations such as uneven tile work, improper installation of fixtures, dimensional discrepancies, or surface irregularities that could indicate construction defects or quality concerns. In some implementations, the change detection algorithms may generate detailed reports that highlight specific areas requiring attention, provide severity assessments, and recommend corrective actions based on industry standards and best practices.

In some aspects, the system may facilitate automatic as-built documentation generation from final scans, reducing the need for manual measurement and verification processes that may be time-consuming and prone to error. In some cases, the AI-powered analysis may process the post-renovation digital twin to generate as-built drawings, dimensional specifications, and material schedules that accurately reflect the completed work. In some implementations, the automatic documentation capabilities may include floor plan generation, elevation drawings, detail specifications, and compliance reports that provide professional-quality documentation without requiring extensive manual drafting or measurement activities.

In some examples, the digital twin system may support integration with insurance claims and appraisal processes through submission of “after” scans that provide proof of completed work or enable property value reassessment. In some cases, homeowners may submit post-renovation digital twin data to insurance companies as verification that claimed work has been completed according to approved specifications and industry standards. In some aspects, the insurance integration may include automated damage assessment, work verification, and claim processing capabilities that streamline the claims resolution process while providing insurers with detailed documentation of property improvements and current conditions.

In some implementations, real estate appraisers may utilize the before/after scanning documentation to reassess property values based on completed renovations and improvements. In some cases, the digital twin representations may provide appraisers with detailed information about renovation scope, material quality, workmanship standards, and compliance with building codes that inform property valuation decisions. In some aspects, the appraisal integration may include automated valuation adjustments, comparative analysis capabilities, and market positioning assessments that enable more accurate property valuations based on documented improvements and current market conditions.

In some examples, the system may provide temporal comparison capabilities that enable users to navigate between different time periods and visualize the progression of renovation work over multiple phases or projects. In some cases, property owners may access historical scans to understand how their property has evolved over time, compare different renovation approaches, or plan future improvements based on previous modification patterns. In some implementations, the temporal navigation features may include interactive timelines, before/after overlays, and progressive change visualization that enable understanding of property evolution and renovation history.

In some aspects, the digital twin system may support quality benchmarking and performance analysis through comparison of completed work against industry standards, manufacturer specifications, and regulatory requirements. In some cases, the AI models may analyze the final state documentation to evaluate installation quality, material performance, and compliance with applicable codes and standards. In some implementations, the benchmarking capabilities may include scoring systems, performance metrics, and improvement recommendations that enable property owners and contractors to understand work quality relative to industry best practices and identify opportunities for enhancement in future projects.

In some examples, the system may facilitate maintenance planning and lifecycle management through analysis of renovation documentation and prediction of future maintenance requirements. In some cases, the AI models may process the post-renovation digital twin data to identify components that may require periodic maintenance, predict replacement schedules, and recommend preventive measures based on material specifications and usage patterns. In some aspects, the maintenance planning capabilities may include automated scheduling, vendor recommendations, and cost projections that enable proactive property management and help prevent costly repairs or premature component failures.

In some implementations, the digital twin system may provide collaborative review capabilities that enable multiple stakeholders including contractors, architects, inspectors, and property owners to examine the final state documentation and verify project completion. In some cases, the collaborative features may include annotation tools, approval workflows, and communication platforms that facilitate project review and sign-off processes. In some aspects, the collaborative capabilities may include remote inspection support, expert consultation services, and dispute resolution mechanisms that ensure all parties are satisfied with the completed work and documentation quality.

In some implementations, the digital twin system may facilitate consolidated memory capabilities that serve as a single source of truth for property history documentation through structured time-stamped records that address the fragmentation typically found across multiple documents and sources. In some cases, property history information may be scattered across various documents, permits, inspection reports, contractor records, and maintenance logs, making it challenging for property owners, real estate professionals, and service providers to maintain a cohesive understanding of how a space has evolved over time. In some aspects, the digital twin system may address these challenges by creating a unified digital repository that consolidates all renovations, repairs, modifications, and maintenance activities into a structured format that preserves the complete evolution of the property throughout its lifecycle.

In some examples, the system may utilize digital twin representations to create a consolidated memory system where each update, modification, or maintenance activity generates a historical snapshot that documents the state of the property at specific points in time. In some cases, homeowners may access a complete visual history of their home's evolution, enabling them to understand how previous modifications have shaped the current configuration and inform future improvement decisions. In some implementations, the consolidated memory capabilities may include detailed documentation of renovation projects, material selections, contractor information, permit records, and inspection results that provide context for each phase of the property's development.

In some aspects, the digital twin system may provide real estate agents with powerful tools to demonstrate property maintenance and improvement history to potential buyers through interactive visual documentation that showcases how the property has been cared for and enhanced over time. In some cases, real estate professionals may utilize the consolidated property history to highlight quality improvements, demonstrate compliance with building codes, and provide transparency regarding the property's condition and maintenance status. In some implementations, the system may generate property reports that include renovation timelines, material specifications, contractor certifications, and compliance documentation that support property valuation and buyer confidence.

In some examples, the system may implement geological snapshot analogies that visualize property changes through layered representations or “strata” that correspond to different periods in the property's timeline. In some cases, users may navigate through these temporal layers to understand how the property has evolved, with each stratum representing a distinct phase of development, renovation, or modification. In some aspects, the geological visualization approach may provide intuitive understanding of property evolution by presenting changes in a familiar layered format that enables users to explore different time periods and understand the relationship between various modification phases.

In some implementations, the digital twin system may provide interactive time-lapse features that enable users to view animated sequences of property modifications and visually explore how spaces have evolved over time. In some cases, the time-lapse capabilities may include smooth transitions between different property states, highlighting specific changes such as room reconfigurations, fixture installations, or material updates. In some aspects, users may control the playback speed, pause at specific time periods, or focus on particular areas of interest to understand the progression of modifications and their impact on the overall property configuration.

In some examples, the system may support metadata integration that includes contractor details, permit information, inspection results, warranty documentation, and compliance certifications within the consolidated property history. In some cases, each historical snapshot may include detailed metadata that provides context about who performed the work, when it was completed, what permits were obtained, and how the work was inspected and approved. In some implementations, the metadata integration may include links to original documents, photographs of work in progress, material specifications, and contact information for service providers that enable future owners or inspectors to access complete information about previous work.

In some aspects, the digital twin system may facilitate inheritance and transfer capabilities that enable the consolidated property memory to be seamlessly transferred to new owners during property transactions. In some cases, the complete property history may be included as part of the property transfer process, providing new owners with immediate access to detailed information about previous modifications, maintenance schedules, warranty periods, and recommended future improvements. In some implementations, the transfer capabilities may include verification mechanisms that ensure the accuracy and completeness of the property history while protecting sensitive information and maintaining appropriate access controls.

In some examples, the system may provide predictive maintenance capabilities that analyze the consolidated property history to identify patterns, predict future maintenance requirements, and recommend proactive measures based on the documented lifecycle of various building systems and components. In some cases, the AI models may process the historical data to understand how different materials, installations, and systems have performed over time, enabling more accurate predictions about when maintenance or replacement activities may be needed. In some aspects, the predictive capabilities may include cost projections, vendor recommendations, and scheduling suggestions that help property owners optimize their maintenance activities and prevent costly emergency repairs.

In some implementations, the digital twin system may support regulatory compliance tracking through integration of the consolidated property history with local building codes, permit requirements, and inspection schedules. In some cases, the system may monitor compliance status across all historical modifications, identify areas where updates may be needed to meet current standards, and provide recommendations for bringing older installations into compliance with current regulations. In some aspects, the compliance tracking may include automated notifications for permit renewals, inspection schedules, and code updates that affect previously completed work.

In some examples, the system may facilitate insurance optimization through analysis of the consolidated property history to identify improvements that may qualify for insurance discounts or coverage enhancements. In some cases, insurance companies may access the documented property improvements, safety upgrades, and maintenance history to assess risk factors and adjust coverage terms or premiums accordingly. In some implementations, the insurance integration may include automated reporting capabilities that generate compliance documentation, safety certifications, and improvement summaries that support favorable insurance rates and coverage options.

In some aspects, the digital twin system may provide collaborative access controls that enable different stakeholders to contribute to and access appropriate portions of the consolidated property memory based on their roles and authorization levels. In some cases, family members may have full access to the property history, while service providers may access relevant technical information, and potential buyers may view selected portions during property evaluation processes. In some implementations, the access control system may include audit trails that document who accessed what information and when, ensuring accountability and transparency in the management of sensitive property information.

In some implementations, the digital twin system may facilitate timeline visualization capabilities that provide users with interactive tools to explore property evolution over time through structured chronological representations of modifications, renovations, and changes. In some cases, property owners, real estate professionals, and construction managers may lack visual tools that clearly represent how a property has changed over time, making it challenging to understand the evolution of spaces or plan future modifications based on historical patterns. In some aspects, the digital twin system may address these visualization challenges by creating interactive digital twin timelines that display property changes as chronological nodes, enabling users to navigate through different time periods and explore historical configurations of their spaces.

In some examples, the system may utilize digital twin representations to create timeline visualizations where each scan, update, or modification generates a temporal node that documents the state of the property at specific points in time. In some cases, homeowners may access interactive timeline interfaces that allow them to explore how their property looked before major renovations, understand the progression of improvements over time, and visualize the impact of various modifications on the overall space configuration. In some implementations, the timeline visualization may include detailed markers for significant events such as renovation projects, system installations, material updates, or structural modifications that provide context for each phase of the property's development.

In some aspects, the digital twin system may provide city planners with timeline tools that enable tracking of public building development and modifications over extended periods. In some cases, municipal planners may utilize the timeline visualization to monitor how public facilities have evolved, assess the effectiveness of improvement projects, and plan future modifications based on historical development patterns. In some implementations, the system may enable construction managers to utilize timeline visualization for project monitoring and problem identification, allowing them to review construction progress and identify specific time periods when issues may have occurred during building or renovation processes.

In some examples, the digital twin system may provide interactive timeline navigation capabilities that enable users to move through different time points with precision and control. In some cases, the navigation interface may include zoom functionality that allows users to focus on specific dates, construction phases, or renovation periods within the property's lifecycle. In some aspects, users may utilize timeline controls to jump between significant milestones, scroll through gradual changes, or focus on particular areas of interest within the property's evolution. In some implementations, the navigation tools may include playback controls that enable users to view animated sequences of property changes, with adjustable speed settings that allow for detailed examination of specific modification phases.

In some implementations, the digital twin system may provide automated change detection and summary capabilities that analyze differences between timeline nodes and generate reports of modifications, additions, or alterations. In some cases, the AI models may process digital twin data from different time periods to identify structural modifications, added features, replaced materials, or configuration changes that have occurred between specific timeline points. In some aspects, the automated change detection may include severity assessments, impact analysis, and categorization of modifications based on their scope and significance. In some examples, the system may generate detailed summaries that highlight key changes, provide context about renovation projects, and document the evolution of specific building systems or architectural elements over time.

In some aspects, the digital twin system may facilitate comparison tools that enable side-by-side analysis of different time periods within the property timeline. In some cases, users may select multiple timeline nodes to generate comparative visualizations that highlight differences in materials, layouts, configurations, and architectural features between different phases of the property's development. In some implementations, the comparison capabilities may include overlay visualizations that show changes directly within the three-dimensional model, color-coded highlighting that identifies modified areas, and detailed reports that document specific differences between selected time periods. In some examples, the comparison tools may enable users to evaluate the effectiveness of renovation projects, understand the impact of material changes, and assess how different modifications have contributed to the overall evolution of the property.

In some implementations, the digital twin system may support temporal rewind functionality that enables users to explore previous configurations and understand historical conditions within their properties. In some cases, the rewind capabilities may allow users to virtually “travel back” to specific time periods and explore how spaces were configured, what materials were used, and how different areas functioned during previous phases of the property's lifecycle. In some aspects, the temporal exploration may include detailed information about historical installations, previous renovation approaches, and material selections that inform current decision-making processes and future improvement planning.

In some examples, the system may provide construction timeline analysis that enables project managers and contractors to monitor construction progress and identify specific time periods when problems or delays may have occurred. In some cases, construction professionals may utilize the timeline visualization to review work sequences, identify bottlenecks in construction processes, and understand how different phases of construction have progressed relative to planned schedules. In some implementations, the construction timeline analysis may include milestone tracking, progress assessment, and problem identification capabilities that support project management decision-making and quality control processes.

In some aspects, the digital twin system may facilitate historical documentation preservation through timeline integration that maintains records of property evolution for future reference and analysis. In some cases, the timeline visualization may serve as a permanent archive of property changes that may be accessed by future owners, service providers, or regulatory authorities who need to understand the history and evolution of specific properties. In some implementations, the historical preservation capabilities may include metadata integration, document linking, and verification mechanisms that ensure the accuracy and completeness of timeline information over extended periods.

In some examples, the system may support collaborative timeline sharing that enables multiple stakeholders to access and contribute to property timeline documentation. In some cases, family members, contractors, architects, and property managers may collaborate on timeline development by contributing scans, documentation, and contextual information about different phases of property evolution. In some aspects, the collaborative features may include permission controls, contribution tracking, and approval workflows that ensure timeline accuracy while enabling multiple parties to participate in the documentation process.

In some implementations, the digital twin system may provide predictive timeline analysis that utilizes historical patterns to forecast future maintenance requirements and modification opportunities. In some cases, the AI models may analyze timeline data to identify recurring patterns, predict when specific systems or components may require attention, and recommend optimal timing for future improvements based on historical renovation cycles and material performance data. In some aspects, the predictive capabilities may include cost projections, scheduling recommendations, and resource planning tools that help property owners optimize their long-term property management strategies based on documented historical patterns and trends.

In some implementations, the digital twin system may facilitate space claiming and historical scan access capabilities that enable new property owners, tenants, or authorized users to gain access to digital twin records and historical documentation from previous occupants. In some cases, new property owners or tenants may lack access to historical scans, renovation records, or maintenance documentation that would provide valuable context about previous modifications, repairs, or improvements made to the property. In some aspects, the digital twin system may address these information gaps by providing space claiming mechanisms that enable authorized users to access historical digital twin data while maintaining appropriate privacy controls and permission management systems.

In some examples, the system may enable users such as homeowners, tenants, or property managers to “claim” a space and gain access to authorized historical scans and digital twin records that have been shared by previous owners or occupants. In some cases, a new homeowner may claim their property and receive access to digital twin records showing all renovations, repairs, and modifications made by previous owners, providing valuable context for understanding the property's evolution and informing future maintenance or improvement decisions. In some implementations, the space claiming process may include verification mechanisms that confirm the user's legitimate relationship to the property, such as through property deed records, lease agreements, or other documentation that establishes authorized access rights.

In some aspects, the digital twin system may provide access control and permission management capabilities that enable previous owners or occupants to share digital twin records selectively based on their preferences and privacy requirements. In some cases, previous property owners may choose to share complete digital twin histories including all renovations, maintenance records, and system installations, while in other situations they may opt to share only specific portions of the digital twin data such as structural information or major system installations while excluding personal or sensitive areas. In some implementations, the permission system may include granular controls that allow previous owners to specify which rooms, time periods, or types of information may be shared with new occupants, ensuring that privacy preferences are respected while still providing valuable property information.

In some examples, the system may implement digital twin handover protocols that create standardized procedures for transferring digital twin records during property transactions, ensuring that new owners receive digital histories of their properties. In some cases, the handover protocol may be integrated with real estate transaction processes, enabling automatic transfer of authorized digital twin records when property ownership changes hands. In some aspects, the handover process may include verification steps that confirm the completeness and accuracy of transferred records, documentation of what information has been shared, and establishment of new access credentials for the incoming property owner or tenant.

In some implementations, the digital twin system may provide anonymization and privacy protection features that enable previous owners to remove sensitive or personal information from digital twin records before sharing them with new occupants. In some cases, the anonymization capabilities may include automated detection and removal of personal photographs, private documents, personal belongings, or other sensitive content that may have been captured during digital twin generation processes. In some aspects, the system may provide selective anonymization tools that allow previous owners to review their digital twin records and manually specify which elements should be obscured, removed, or modified before transfer to new occupants.

In some examples, the space claiming system may support multi-tenant scenarios where rental properties or commercial spaces may have multiple authorized users who require access to different portions of the digital twin history. In some cases, property managers may maintain digital twin records while providing tenants with access to relevant portions of the property history such as maintenance records, system specifications, or renovation information that affects their specific units or areas. In some implementations, the multi-tenant access controls may include role-based permissions that provide different levels of access based on the user's relationship to the property, such as full access for property owners, limited access for tenants, and technical access for service providers or maintenance personnel.

In some aspects, the digital twin system may facilitate verification and authentication mechanisms that ensure only authorized users may claim spaces and access historical digital twin records. In some cases, the verification process may include integration with property records databases, utility account information, or other official documentation that confirms the user's legitimate relationship to the property. In some implementations, the authentication system may include multi-factor verification that combines property-specific information with personal identification to prevent unauthorized access to sensitive property records.

In some examples, the system may provide audit trails and access logging that document all space claiming activities, record transfers, and historical scan access events for security and accountability purposes. In some cases, the audit capabilities may include detailed logs of who accessed what information, when transfers occurred, and what modifications were made to permission settings or shared records. In some aspects, the logging system may provide previous owners with notifications when their shared digital twin records are accessed, enabling them to monitor how their contributed information is being utilized while maintaining transparency in the record sharing process.

In some implementations, the digital twin system may support legacy record integration that enables incorporation of historical documentation, photographs, or other property records that predate digital twin generation into the property history. In some cases, previous owners may contribute historical renovation photographs, contractor records, permit documentation, or maintenance logs that complement the digital twin records and provide additional context about the property's evolution. In some aspects, the legacy integration capabilities may include document scanning, metadata extraction, and timeline integration that incorporates historical records into the digital twin timeline while maintaining chronological accuracy and contextual relationships.

In some examples, the space claiming system may facilitate collaborative property history development where multiple previous owners, contractors, or service providers may contribute to the digital twin record over time. In some cases, contractors who have performed work on the property may be authorized to contribute digital twin updates, renovation documentation, or system installation records that enhance the overall property history. In some implementations, the collaborative features may include contribution tracking, quality verification, and approval workflows that ensure the accuracy and completeness of contributed information while maintaining appropriate access controls and privacy protections.

In some aspects, the digital twin system may provide incentive mechanisms that encourage previous owners to share their digital twin records with new occupants, such as through recognition programs, community contributions, or other benefits that acknowledge their participation in maintaining property histories. In some cases, the incentive system may include reputation tracking, community recognition, or other rewards that encourage high-quality record sharing and maintenance of accurate property documentation. In some implementations, the system may provide feedback mechanisms that enable new property owners to acknowledge and appreciate the value of shared digital twin records, creating positive reinforcement for continued participation in the record sharing ecosystem.

In some implementations, the digital twin system may facilitate building management and health score monitoring capabilities through AI-driven analysis of structural conditions and environmental parameters to provide building health assessment and maintenance optimization. In some cases, building management may lack continuous and precise visibility into the health of structures, making it difficult to monitor issues such as structural integrity, environmental conditions, or emerging maintenance needs that could affect building safety and operational efficiency. In some aspects, the digital twin system may address these challenges by providing building health monitoring capabilities that track parameters such as structural integrity, humidity levels, and areas requiring repairs through continuous analysis of digital twin data and sensor integration.

In some examples, the system may utilize digital twin representations to create building health monitoring systems that track structural integrity parameters including crack development, foundation settlement, wall deformation, and other indicators of structural condition. In some cases, property managers may access substantially real-time monitoring of building conditions through analysis of digital twin data that identifies changes in structural elements, surface conditions, or dimensional relationships that may indicate developing maintenance issues. In some implementations, the machine learning models may analyze the text-based descriptors, spatial configurations, and visual data within digital twins to detect subtle changes in building conditions that may not be immediately apparent during manual inspections.

In some aspects, the digital twin system may provide AI-driven anomaly detection capabilities that analyze scan data to identify structural anomalies such as micro-cracks, water damage, material fatigue, or other indicators of building deterioration. In some cases, the AI models may process digital twin representations captured at different time intervals to detect progressive changes in building conditions, identifying areas where structural elements may be experiencing stress, moisture intrusion, or material degradation. In some implementations, the anomaly detection algorithms may be trained to recognize patterns associated with common building issues, enabling early identification of problems before they become more serious or costly to address.

In some examples, the system may generate dynamic health scores for buildings that provide quantitative assessments of overall building condition based on analysis of multiple structural and environmental parameters. In some cases, the health scoring system may evaluate factors such as structural integrity, moisture levels, material condition, system performance, and maintenance history to generate building health ratings. In some aspects, the health scores may be updated substantially in real-time as new digital twin data is captured or as environmental conditions change, providing building managers with current assessments of building condition and maintenance priorities.

In some implementations, the digital twin system may provide health score dashboard capabilities that display visual representations of building health conditions through color-coded zones that indicate critical, moderate, or low-risk areas within the building. In some cases, the dashboard may include interactive visualizations that enable users to explore different areas of the building and access detailed information about specific health conditions, maintenance requirements, or risk factors. In some aspects, the dashboard may provide annotation capabilities that enable building managers to add notes or comments regarding specific conditions, maintenance activities, or observations that contribute to the health score assessments.

In some examples, the health score dashboard may include zone-specific information that explains the conditions and factors that contribute to particular health score ratings for different areas of the building. In some cases, critical zones may be highlighted with detailed explanations of identified issues such as structural concerns, moisture problems, or system failures that require immediate attention. In some implementations, the dashboard may provide moderate-risk zones with information about developing conditions that may require monitoring or preventive maintenance, while low-risk zones may display confirmation of good condition status and recommended maintenance schedules.

In some aspects, the digital twin system may facilitate predictive maintenance integration that connects building health monitoring with automated maintenance scheduling and resource allocation systems. In some cases, the system may analyze health score trends, historical maintenance data, and predictive models to automatically schedule inspections, repairs, or preventive maintenance activities based on building condition assessments. In some implementations, the predictive maintenance capabilities may include integration with work order systems, contractor scheduling platforms, and resource management tools that streamline the coordination of maintenance activities based on health score priorities.

In some examples, the system may provide substantially real-time alert capabilities that notify building managers, maintenance personnel, or other stakeholders when health scores indicate emerging issues or critical conditions that require immediate attention. In some cases, the alert system may include customizable notification thresholds, escalation procedures, and communication protocols that ensure appropriate personnel are informed about building health issues in a timely manner. In some aspects, the alerts may include detailed information about identified problems, recommended actions, and priority levels that enable efficient response to building health concerns.

In some implementations, the digital twin system may support insurance integration capabilities that enable insurance companies to access building health scores and condition assessments for risk evaluation and premium adjustment purposes. In some cases, insurers may utilize the health monitoring data to assess risk factors, evaluate building maintenance practices, and adjust coverage terms or premiums based on documented building conditions and maintenance history. In some aspects, the insurance integration may include automated reporting capabilities that generate compliance documentation, condition assessments, and risk analysis reports that support favorable insurance rates and coverage options for well-maintained buildings.

In some examples, the system may provide trend analysis and historical tracking capabilities that enable building managers to monitor how building health scores change over time and identify patterns in building condition deterioration or improvement. In some cases, the trend analysis may include seasonal variations, usage-related impacts, and maintenance effectiveness assessments that inform long-term building management strategies. In some implementations, the historical tracking may include comparative analysis capabilities that enable building managers to evaluate the effectiveness of different maintenance approaches, material selections, or system upgrades based on their impact on building health scores.

In some aspects, the digital twin system may facilitate multi-building portfolio management where property management companies or institutional building owners may monitor health scores across multiple properties through centralized dashboards and reporting systems. In some cases, the portfolio management capabilities may include comparative analysis tools that enable managers to identify buildings requiring priority attention, allocate maintenance resources efficiently, and optimize overall portfolio performance based on building health assessments. In some implementations, the system may provide benchmarking capabilities that compare building health scores against industry standards, similar properties, or historical performance metrics to support strategic decision-making and resource allocation.

In some examples, the building health monitoring system may integrate with environmental monitoring sensors and IoT devices to provide assessment of both structural and environmental conditions that affect building health. In some cases, the system may monitor parameters such as temperature, humidity, air quality, vibration, and other environmental factors that may impact building condition and occupant comfort. In some aspects, the environmental integration may include correlation analysis that identifies relationships between environmental conditions and structural health indicators, enabling more understanding of factors that affect building performance and maintenance requirements.

In some implementations, the digital twin system may provide customizable health scoring algorithms that enable building managers to adjust assessment criteria, weighting factors, and priority levels based on specific building types, usage patterns, or organizational requirements. In some cases, commercial buildings may utilize different health scoring criteria than residential properties, while historical buildings may require specialized assessment parameters that account for unique preservation requirements. In some aspects, the customization capabilities may include industry-specific templates, regulatory compliance checking, and specialized assessment protocols that ensure health scoring aligns with relevant standards and requirements for different building types and applications.

In some implementations, the digital twin system may facilitate monitoring and risk management capabilities for oil and gas, maritime, and mining industries through AI-driven analysis of complex operational environments to provide enhanced safety, predictive maintenance, and regulatory compliance. In some cases, industries such as oil and gas, maritime, and mining may face significant challenges in monitoring and maintaining complex environments that are difficult to access, leading to high operational risks, safety concerns, and maintenance costs that could be mitigated through advanced digital monitoring technologies. In some aspects, the digital twin system may address these challenges by creating detailed digital models of critical infrastructure including pipelines, vessels, and mining sites, utilizing AI-powered analysis to monitor for issues such as oil leaks, structural fatigue, unsafe conditions, and equipment degradation through remote and substantially real-time environmental assessment capabilities.

In some examples, the system may utilize digital twin representations to create pipeline integrity monitoring systems for oil and gas operations that track structural conditions, pressure variations, temperature fluctuations, and potential leak indicators across extensive pipeline networks. In some cases, oil and gas operators may access substantially real-time monitoring of pipeline conditions through analysis of digital twin data that identifies changes in structural elements, surface conditions, or operational parameters that may indicate developing integrity issues or potential leak scenarios. In some implementations, the machine learning models may analyze the text-based descriptors, spatial configurations, and sensor data within digital twins to detect subtle changes in pipeline conditions such as micro-fractures, corrosion patterns, or pressure anomalies that may not be immediately apparent during manual inspections.

In some aspects, the digital twin system may provide AI-driven leak detection capabilities that analyze sensor data and digital twin representations to identify potential oil leaks, gas emissions, or other hazardous releases before they become significant environmental or safety incidents. In some cases, the AI models may process digital twin data captured from IoT sensors, pressure monitoring systems, and environmental detection equipment to identify patterns associated with leak development, enabling early intervention and containment measures. In some implementations, the leak detection algorithms may be trained to recognize signatures of different types of leaks, pressure variations, and environmental changes that indicate compromised pipeline integrity or equipment failure.

In some examples, the system may generate dynamic risk scores for pipeline segments that provide quantitative assessments of leak probability and structural integrity based on analysis of multiple operational and environmental parameters. In some cases, the risk scoring system may evaluate factors such as pipeline age, material condition, pressure history, environmental exposure, and maintenance records to generate pipeline health ratings. In some aspects, the risk scores may be updated substantially in real-time as new sensor data is captured or as operational conditions change, providing operators with current assessments of pipeline condition and maintenance priorities.

In some implementations, the digital twin system may facilitate maritime vessel monitoring capabilities through detailed hull structure modeling that tracks stress points, material wear, and structural fatigue across ship components and systems. In some cases, maritime operators may utilize digital twin representations to monitor vessel structural integrity, identify areas experiencing excessive stress, and predict maintenance requirements based on operational conditions and environmental exposure. In some aspects, the system may analyze factors such as wave loading, cargo distribution, engine vibration, and weather conditions to assess their impact on vessel structural health and operational safety.

In some examples, the maritime digital twin system may provide AI-powered structural analysis capabilities that monitor hull deformation, material fatigue, and stress concentration areas that may indicate developing structural issues or safety concerns. In some cases, the AI models may process sensor data from strain gauges, accelerometers, and other monitoring equipment integrated throughout the vessel to detect changes in structural behavior that may indicate fatigue, corrosion, or damage. In some implementations, the structural analysis algorithms may be trained to recognize patterns associated with different types of vessel degradation, enabling predictive maintenance scheduling and safety risk mitigation.

In some aspects, the digital twin system may support vessel stability simulation capabilities that enable maritime operators to evaluate the impact of different loading conditions, weather scenarios, or operational parameters on vessel safety and performance. In some cases, the system may simulate the effects of high sea waves, cargo shifts, or equipment failures on vessel stability, providing operators with predictive analysis of potential safety risks and operational limitations. In some implementations, the simulation capabilities may include scenario modeling that evaluates emergency response procedures, evacuation protocols, and damage control strategies based on the specific characteristics of the vessel and its operational environment.

In some examples, the system may facilitate mining site safety monitoring through digital twin representations that assess structural stability, hazardous conditions, and equipment performance across mining operations. In some cases, mining operators may utilize digital twin technology to monitor underground tunnels, surface excavations, equipment installations, and environmental conditions that affect worker safety and operational efficiency. In some aspects, the system may analyze factors such as ground stability, air quality, equipment vibration, and structural integrity to identify potential hazards and optimize safety protocols.

In some implementations, the digital twin system may provide AI-driven hazard detection capabilities that analyze mining site conditions to identify unsafe situations such as ground instability, equipment malfunctions, or environmental hazards that may pose risks to personnel or operations. In some cases, the AI models may process sensor data from ground monitoring systems, air quality sensors, and equipment monitoring devices to detect patterns associated with developing hazards or safety concerns. In some aspects, the hazard detection algorithms may be trained to recognize signatures of different types of mining risks, enabling proactive safety measures and emergency response procedures.

In some examples, the mining digital twin system may support environmental monitoring that tracks air quality, dust levels, gas concentrations, and other environmental parameters that affect worker health and safety. In some cases, the system may monitor parameters such as methane levels, particulate matter, temperature variations, and humidity conditions that may impact mining operations and personnel safety. In some implementations, the environmental monitoring capabilities may include correlation analysis that identifies relationships between operational activities and environmental conditions, enabling optimization of mining processes and safety protocols.

In some aspects, the digital twin system may facilitate IoT sensor integration capabilities that incorporate data from distributed sensor networks to provide substantially real-time updates and alerts for critical conditions across oil and gas, maritime, and mining operations. In some cases, the system may integrate with pressure sensors, temperature monitors, vibration detectors, strain gauges, and environmental sensors to create monitoring networks that feed data into the digital twin representations. In some implementations, the IoT integration may include automated data collection, sensor health monitoring, and communication protocols that ensure reliable data transmission and system availability.

In some examples, the system may provide substantially real-time alert capabilities that notify operators, safety personnel, or other stakeholders when sensor data or digital twin analysis indicates emerging hazards or critical conditions that require immediate attention. In some cases, the alert system may include customizable notification thresholds, escalation procedures, and communication protocols that ensure appropriate personnel are informed about safety issues in a timely manner. In some aspects, the alerts may include detailed information about identified problems, recommended actions, and priority levels that enable efficient response to safety concerns and operational issues.

In some implementations, the digital twin system may support scenario simulation and risk analysis capabilities that enable operators to evaluate the potential impact of various operational conditions, equipment failures, or environmental factors on safety and performance. In some cases, oil and gas operators may simulate the effects of pipeline pressure variations, temperature changes, or equipment malfunctions on system integrity and leak risk. In some aspects, maritime operators may simulate the impact of severe weather conditions, cargo loading scenarios, or mechanical failures on vessel stability and safety, while mining operators may evaluate the effects of excavation activities, equipment operations, or environmental changes on site safety and structural stability.

In some examples, the system may facilitate compliance monitoring and regulatory reporting capabilities that continuously assess operations against industry regulations, safety standards, and environmental requirements. In some cases, the digital twin system may monitor operational parameters, safety conditions, and environmental impacts to ensure compliance with regulations such as pipeline safety standards, maritime safety codes, or mining safety requirements. In some implementations, the compliance monitoring may include automated reporting capabilities that generate regulatory documentation, safety assessments, and environmental impact reports that support regulatory compliance and audit requirements.

In some aspects, the digital twin system may provide predictive maintenance integration that connects operational monitoring with automated maintenance scheduling and resource allocation systems across oil and gas, maritime, and mining operations. In some cases, the system may analyze operational data, equipment performance metrics, and predictive models to automatically schedule inspections, repairs, or preventive maintenance activities based on equipment condition assessments and operational requirements. In some implementations, the predictive maintenance capabilities may include integration with work order systems, contractor scheduling platforms, and resource management tools that streamline the coordination of maintenance activities based on operational priorities and safety requirements.

In some examples, the system may support multi-site portfolio management where operators may monitor multiple facilities, vessels, or mining sites through centralized dashboards and reporting systems. In some cases, the portfolio management capabilities may include comparative analysis tools that enable operators to identify facilities requiring priority attention, allocate maintenance resources efficiently, and optimize overall operational performance based on safety assessments and operational metrics. In some implementations, the system may provide benchmarking capabilities that compare operational performance against industry standards, similar facilities, or historical performance metrics to support strategic decision-making and resource allocation.

In some aspects, the digital twin system may facilitate emergency response planning and coordination through simulation capabilities that model various crisis scenarios and their potential impact on operations and personnel safety. In some cases, emergency management teams may utilize digital twin models to simulate oil spills, vessel emergencies, or mining accidents to develop optimized response strategies and resource allocation plans. In some implementations, the system may analyze evacuation routes, emergency equipment locations, and personnel distribution patterns to identify vulnerabilities, optimize emergency response procedures, and coordinate multi-agency disaster response activities across industrial operations.

### EXAMPLE CLAUSES

A. A method comprising: receiving, from a scanning device, sensor data of a physical environment; generating a three-dimensional model of the physical environment based at least in part on the sensor data; generating a plurality of text-based descriptors of the physical environment based at least in part on the three-dimensional model; and storing the text-based descriptors together with the three-dimensional model.

B. The method of A, wherein: the three-dimensional model includes features and objects of the physical environment; and the text-based descriptors include descriptions of the features and objects.

C. The method of A, further comprising: receiving, from a display device, a query associated with the three-dimensional model; and generating, based at least in part on the query, a prompt for use as an input to a machine learning model.

D. The method of C, wherein generating the prompt is based at least in part on the text-based descriptors.

E. The method of C, further comprising inputting the text-based descriptors and the prompt into one or more machine learning models trained on textual descriptions of physical spaces and receiving output data as an output of the one or more machine learning models.

F. The method of E, wherein the one or more machine learning models includes at least one of a large language model, neural network, or artificial intelligence agent.

G. The method of E, further comprising: determining, based at least in part on the output data, a modification associated with the three-dimensional model; generating, based at least in part on the three-dimensional model and the modification, an updated three-dimensional model; and causing a user to consume the updated three-dimensional model.

H. The method of E, further comprising: generating, based at least in part on the output data, a report associated with the three-dimensional model; and providing the report to the display device.

I. The method of H, wherein the report includes at least one of: analytics data associated with the physical environment and a second physical environment different than the first physical environment, characteristic data associated with the physical environment, a proposed physical modification to the physical environment, quote data associated with physical modifications to the physical environment, object data associated with the physical environment, material data associated with the physical environment, or dimensions associated with the physical environment.

J. The method of A, wherein generating the plurality of text-based descriptors further comprises: inputting the sensor data of the physical environment into one or more machine learning model and receiving segmented and classified data of objects as an output of the machine learning model; and converting the segmented and classified data the text-based descriptors.

K. A computer-readable medium storing instructions that, when executed by one or more processors, cause the one or more processors to perform operations comprising: receiving, from a scanning device, sensor data of a physical environment; generating a three-dimensional model of the physical environment based at least in part on the sensor data, wherein the three-dimensional model includes features and objects included in the physical environment; generating, based at least in part on the three-dimensional model, a plurality of text-based descriptors of the features and objects; receiving, from a display device, a query associated with the three-dimensional model; generating, based at least in part on the query, a prompt for use as an input to a machine learning model; inputting the text-based descriptors and the prompt into one or more machine learning models trained on textual descriptions of physical environments and receiving output data as an output of the one or more machine learning models; and providing the output data to the display device.

L. The computer-readable medium of K, the operations further comprising: determining, based at least in part on the output data, a modification associated with the three-dimensional model; generating, based at least in part on the three-dimensional model and the modification, an updated three-dimensional model; and causing a user to consume the updated three-dimensional model.

M. The computer-readable medium of K, the operations further comprising: generating, based at least in part on the output data, a report associated with the three-dimensional model; and providing the report to the display device.

N. A method comprising: receiving image data of the physical environment and location data associated with the capture of the image data with respect to the physical environment; determining, based at least in part on the location data, a position of the image data with respect to a digital twin of the physical environment; and registering the image data at the position within the digital twin.

O. The method of N, wherein determining the position of the image data within the digital twin is based at least in part on one or more visual place recognition techniques between content of the digital twin and the image data.

P. The method of O, wherein the one or more visual place recognition techniques includes one or more of the following: analyzing visual features within the image data and the digital twin to identify matching architectural elements, surface textures, and spatial patterns; determining feature descriptors from the image data and comparing the feature descriptors to corresponding text-based descriptors of the digital twin; and determining geometric properties and dimensional characteristics from the image data and comparing the geometric properties and dimensional characteristics to corresponding text-based descriptors of the digital twin.

Q. The method of O, wherein the location data is position and orientation data associated with a capture device.

R. The method of N, further comprising presenting the image data to a user in response to a user interaction with the position within the digital twin.

S. The method of N, further comprising presenting the image data to a user in response to a field of view associated with the user with respect to the digital twin and the position.

T. The method of N, wherein the image data includes at least one of a photograph, a video frame, or a sequence of video frames of the physical environment.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### Conclusion

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A method comprising:
receiving, from a scanning device, sensor data of a physical environment;
generating a three-dimensional model of the physical environment based at least in part on the sensor data;
generating a plurality of text-based descriptors of the physical environment based at least in part on the three-dimensional model; and
storing the text-based descriptors together with the three-dimensional model.

2. The method of claim 1, wherein:
the three-dimensional model includes features and objects of the physical environment; and
the text-based descriptors include descriptions of the features and objects.

3. The method of claim 1, further comprising:
receiving, from a display device, a query associated with the three-dimensional model; and
generating, based at least in part on the query, a prompt for use as an input to a machine learning model.

4. The method of claim 3, wherein generating the prompt is based at least in part on the text-based descriptors.

5. The method of claim 3, further comprising inputting the text-based descriptors and the prompt into one or more machine learning models trained on textual descriptions of physical spaces and receiving output data as an output of the one or more machine learning models.

6. The method of claim 5, wherein the one or more machine learning models includes at least one of a large language model, neural network, or artificial intelligence agent.

7. The method of claim 5, further comprising:
determining, based at least in part on the output data, a modification associated with the three-dimensional model;
generating, based at least in part on the three-dimensional model and the modification, an updated three-dimensional model; and
causing a user to consume the updated three-dimensional model.

8. The method of claim 5, further comprising:
generating, based at least in part on the output data, a report associated with the three-dimensional model; and
providing the report to the display device.

9. The method of claim 8, wherein the report includes at least one of:
analytics data associated with the physical environment and a second physical environment different than the first physical environment,
characteristic data associated with the physical environment,
a proposed physical modification to the physical environment,
quote data associated with physical modifications to the physical environment,
object data associated with the physical environment,
material data associated with the physical environment, or
dimensions associated with the physical environment.

10. The method of claim 1, wherein generating the plurality of text-based descriptors further comprises:
inputting the sensor data of the physical environment into one or more machine learning model and receiving segmented and classified data of objects as an output of the machine learning model; and
converting the segmented and classified data the text-based descriptors.

11. A computer-readable medium storing instructions that, when executed by one or more processors, cause the one or more processors to perform operations comprising:
receiving, from a scanning device, sensor data of a physical environment;
generating a three-dimensional model of the physical environment based at least in part on the sensor data, wherein the three-dimensional model includes features and objects included in the physical environment;
generating, based at least in part on the three-dimensional model, a plurality of text-based descriptors of the features and objects;
receiving, from a display device, a query associated with the three-dimensional model;
generating, based at least in part on the query, a prompt for use as an input to a machine learning model;
inputting the text-based descriptors and the prompt into one or more machine learning models trained on textual descriptions of physical environments and receiving output data as an output of the one or more machine learning models; and
providing the output data to the display device.

12. The computer-readable medium of claim 11, the operations further comprising:
determining, based at least in part on the output data, a modification associated with the three-dimensional model;
generating, based at least in part on the three-dimensional model and the modification, an updated three-dimensional model; and
causing a user to consume the updated three-dimensional model.

13. The computer-readable medium of claim 11, the operations further comprising:
generating, based at least in part on the output data, a report associated with the three-dimensional model; and
providing the report to the display device.

14. A method comprising:
receiving image data of the physical environment and location data associated with the capture of the image data with respect to the physical environment;
determining, based at least in part on the location data, a position of the image data with respect to a digital twin of the physical environment; and
registering the image data at the position within the digital twin.

15. The method of claim 14, wherein determining the position of the image data within the digital twin is based at least in part on one or more visual place recognition techniques between content of the digital twin and the image data.

16. The method of claim 15, wherein the one or more visual place recognition techniques includes one or more of the following:
analyzing visual features within the image data and the digital twin to identify matching architectural elements, surface textures, and spatial patterns;
determining feature descriptors from the image data and comparing the feature descriptors to corresponding text-based descriptors of the digital twin; and
determining geometric properties and dimensional characteristics from the image data and comparing the geometric properties and dimensional characteristics to corresponding text-based descriptors of the digital twin.

17. The method of claim 15, wherein the location data is position and orientation data associated with a capture device.

18. The method of claim 14, further comprising presenting the image data to a user in response to a user interaction with the position within the digital twin.

19. The method of claim 14, further comprising presenting the image data to a user in response to a field of view associated with the user with respect to the digital twin and the position.

20. The method of claim 14, wherein the image data includes at least one of a photograph, a video frame, or a sequence of video frames of the physical environment.
